(19) United States
(12) Patent Application Publication
(10) Pub. No.: US 2008/0109739 A1
(43) Pub. Date: May 8, 2008

(54) Automated documentation system and method

(76) Inventor: Mohammad Humayoun Khan, Lombard, IL (US)

Correspondence Address: JOHN C SHEPARD, 575 SUNSET ROAD, WINNETKA, IL, 60093, US

(21) Appl. No.: 11/592,086

(22) Filed: Nov. 2, 2006

(51) Int. Cl. G06F 17/21; G06F 17/00

(52) U.S. Cl. 715/762; 715/200

(57) ABSTRACT

An automated documentation system and method includes a computer having a display providing first and second work areas. Narratives are generated in predefined formats from text placed within the first area. In a basic mode, text objects from the second area are selected by the user and automatically appended to text existing in the first area. In a summary mode, text objects listed in a third work area are associated with text objects listed in the second area, which have one or more markers associated therewith. Text objects selected by the user in the third area replace previously selected text objects in the second area and are marked. Text objects are written from the second area to the first area according to markers selected by the user. Text objects comprising a topical database displayed in said second and third areas are not editable until editing is affirmatively enabled.

### BACKGROUND OF THE INVENTION

1. Technical Field

The invention relates to an automated documentation system and method and, more particularly, to a computerized customizable narrative documentation preparation system and method that can be adapted for use in the medical field.

2. Background Art

In the current business environment, record keeping has become vital. Record keeping is necessary to maintain information about events, interviews, examinations, inspections and the like. Technical documentation, such as medical charts and records, legal documents, business proposals, engineering analyses, maintenance logs, or quality control reports, should be clear, concise and accurate and should be written in simple-to-understand English, preferably in an easy-to-read narrative form. When documentation is well done, people who review a file or report later and do not have personal knowledge of earlier events can easily understand what has been done and what needs to be done.

Such records are often handwritten, or dictated and transcribed by assistants or secretaries to typewritten form. The records might later be proofread, amended and then re-typed. This process has many times proven to be inefficient. Attempts to automate record keeping and eliminate transcription errors were made by using computer “mark sense” input sheets or scanning imaging. The former did not allow for customization or the inclusion of extraordinary items, while the latter could not be sorted or easily edited.

One problem surrounding good record keeping is that it takes time. Often because something else needs to be done, it is put aside or neglected entirely. Frequently, information is forgotten or left out. Performing a task and then keeping a record of it takes time and can be tedious.

In the medical profession, for example, doctors and nurses do a great deal of record keeping. At the beginning, the contact and billing information may be taken by administrative personnel, then vital signs and initial complaints may taken by nurses, then doctors may perform an examination, others may perform diagnostic tests, the doctor may then make a diagnosis, and finally a course of treatment is directed by the doctor, a surgeon, a therapist or by a pharmacist. All of these people need to chart their findings and actions on a patient's record. This record must be stored and readily retrievable, so that all may access and view a patient's complete history, which is readable and complete and accurate, and so that all information may be duly considered in recommending appropriate future action.

### BRIEF SUMMARY OF THE INVENTION

The present invention is directed to overcoming one or more of the problems as set forth above.

It is an object of the present invention to provide a means for recording information quickly and efficiently in real-time and then producing complete multiple custom documents concurrently from the recorded information. Physical records produced by the creator in a final form would clearly be more accurate than those written by hand or dictated for later transcription. In particular, it is an object to minimize misreading and misinterpretation of handwritten prescriptions and other medical instructions, including those that would otherwise be verbal.

It is a further object of the present invention to replace boilerplate and checklist documents with individualized documents created in narrative form so that they can be easily read and understood by many different people.

It is a further object of the present invention to provide a means allowing narrative documentation that can be modified by multiple contributors from multiple sites and quickly disseminated to multiple viewers at multiple sites, thereby permitting complex records to be corrected or augmented by anyone at anytime from any location.

It is a further object of the present invention to provide a method for minimizing errors by placing commonly used phrases, language and terminology in a text object database that can later be quickly accessed by the user with minimal keystrokes and minimal searching. The stored text objects are arranged by subject or topic, the subjects and topics being easily selectable from a menu. To further assist in finding and selecting desired text objects, text objects are arranged in paginated categories which can be automatically displayed to prompt the user for necessary information.

It is a further object of the present invention to provide a system that may be customized for the user's own particular needs by changing or reorganizing the text objects available for the various subject and topics while the system is being actively used.

In an exemplary embodiment of the present invention, a computer is provided which has a processor, storage and an interface enabling a user to enter, store and retrieve text data. Documents in narrative form are generated in predefined formats from accumulated text selectively placed within a first work area by the user. Text objects contained in a sorted database are retrieved from storage and listed in a second work area as required. Text objects listed in the second work area may be operatively selected by the user for placement in the first work area with the first and second work areas being presented at the user interface at the same time.

In building basic narratives, text objects are selected from the second work area by the user and automatically appended to text existing in the first work area and any text in the first work area may be edited by the user as freeform text.

In building summary narratives, text objects listed in a third work area are associated with text objects listed in the second work area, which have one or more markers associated therewith. Text objects selected by the user in the third work area replace previously selected text objects in the second work area and are marked. Text objects are written from the second work area to the first work area according to markers selected by the user.

In an another embodiment of the present invention, the markers are grouped as a series of indicators for generating an extensive document or a brief document. In addition, another series of markers are activated when a text object in the third work area is selected by the user to replace a text object in the second work area.

In another embodiment of the present invention, text objects listed in the third work area are complete sentences and are arranged in the third work area so that text objects indicative of a standard or normal condition are placed at the top of the list.

In another embodiment of the present invention, subsets of text objects comprising a topical database that are displayed in said second and third work areas are not editable until editing is affirmatively enabled so that the text object database is not mistakenly modified.

It is a feature of the present invention to provide a system and method through which information may be collected and entered into the system by means of an attached or wireless keyboard, by a touch screen, by a remote keypad, by a mouse, or by a microphone using voice recognition, and by which information may be written and disseminated in a variety of printed and electronic formats.

Numerous other advantages and features of the present invention will become readily apparent from the following detailed description of the invention and the embodiments thereof, from the claims and from the accompanying drawings.

### BRIEF DESCRIPTION OF THE SEVERAL VIEWS OF THE DRAWINGS

The details of construction and operation of the invention are more fully described with reference to the accompanying drawings which form a part hereof and in which like reference numerals refer to like parts throughout.

In the drawings:

FIG. 1 is a schematic diagram of a typical computer hardware configuration also showing a remote handheld device;

FIG. 2 is a schematic diagram of a computer system of the configuration of FIG. 1 with internal and external components shown;

FIG. 3 is the first part of a continuing flow chart illustrating the basic operating steps of the invention;

FIG. 4 is the second part of the continuing flow chart illustrating the basic operating steps of the invention;

FIG. 5 is the third part of the continuing flow chart illustrating the basic operating steps of the invention;

FIG. 6 is the fourth part of the continuing flow chart illustrating the basic operating steps of the invention;

FIG. 7 is the fifth part of the continuing flow chart illustrating the basic operating steps of the invention;

FIG. 8 is the sixth part of the continuing flow chart illustrating the basic operating steps of the invention;

FIG. 9 is the seventh part of the continuing flow chart illustrating the basic operating steps of the invention;

FIG. 10 is the eighth part of the continuing flow chart illustrating the basic operating steps of the invention;

FIG. 11 is the ninth part of the continuing flow chart illustrating the basic operating steps of the invention;

FIG. 12 is the tenth part of the continuing flow chart illustrating the basic operating steps of the invention;

FIG. 13 is the eleventh part of the continuing flow chart illustrating the basic operating steps of the invention;

FIG. 14 is the twelfth part of the continuing flow chart illustrating the basic operating steps of the invention;

FIG. 15 is the thirteenth part of the continuing flow chart illustrating the basic operating steps of the invention;

FIG. 16 is the fourteenth part of the continuing flow chart illustrating the basic operating steps of the invention;

FIG. 17 is the fifteenth part of the continuing flow chart illustrating the basic operating steps of the invention;

FIG. 18 is the sixteenth part of the continuing flow chart illustrating the basic operating steps of the invention;

FIG. 19 is the seventeenth part of the continuing flow chart illustrating the basic operating steps of the invention;

FIG. 20 is the eighteenth part of the continuing flow chart illustrating the basic operating steps of the invention;

FIG. 21 is the nineteenth part of the continuing flow chart illustrating the basic operating steps of the invention;

FIG. 22 is the twentieth part of the continuing flow chart illustrating the basic operating steps of the invention;

FIG. 23 is the twenty-first part of the continuing flow chart illustrating the basic operating steps of the invention;

FIG. 24A is the left portion of a hierarchial tree diagram showing the organization of text objects in a database;

FIG. 24B is the right portion of the hierarchial tree diagram of FIG. 24B showing organization of text objects in a database;

FIG. 25 is a tree diagram illustrating some of the various modules available from the menus to construct medical reports;

FIG. 26 is a chart listing in the first column the subjects available from the auxiliary menu and in the second column the respective topic choice classes;

FIG. 27 is a chart listing the topic choices available for the classes listed in the second column of FIG. 26;

FIG. 28 is a chart listing the text object categories available for the subjects under medical system 1 in FIGS. 26 and 27;

FIG. 29 is a screen snapshot of the opening login and password display;

FIG. 30 is a screen snapshot of the home display;

FIG. 31 is a screen snapshot of a patient appointment data entry display;

FIG. 32 is a screen snapshot of a patient basic data entry display;

FIG. 33 is a screen snapshot of the home screen with a name entered in the search field;

FIG. 34 is a screen snapshot of the name database display listing patients matching the search name;

FIG. 35 is a screen snapshot of the session menu display listing the various modules that are user selectable;

FIG. 36 is a first screen snapshot of the main data screen for the subject Chief Complaint and the topic Common showing the menu icons, the main text work area, and the Dialect phrase lists;

FIG. 37 is a second screen snapshot of the main data screen for the subject Chief Complaint and the topic Common showing the menu icons, the main text work area, and the Dialect phrase lists;

FIG. 38 is a screen snapshot similar to FIG. 37 with the main text work area being enlarged and displayed in an overlying window;

FIG. 39 is a third screen snapshot of the main data screen for the subject Chief Complaint and the topic Common showing the menu icons, the main text work area, and the Dialect phrase lists with the Topic Menu window overlying the display;

FIG. 40 is a first screen snapshot of the main data screen for the subject Chief Complaint and the topic ENT (Eye/Nose/Throat) showing the menu icons, the main text work area, and the Dialect phrase lists;

FIG. 41 is a second screen snapshot of the main data screen for the subject Chief Complaint and the topic ENT (Eye/Nose/Throat) showing the menu icons, the main text work area, and the Dialect phrase lists;

FIG. 42 is a third screen snapshot of the main data screen the subject Chief Complaint and the topic Common showing the menu icons, the main text work area, and the Dialect phrase lists;

FIG. 43 is a fourth screen snapshot of the main data screen the subject Chief Complaint and the topic Common showing the menu icons, the main text work area, and the Dialect phrase lists with the Auxiliary Subject Menu window overlying the display;

FIG. 44 is a first screen snapshot of the main data screen for the subject History of Present Illness and the topic Common showing the menu icons, the main text work area, and the Dialect phrase lists;

FIG. 45 is a second screen snapshot of the main data screen for the subject History of Present Illness and the topic Common showing the menu icons, the main text work area, and the Symptoms phrase lists;

FIG. 46 is a third screen snapshot of the main data screen for the subject History of Present Illness and the topic Common showing the menu icons, the main text work area, and a first Time phrase list;

FIG. 47 is a fourth screen snapshot of the main data screen for the subject History of Present Illness and the topic Common showing the menu icons, the main text work area, and a second Time phrase list;

FIG. 48 is a fifth screen snapshot of the main data screen for the subject History of Present Illness and the topic Common showing the menu icons, the main text work area, and a third Time phrase list;

FIG. 49 is a sixth screen snapshot of the main data screen for the subject History of Present Illness and the topic Common showing the menu icons, the main text work area, and the Severity phrase lists;

FIG. 50 is a seventh screen snapshot of the main data screen for the subject History of Present Illness and the topic Common showing the menu icons, the main text work area, and the Modifying Factor phrase lists;

FIG. 51 is an eighth screen snapshot of the main data screen for the subject History of Present Illness and the topic Common showing the menu icons, the main text work area, and Physical phrase lists;

FIG. 52 is a ninth screen snapshot of the main data screen for the subject History of Present Illness and the topic Common showing the menu icons, the main text work area, and the Substance Abuse phrase lists;

FIG. 53 is a tenth screen snapshot of the main data screen for the subject History of Present Illness and the topic Common showing the menu icons, the text work area, and the Hospitals phrase lists;

FIG. 54 is a first screen snapshot of the main data screen for the subject Vital Signs showing the menu icons, the text work area, and the Systolic-Normal phrase lists;

FIG. 55 is a second screen snapshot of the main data screen for the subject Vital Signs showing the menu icons, the text work area, and the Diastolic-Normal phrase lists;

FIG. 56 is a third screen snapshot of the main data screen for the subject Vital Signs showing the menu icons, the text work area, and the Pulse phrase lists;

FIG. 57 is a fourth screen snapshot of the main data screen for the subject Vital Signs showing the menu icons, the text work area, and the Respiration phrase lists;

FIG. 58 is a fifth screen snapshot of the main data screen for the subject Vital Signs showing the menu icons, the text work area, and the Temperature-F phrase lists;

FIG. 59 is a sixth screen snapshot of the main data screen for the subject Vital Signs showing the menu icons, the text work area, and the Weight-Lbs phrase lists;

FIG. 60 is a seventh screen snapshot of the main data screen for the subject Vital Signs showing the menu icons, the text work area, and the Weight-Lbs phrase lists after the Low weight category has been selected;

FIG. 61 is an eighth screen snapshot of the main data screen for the subject Vital Signs showing the menu icons, the text work area, and the Height-In phrase lists;

FIG. 62 is a ninth screen snapshot of the main data screen for the subject Vital Signs showing the menu icons, the text work area, and the Height-In phrase lists after a height has been inserted;

FIG. 63 is a first screen snapshot of the main data screen for the subject System Review and the topic General showing the menu icons, the main text work area, the phrase lists and the indicator check boxes;

FIG. 64 is a second screen snapshot of the main data screen for the subject System Review and the topic General showing the menu icons, the main text work area, the phrase lists and the indicator check boxes;

FIG. 65 is a third screen snapshot of the main data screen for the subject System Review and the topic General showing the menu icons, the main text work area, the phrase lists and the indicator check boxes;

FIG. 66 is a fourth screen snapshot of the main data screen for the subject System Review and the topic General showing the menu icons, the main text work area, the phrase lists and the indicator check boxes;

FIG. 67 is a fifth screen snapshot of the main data screen for the subject System Review and the topic General showing the menu icons, the main text work area, the phrase lists and the indicator check boxes;

FIG. 68 is a sixth screen snapshot of the main data screen for the subject System Review and the topic General showing the menu icons, the main text work area, the phrase lists and the indicator check boxes;

FIG. 69 is a first screen snapshot of the main data screen for the subject System Review and the topic Nose showing the menu icons, the main text work area, the phrase lists and the indicator check boxes;

FIG. 70 is a second screen snapshot of the main data screen for the subject System Review and the topic Nose showing the menu icons, the main text work area, the phrase lists and the indicator check boxes;

FIG. 71 is a third screen snapshot of the main data screen for the subject System Review and the topic Nose showing the menu icons, the main text work area, the phrase lists and the indicator check boxes;

FIG. 72 is a seventh screen snapshot of the main data screen for the subject System Review and the topic General showing the menu icons, the main text work area, the phrase lists and the indicator check boxes after the Extensive data has been written into the main text work area;

FIG. 73 is an eighth screen snapshot of the main data screen for the subject System Review and the topic General with the Extensive View All window overlying the display;

FIG. 74 is a ninth screen snapshot of the main data screen for the subject System Review and the topic General showing the menu icons, the main text work area, the phrase lists and the indicator check boxes after the Brief data has been written into the main text work area;

FIG. 75 is a tenth screen snapshot of the main data screen for the subject System Review and the topic General with the Brief View All window overlying the display;

FIG. 76 is an eleventh screen snapshot of the main data screen for the subject System Review and the topic General showing the menu icons, the main text work area, the phrase lists and the indicator check boxes after the My Review data has been written into the main text work area;

FIG. 77 is a twelfth screen snapshot of the main data screen for the subject System Review and the topic General with the My Review View All window overlying the display;

FIG. 78 is a first screen snapshot of the main data screen for the subject Physical Exam and the topic General Appearance showing the menu icons, the main text work area, the phrase lists and the indicator check boxes;

FIG. 79 is a second screen snapshot of the main data screen the subject Physical Exam and the topic General Appearance showing the menu icons, the main text work area, the phrase lists and the indicator check boxes;

FIG. 80 is a third screen snapshot of the main data screen the subject Physical Exam and the topic General Appearance showing the menu icons, the main text work area, the phrase lists and the indicator check boxes;

FIG. 81 is a fourth screen snapshot of the main data screen the subject Physical Exam and the topic General Appearance showing the menu icons, the main text work area, the phrase lists and the indicator check boxes;

FIG. 82 is a first screen snapshot of the main data screen the subject Physical Exam and the topic Nose showing the menu icons, the main text work area, the phrase lists and the indicator check boxes;

FIG. 83 is a second screen snapshot of the main data screen for the subject Physical Exam and the topic Nose showing the menu icons, the main text work area, the phrase lists and the indicator check boxes;

FIG. 84 is a third screen snapshot of the main data screen for the subject Physical Exam and the topic Nose showing the menu icons, the main text work area, the phrase lists and the indicator check boxes;

FIG. 85 is a fifth screen snapshot of the main data screen for the subject Physical Exam and the topic General Appearance showing the menu icons, the main text work area, the phrase lists and the indicator check boxes after the Extensive data has been written into the main text work area;

FIG. 86 is a sixth screen snapshot of the main data screen for the subject Physical Exam and the topic General Appearance with the Extensive View All window overlying the display;

FIG. 87 is a seventh screen snapshot of the main data screen the subject Physical Exam and the topic General Appearance showing the menu icons, the main text work area, the phrase lists and the indicator check boxes after the Brief data has been written into the main text work area;

FIG. 88 is an eighth screen snapshot of the main data screen for the subject Physical Exam and the topic General Appearance with the Brief View All window overlying the display;

FIG. 89 is a ninth screen snapshot of the main data screen for the subject Physical Exam and the topic General Appearance showing the menu icons, the main text work area, the phrase lists and the indicator check boxes after the My Review data has been written into the main text work area;

FIG. 90 is a tenth screen snapshot of the main data screen for the subject Physical Exam and the topic General Appearance with the My Review View All window overlying the display;

FIG. 91 is a screen snapshot of the main data screen showing an overlying window allowing the user to exit the system;

FIG. 92 is a screen snapshot of the main data screen for the subject Immunizations and the topic Common showing the menu icons, the main text work area, and the Immunizations phrase lists;

FIG. 93 is a screen snapshot of the main data screen for the subject Family History and the topic Common showing the menu icons, the main text work area, and the Diagnosis phrase lists; and,

FIG. 94 is a screen snapshot of the main data screen for the subject Diagnosis and the topic Common showing the menu icons, the main text work area, and the Dialect phrase lists.

FIG. 95 is a first screen snapshot of the main data screen for the Prescription module and the topic Common showing the menu icons, the main text work area, and the Name of Medicine phrase lists;

FIG. 96 is a second screen snapshot of the main data screen for the Prescription module and the topic Common showing the menu icons, the main text work area, and the Instructions phrase lists;

FIG. 97 is a third screen snapshot of the main data screen for the Prescription module and the topic Common showing the menu icons, the main text work area, and the No. of Pills phrase lists;

FIG. 98 is a fourth screen snapshot of the main data screen for the Prescription module and the topic Common showing the menu icons, the main text work area, and the Refills phrase lists;

FIG. 99 is a fifth screen snapshot of the main data screen for the Prescription module and the topic Common showing the menu icons, the main text work area, and the Name of Medicine phrase lists;

FIG. 100 is a sixth screen snapshot of the main data screen for the Prescription module and the topic Common showing the menu icons, the main text work area, and a second page of the Name of Medicine phrase lists;

FIG. 101 is a seventh screen snapshot of the main data screen for the Prescription module and the topic Common showing the menu icons, the main text work area, and a second page of the Name of Medicine phrase lists;

FIG. 102 is a screen snapshot of the main data screen showing an overlying window containing a virtual numeric keypad;

FIG. 103 is a screen snapshot of the main data screen for the Review Chart module showing a formatted patient chart in the main text work area, module selection tabs above and subject icons below;

FIG. 104 is a formatted report of a printed patient chart generated by the present invention;

FIG. 105 is a screen snapshot of the main data screen for the Prescription module showing a formatted prescription in the main text work area, module selection tabs above and topic icons below;

FIG. 106 is a formatted reported of a printed prescription generated by the present invention; and,

FIG. 107 is a chart listing various report types available for a medical documentation system.

### DETAILED DESCRIPTION OF THE PREFERRED EMBODIMENTS

While the present invention is susceptible of embodiment in many different forms, there are shown in the drawings and will be described herein in detail specific embodiments thereof with the understanding that the present disclosure is to be considered as an exemplification of the principles of the invention and is not intended to limit the invention to the specific embodiments illustrated.

### 1. Typical Computer System

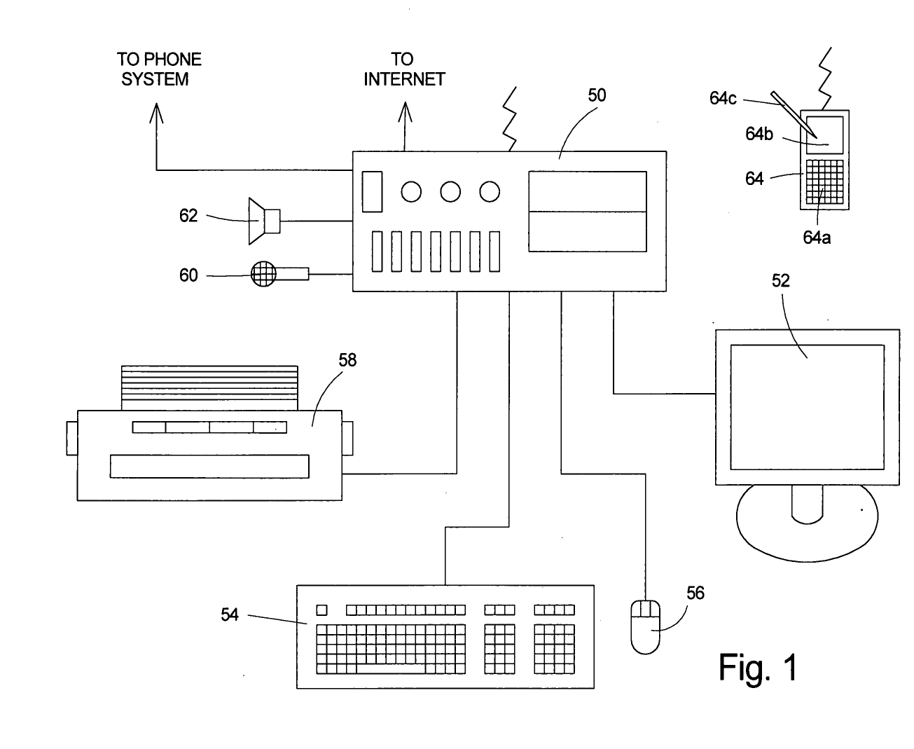

Referring now to the drawings in greater detail, FIG. 1 schematically shows the configuration of a typical desktop computer system, such as a PC-compatible computer 50, to which are attached various devices which act as user interfaces, such as a video display monitor 52, a keyboard 54, a mouse 56, a printer 58, a microphone 60 and a speaker 62. A wireless or handheld terminal 64 having a keypad 64a may also interface with the computer system to enable remote input. The terminal 64 may include a touchscreen 64b display permitting the entry of data by means of a stylus 64c.

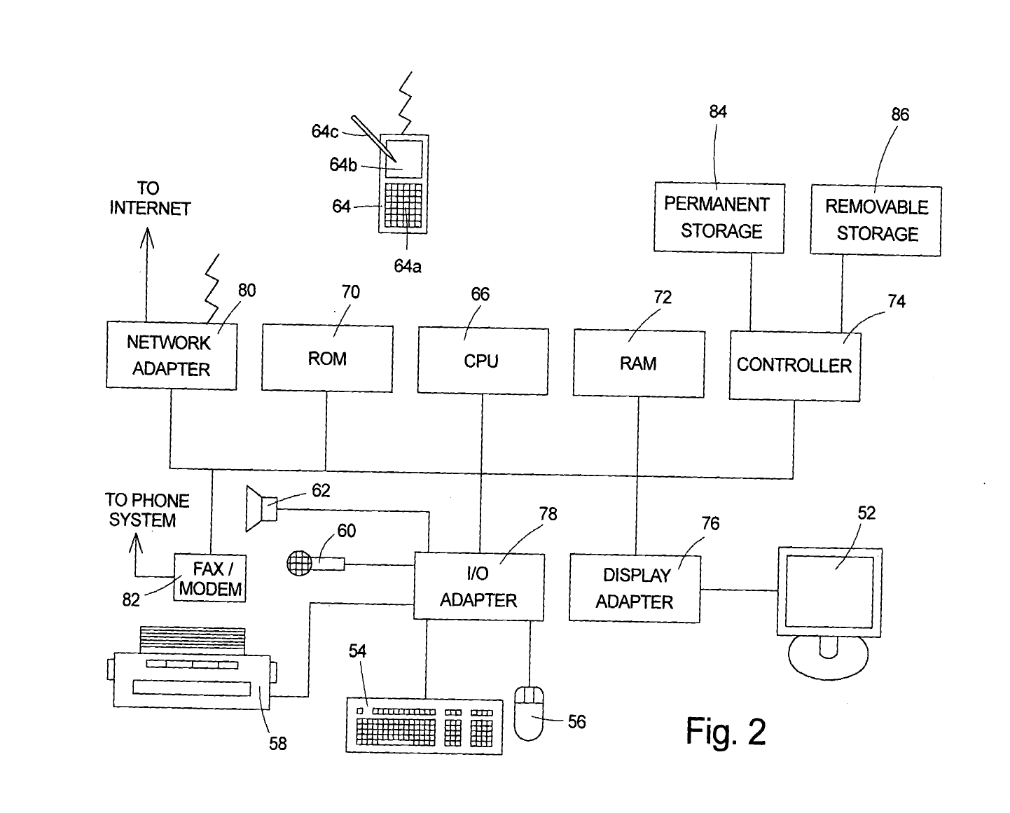

In FIG. 2, the computer system is seen to include a central processing unit (CPU) 66, which communicates to the remaining computer components through a central bus 68 with read-only memory (ROM) 70, random access memory (RAM) 72, a controller 74, a display adapter 76, an input and output (I/O adapter) 78, a network adapter 80 and a fax/modem 82.

The CPU executes procedures from instructions and data contained in memory locations found in the ROM (read-only memory) or RAM (random-access memory). ROM is used to maintain permanent instructions and data for the computer, such as start-up instructions or setup data. If instructions or data are required from permanent storage 84, such as a hard disk, or from removable storage 86, such as a floppy disk, a CD-ROM, or a memory module, then the CPU accesses the controller to retrieve it from storage and move it to RAM.

If data is to be input by a user or output to a user, then the CPU 66 accesses the I/O adapter 78 to retrieve information from the alphanumeric keyboard 54, the mouse 56, or the microphone 60 or send information to the printer 58 or the speaker 62. When alphanumeric or graphical information is to be sent to the display monitor 52, the CPU 66 sends visual information to the display adapter 76, which then is sent to the monitor 52. If a touchscreen display is employed, then the display 52 may also be connected to the I/O adapter 78 to accept input by user touching points on the display screen. The network adapter 80 permits the entire system to communicate with other wired or wireless devices in a local area network (LAN) or a wide area network (WAN) or the Internet.

The above components are well-known in the prior art and can be purchased and assembled as desired. The software utilized to drive the current application is Microsoft Windows and Microsoft ASP.NET, obtained from the Microsoft Corporation of Bellevue, Wash. Windows is the basic operating system.

An ASP.NET application is defined as all the files, pages, handlers, modules, and executable code that can be invoked or run from a virtual directory and its subdirectories on a Web application server. Any of the ASP.NET programming models can be used within any application that is defined, based on either Web Forms or XML Web services. However, they must coexist in a single virtual directory structure.

### 2. Data Structure

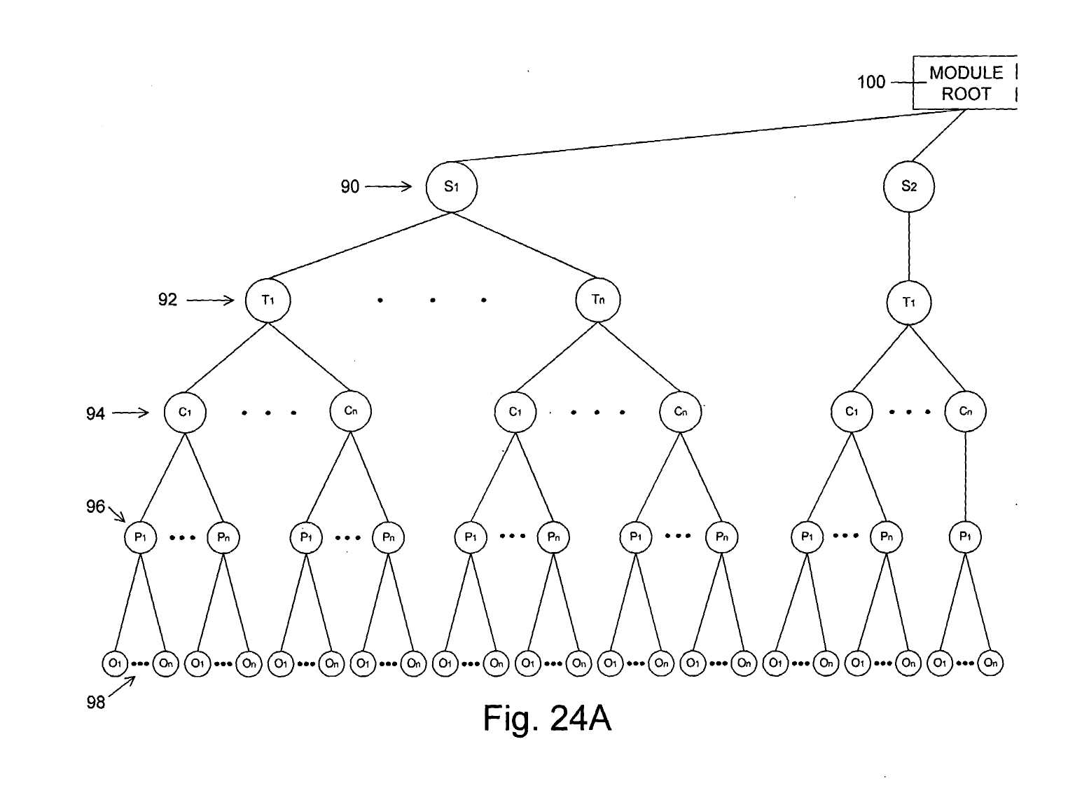

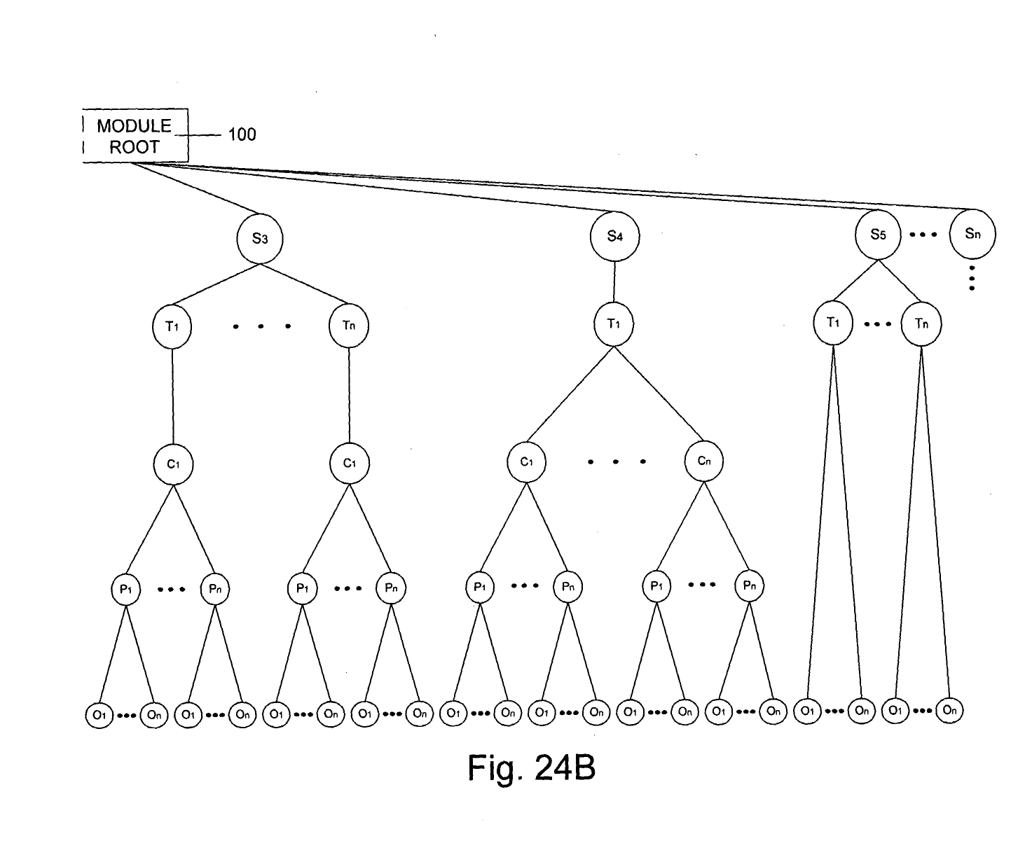

To achieve efficiency in composing original narrative documentation, a user in most instances will select whole sentences or phrases from a displayed list rather than entering a single alphanumeric character from a keyboard. The lists are organized in a hierarchical array of related concepts or terms as seen in FIGS. 24A and 24B so that the user can locate text data previously stored in the system. The system is divided into modules, such as History & Procedure module 100. Each module is divided into classes or subjects. Each class is divided subclasses or topics. Within each of the subclasses, there are categories of broadly related text data objects arranged onto pages or levels.

Text objects as used herein includes sentences, phrases, words, letters, numbers, characters, punctuation, symbols, spaces and other indicia, including nonprintable control characters, or combinations of the foregoing, representing information understandable by humans. Text data, text data objects and text data items as used herein are synonymous with text objects. Text or a text fragment is one text object, a part of one text object, or two or more text objects concatenated together. A phrase list is a list of text objects.

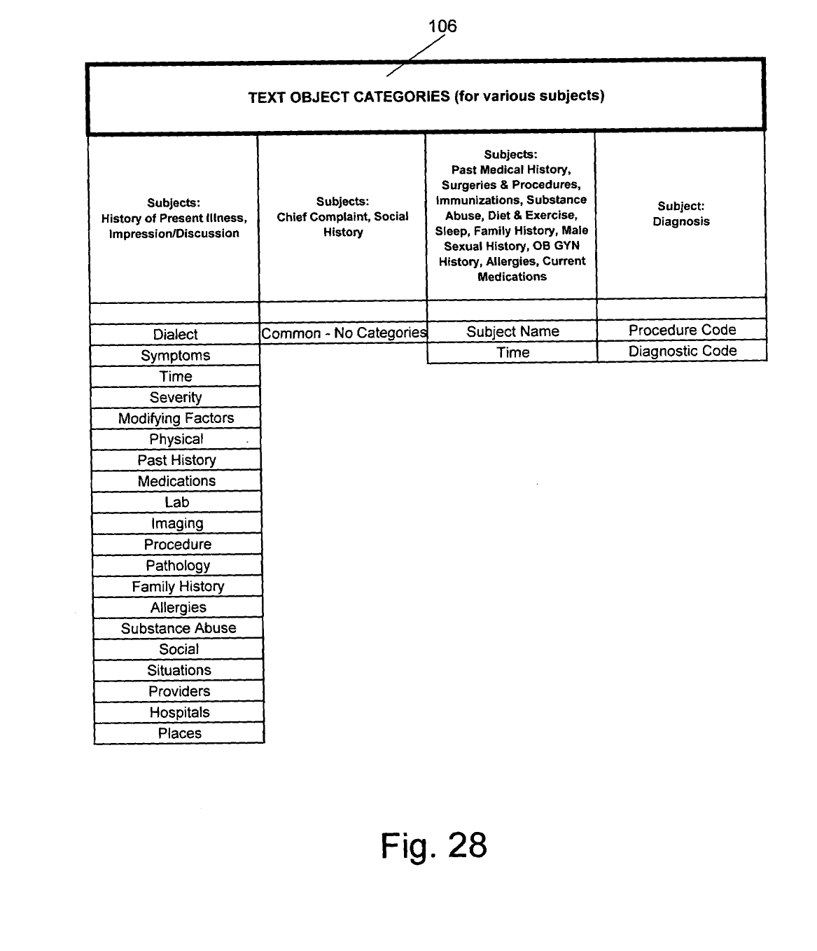

Text objects are maintained in a database within the computer storage means and subsets of these text objects are displayed in appropriate lists on the display. Herein, text objects are arranged more or less by subject matter. That is, terms and phrases are categorized by subject and topic and by connecting verbs, adjectives, and other grammatical elements. FIG. 28 shows the various categories for text objects with the various subjects. Any particular module has one or more subjects. Each subject has one or more topics. Each topic has one or more categories of text objects or phrases. Each category may have one or more pages of separate text objects. As seen in FIGS. 24A and 24B, within each module 100 each subject S1 to Sn, collectively designated 90, may encompass one or more topics T1 to Tn, collectively designated 92. Within each topic 92, text objects can be divided into one or more respective categories C1 to Cn, collectively designated 94. Text objects are further subdivided, where necessary, onto one or more respective pages P1 to Pn, collectively designated 96, each encompassing a series of text objects O1 to On, collectively designated 98. Such pagination might be required where there are a large number of text objects within one category. The set of all the text objects as used herein includes all of the text objects in the database and a subset includes all of the set, a portion of the set, or none of the set.

### 3. Data Display and Data Entry Templates

As contemplated by the invention herein, when data is displayed it can be selectively displayed on computer monitor or on the remote keypad. When the user inputs data into the system, input can be by keyboard, by mouse, by display touchscreen, by handheld terminal, by voice through a microphone, or by similar input devices.

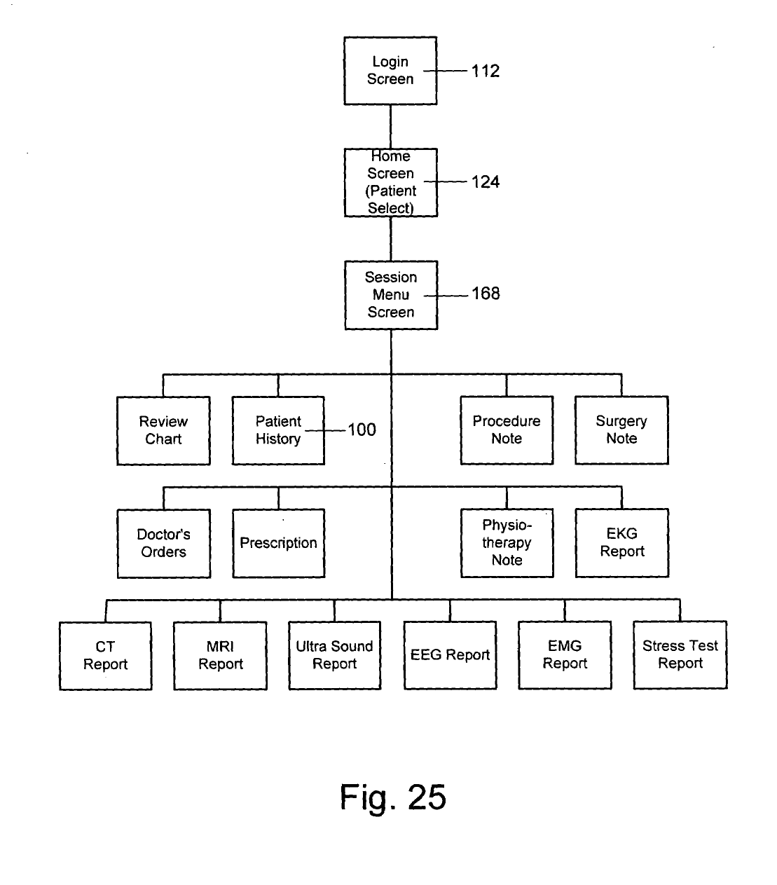

The intended final result of the automated documentation system disclosed herein is to provide a viewable or printed record in narrative form. The system is based on separate modules with appropriate reports and other documents designed and laid out in a predetermined format for each module. Some possible modules are shown in FIG. 25 below the Session Menu Screen box 168.

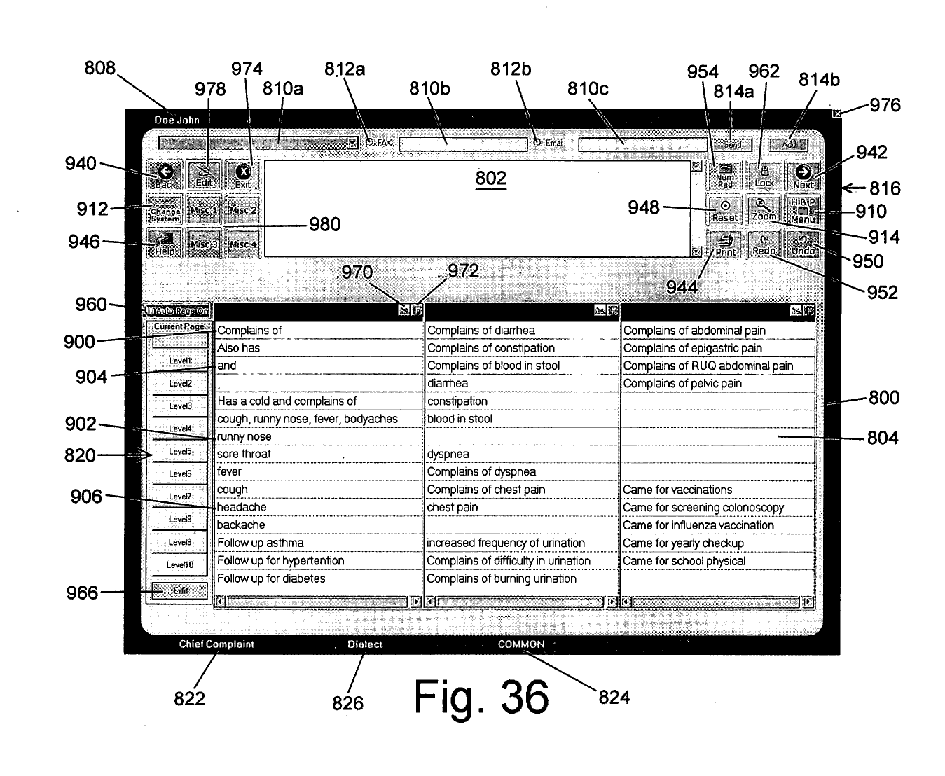

A typical screen display as contemplated herein is shown in FIG. 36 and comprises a main data screen, generally designated 800, defining a template subdivided into a number of regions. Centered in the upper part of the display is a region which will be denoted as the main text box or first display work area 802. Any documentation which is generated by the system described herein will be made up of text objects selected by the user to be placed into the first display work area 802 as text. Text in the first display work area 802 is editable at any time by moving the display cursor to any position therein and adding, modifying or deleting text at that point.

In the lower half of the display is a region, which will be denoted as a second display work area 804, displaying a series of text objects that the user may select for insertion into the first display work area 802. Complete narrative text can be built from one or more text objects by selecting and joining them together in the first display work area 802. Text objects in the second display work area 804 are protected and not editable, unless editing is specifically toggled on by the user in a manner described hereinafter. Herein, display work areas have corresponding work areas in memory or storage so that processor can manipulate, save and retrieve the same text data that is viewed by the user.

Above the first display work area 802 in the left margin area is the patient's name 808. On the line directly below the top margin are text boxes 810a for a pharmacy name, 810b for a fax number and 810c for an e-mail address. There are radio buttons 812a to denote send by fax and 812b to denote send by e-mail and command buttons 814a for directing output of documents to selected recipients and 814b for adding a new patient. On either side of the first display work area 802 are command buttons, collectively designated 816, for executing various functions that will be described hereinafter.

A series of selectable tabs, collectively designated 818 (FIG. 44), may be displayed below the first display work area 802 allowing the user to selectively change the category of text objects being displayed, the categories varying according to the subject and topic that are currently active. Tabs, collectively designated 820, along the lower left side labeled “Level1” to “Level10” are used to change the text object page, i.e., display a different series or subset of text objects under the active category.

At the left of the bottom margin area, the title 822 of the currently active subject is shown. In the left center of the bottom margin area, the title 824 of the currently active topic is shown. Between the subject and topic titles 822 and 824, the title 826 of the currently active text category is shown. The currently active page may be displayed and highlighted immediately above the top of the page level list 820.

Most user selections under this system are made by moving a mouse to position a cursor on the display over a display work area, or a command button, or a tab. Thereafter, a mouse button is clicked or the ENTER key pressed on the keyboard so that the system responds to the user's selection and executes an appropriate command or function.

The primary purpose of this main data screen 800 and other similar screens is to accumulate suitable information, information that will be copied or otherwise inserted by the user into the first display work area 802, then saved and later inserted into the various predefined charts, reports, notes and other documents that will be generated later.

### 4. Medical Documentation

While the system can be employed in any number of fields, the examples described herein illustrate the invention as applied to a medical documentation system. Herein, the various reporting functions are broken down into modules. In a medical record documentation system constructed in accordance with the present invention, there are modules broadly organized into the following areas as diagrammed in FIG. 25:

Review Chart
Patient History
Procedure Note
Surgery Note
Doctor's Orders
Prescription
Physiotherapy Note
EKG (electrocardiogram) Report
CT (computerized axial tomography) Report
MRI (magnetic resonance imaging) Report
Ultra Sound Report
EEG (electroencephalogram) Report
EMG (electromyogram) Report
Stress Test Report

For a medical documentation system, information is stored in records or charts according to patient. Within each patient's records are one or more dates when records were generated, i.e., when the patient was interviewed, when the patient was examined, when medical tests were conducted, when diagnoses were determined, when treatment was suggested, when procedures were conducted, prescriptions written, etc. These can be classified under the various available modules, medical field, etc.

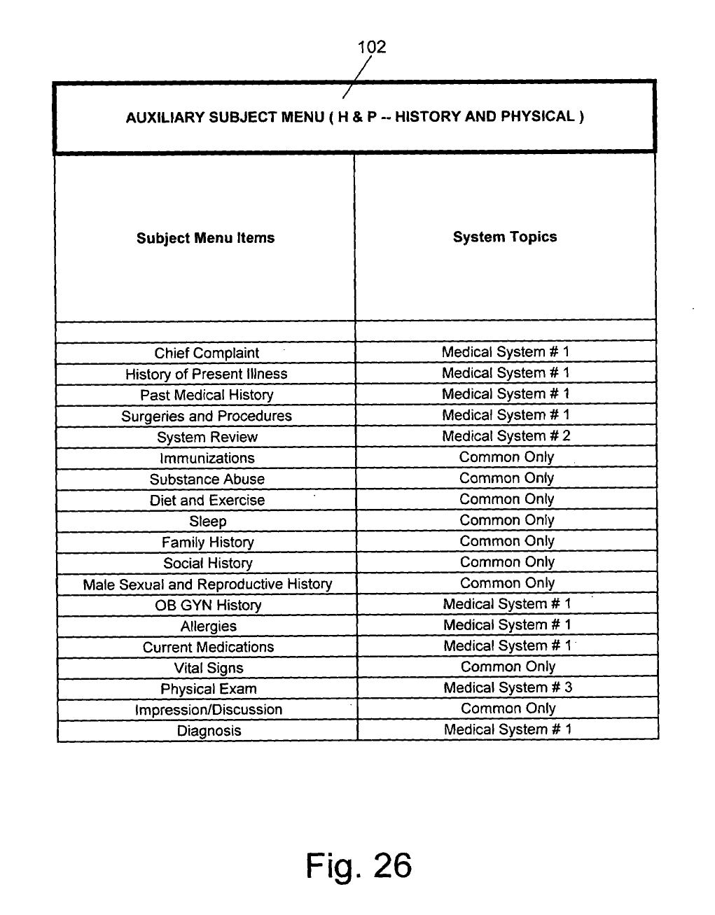

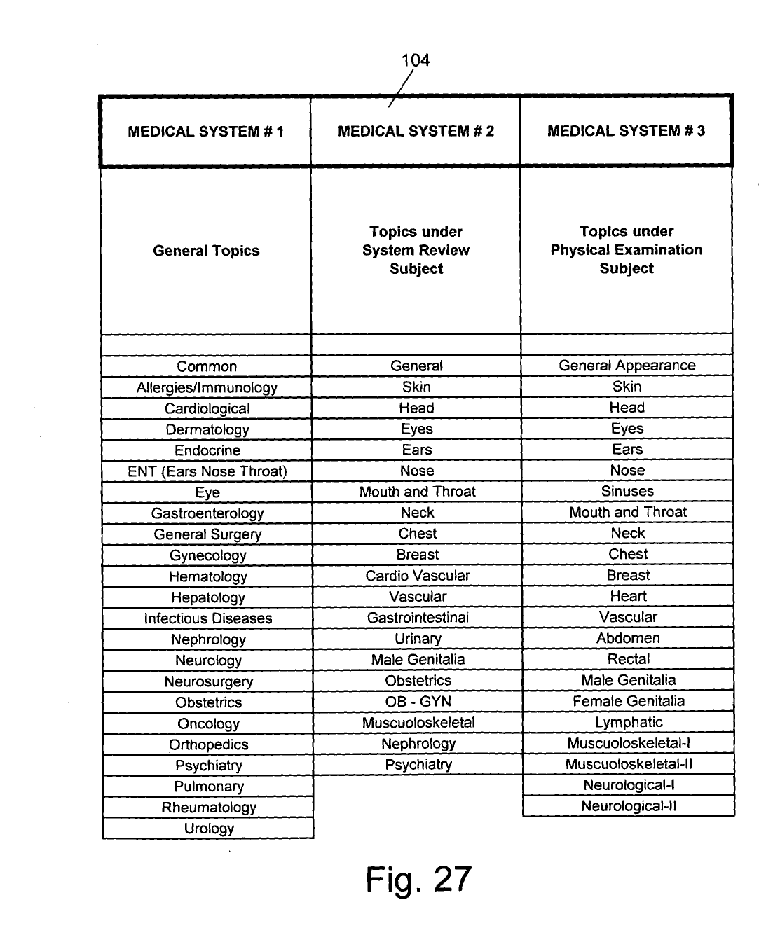

To facilitate data entry, history and physical (“H&P”) module information likely to be used during interviews and doctor's examinations is organized into subjects and topics. Typical subjects are listed in the left column of the table 102 shown in FIG. 26. Within each of the subjects, there may be one or more topics or subclasses or systems, which might otherwise be called medical specialties, and are referenced in the right column of the table shown in FIG. 26 and listed in detail in the table 104 shown in FIG. 27. Some subjects do not have more than a single topic, in which case the topic is simply labeled “Common.” The table 106 in FIG. 28 shows the various categories of text objects and phrases for each subject listed in the table 102 shown in FIG. 26. As a result, information relating to specific body systems or topics is organized and can be easily accessed as necessary while interviewing or examining the patient. This allows a doctor to quickly go down the list from current complaint and symptoms, to patient history, to patient's vital signs, to doctor's physical examination, to doctor's impressions and finally to doctor's diagnosis.

When a patient makes a visit to a doctor's office, the doctor or nurse simply goes through the list of items in the subject list. The subjects are roughly chronologically arranged to put them in an order in which they might be attended to during a doctor's visit. When a patient arrives at the doctor's office, he will usually have a “Chief Complaint” or will be coming for a check-up or physical. The doctor or nurse will take a history asking about the patient's “Present Illness”, the patient's “Past Medical History” and the patient's prior “Surgeries and Procedures.” The doctor or nurse might make a brief overview of the patient's overall condition during a “System Review.” Then, more detailed questions about the patient's health, life style and history might be asked, including questions about “Immunizations,” “Substance Abuse,” “Diet and Exercise,” “Sleep,” “Family History,” “Social History,” “Sexual and Reproductive History” (for males only), “Obstetric and Gynecological History” (for females only), “Allergies,” and “Current Medications.” Thereafter, the patient's current “Vital Signs” are actually checked by the doctor or nurse. The doctor then conducts a “Physical Exam,” gives his “Impressions and Discussions,” and finally provides a “Diagnosis.” All of the information obtained during this process is entered and can be printed in multiple reports in a narrative form that anyone can understand easily at a later time.

### 5. Data Entry

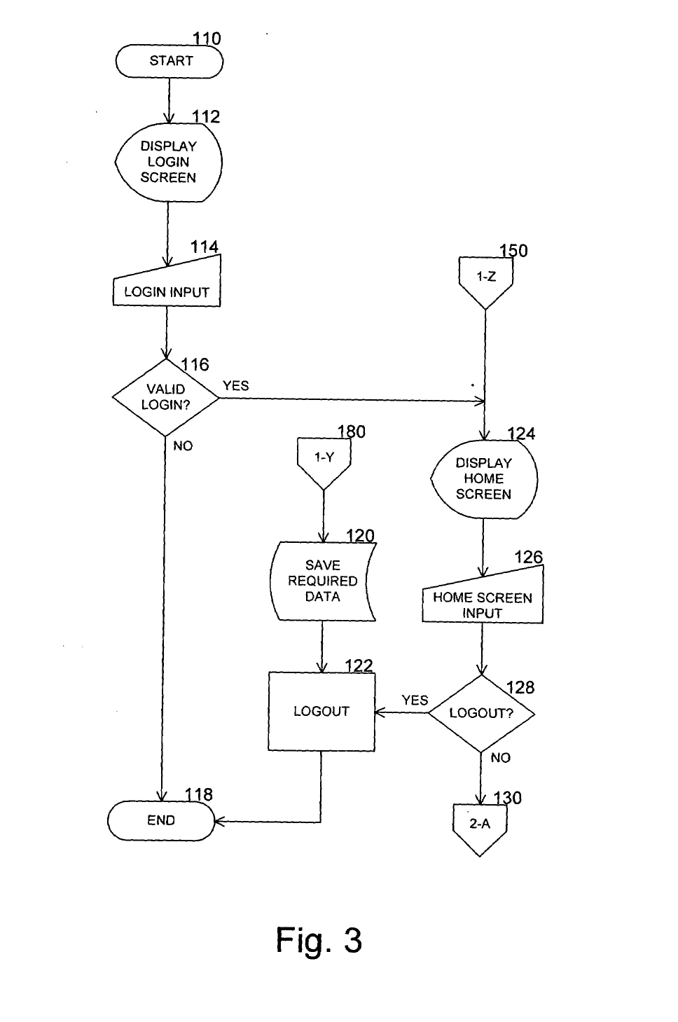

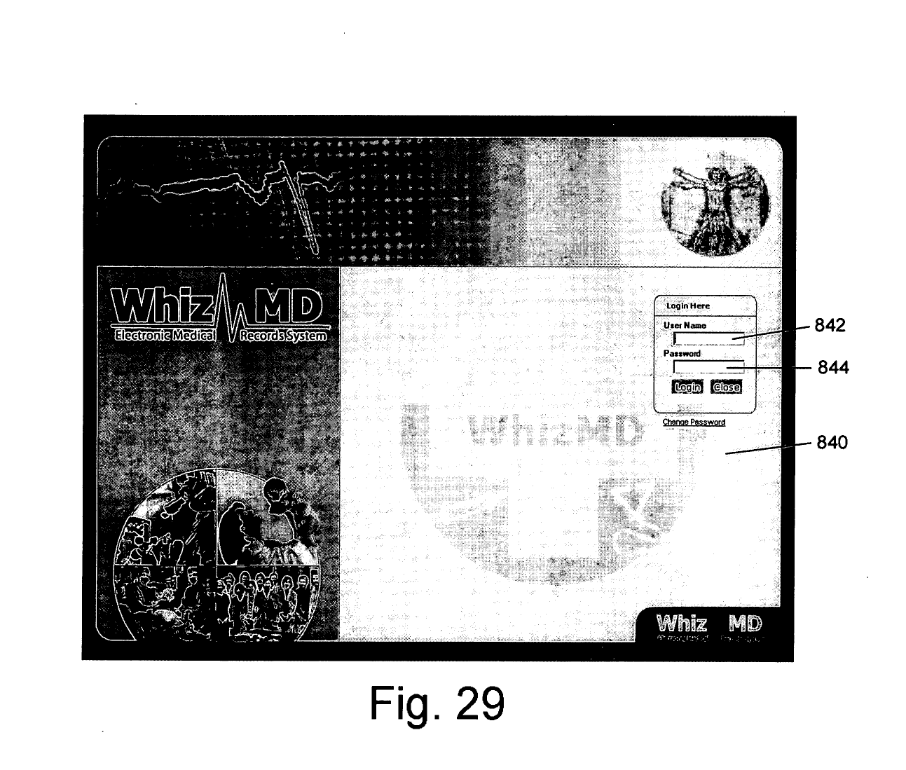

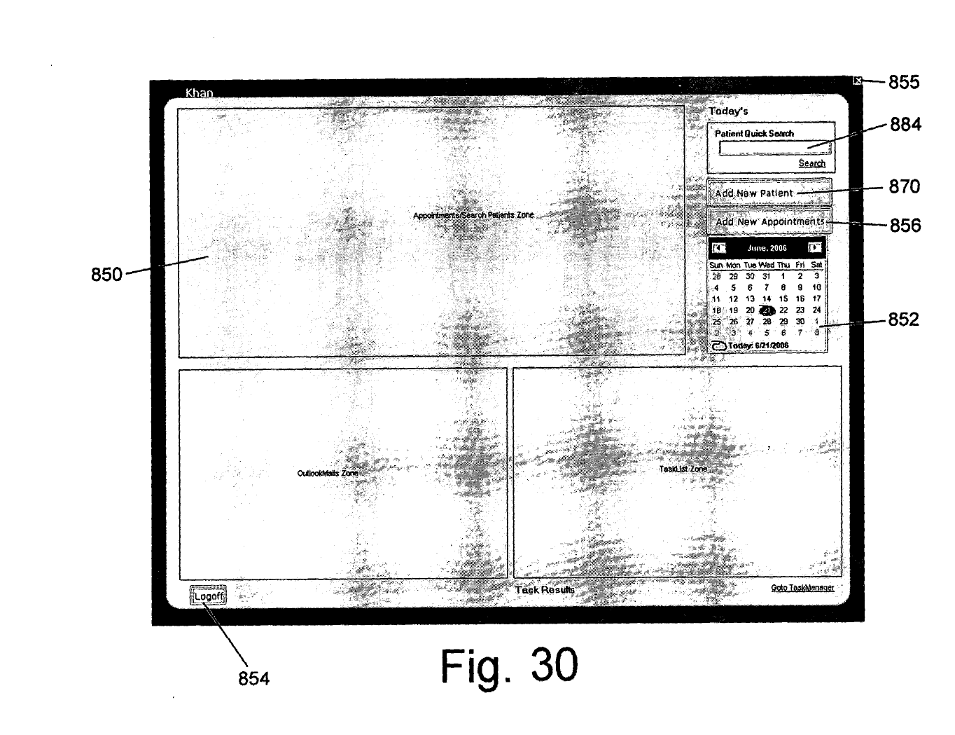

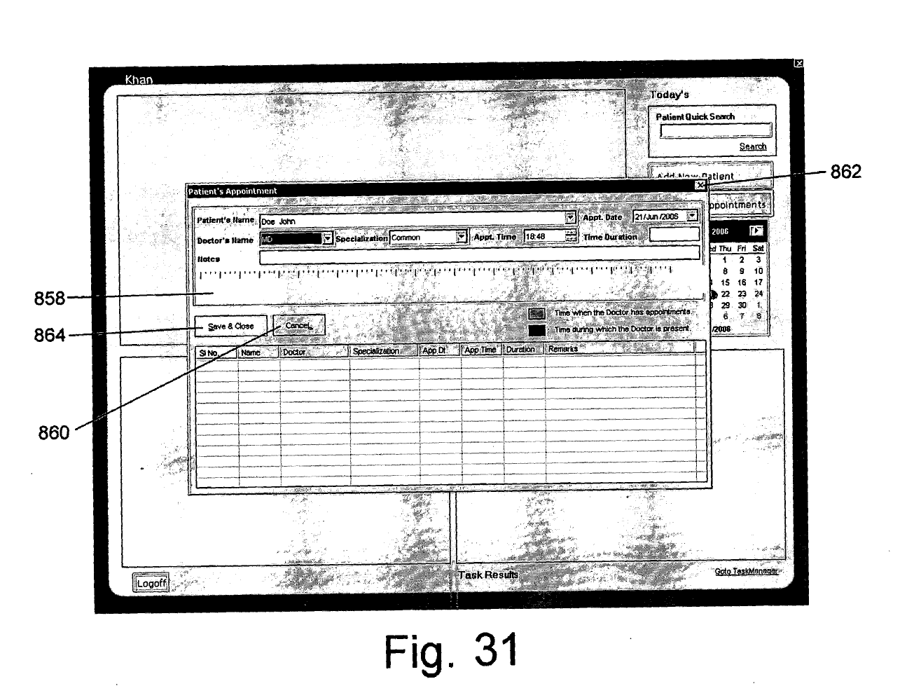

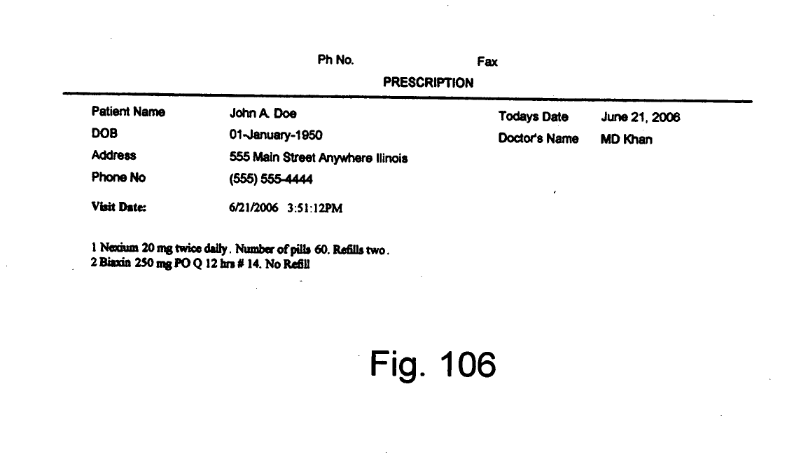

FIGS. 3 through 23, inclusive, depict a program routine for software to be used in a data processing system according to an embodiment of the present invention, while FIGS. 29 through 106, inclusive, are representative screenshots of the display generated by an implementation of the present invention. The operation of the overall system can be described by reference to all of these drawings together.

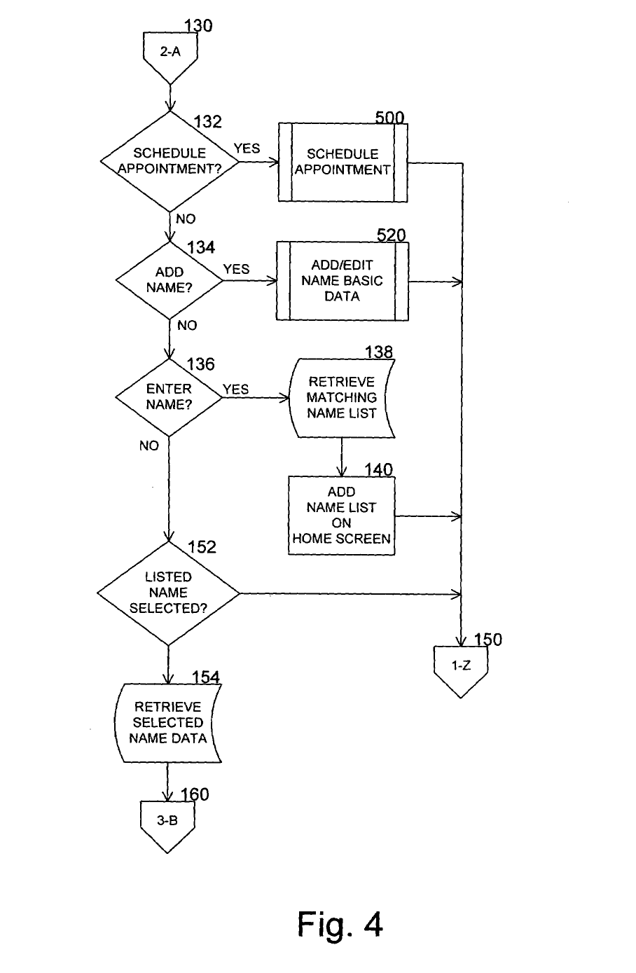

The system program is initialized in FIG. 3 at step 110 and proceeds to step 112, where the LOGIN SCREEN 840 as seen in FIG. 29 is displayed. At step 114, the user enters a login name in box 842 and a password in box 844 that is validated at step 116. If the user enters an invalid name or password, then processing branches and terminates at step 118. If the system determines that the password is valid for the name entered, then processing branches to step 124 and the HOME SCREEN 850 as seen in FIG. 30 is displayed and the system waits for user input at step 126. The HOME SCREEN 850 includes a scrollable calendar 852 and displays a number of options from which a user may select one for execution. If the system determines at step 128 that the user has selected the LOGOFF button 854 or the Exit icon 855, then processing branches to step 122 and executes any logout procedures and processing terminates at step 118; otherwise, processing continues at the 2-A connector 130 (FIGS. 3 and 4).

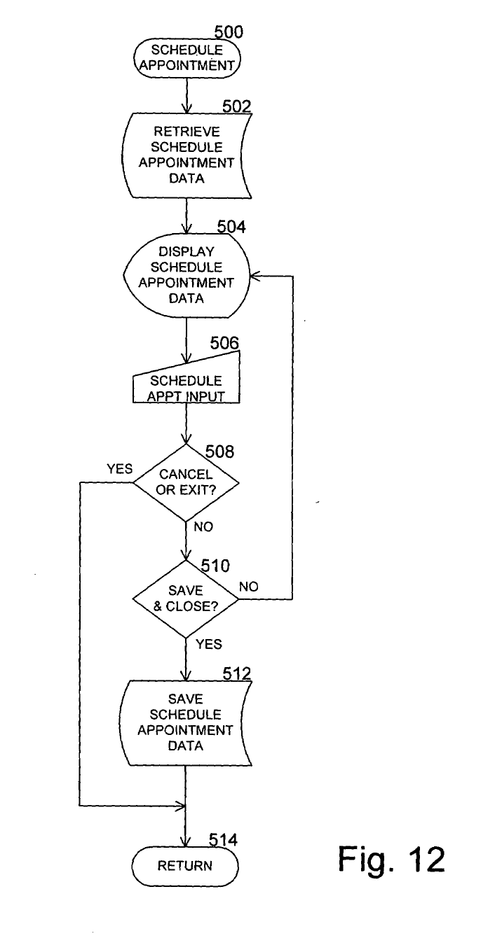

If it is determined at step 132 that at the HOME SCREEN 850 display the user has decided to schedule an appointment by selecting the ADD NEW APPOINTMENTS button 856, then the SCHEDULE APPOINTMENT Routine beginning at subroutine 500 (FIG. 12), an accessory feature of this system, is executed. At the beginning of this routine, appointment data is retrieved from storage at step 502 and displayed at step 504 in an overlying window 858 as seen in FIG. 31. At step 506, the user can then add, edit and delete appointments for clients or patients or end editing. If the system at step 508 determines that the user has selected the CANCEL button 860 or the EXIT icon 862, then execution branches to step 514 and any changes to the appointment data are disregarded and not saved to storage and the system returns to the HOME SCREEN 850 at step 124 through the 1-Z connector 150 (FIGS. 3 and 4). If upon continuing, the system determines at step 510 that the user has completed entering appointment data by selecting the SAVE & CLOSE button 864, then processing branches and appointment data is saved to storage at step 512 and the system at step 514 returns to the HOME SCREEN 850. If neither option was selected, then processing branches back from step 510 and appointment data is redisplayed at step 504.

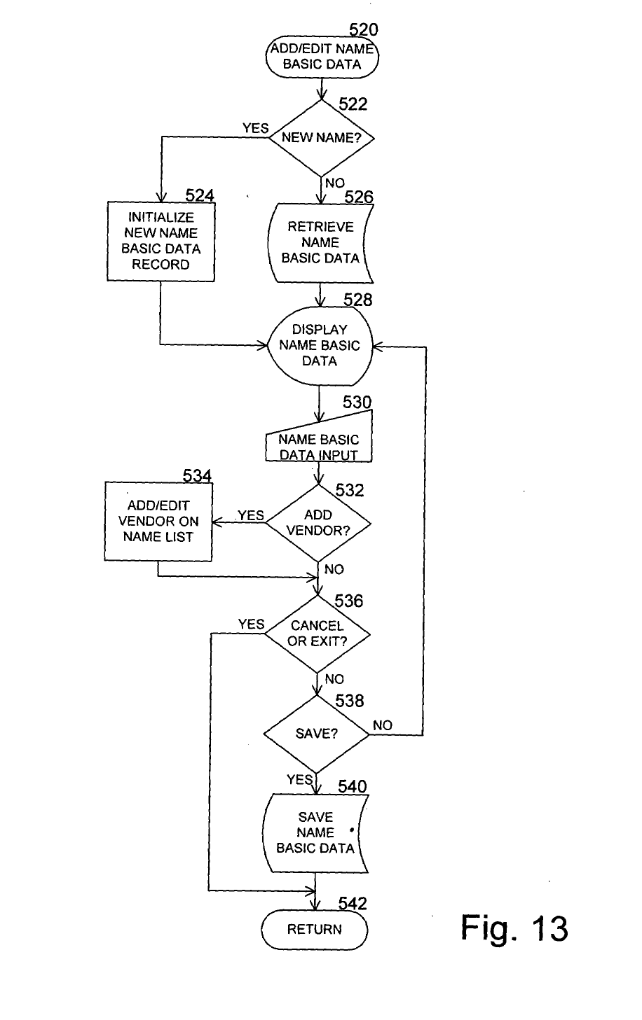

If it is determined at step 134 that at the HOME SCREEN 850 the user has selected the ADD NEW PATIENT icon button 870, then the ADD/EDIT NAME BASIC DATA Routine is executed beginning at subroutine 520 (FIG. 13). At the beginning of this routine, the system determines at step 522 whether or not a name is new. If the name is not new, then name basic data is retrieved at step 526 and displayed at step 528.

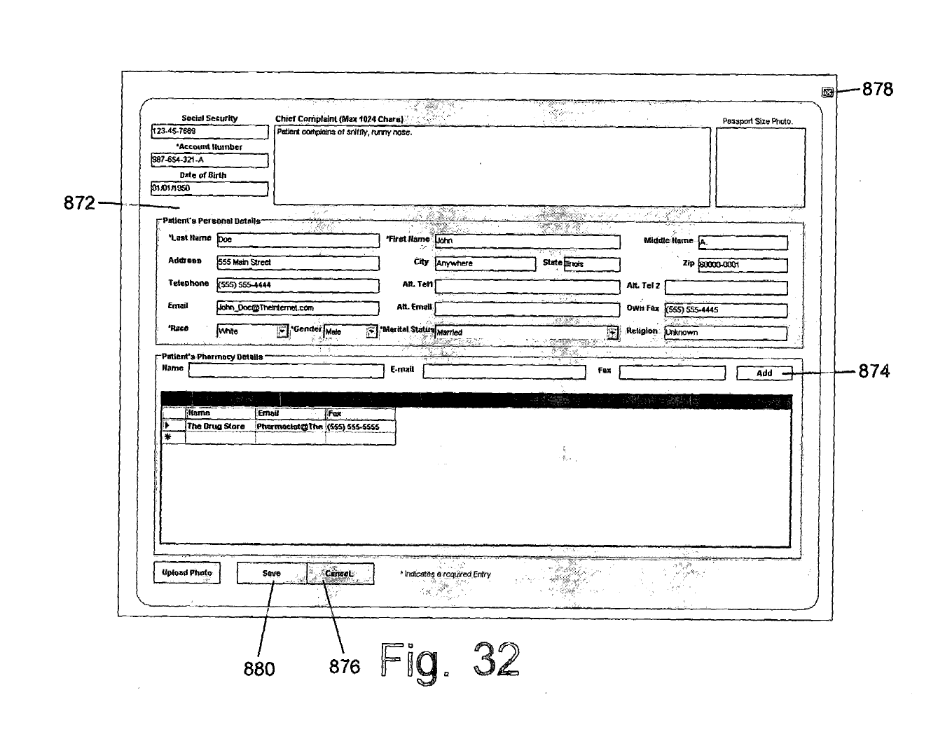

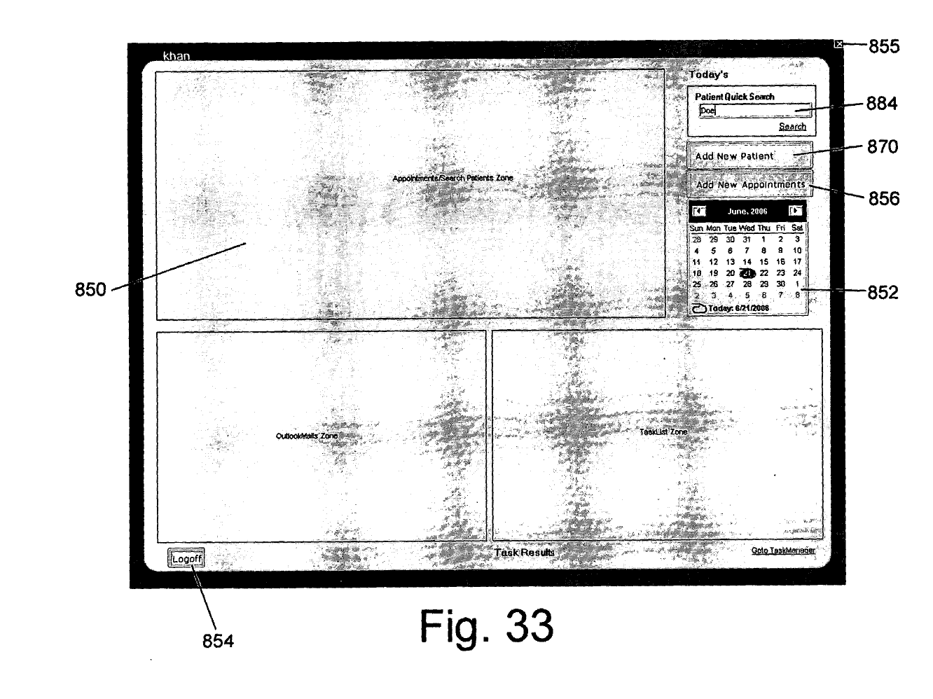

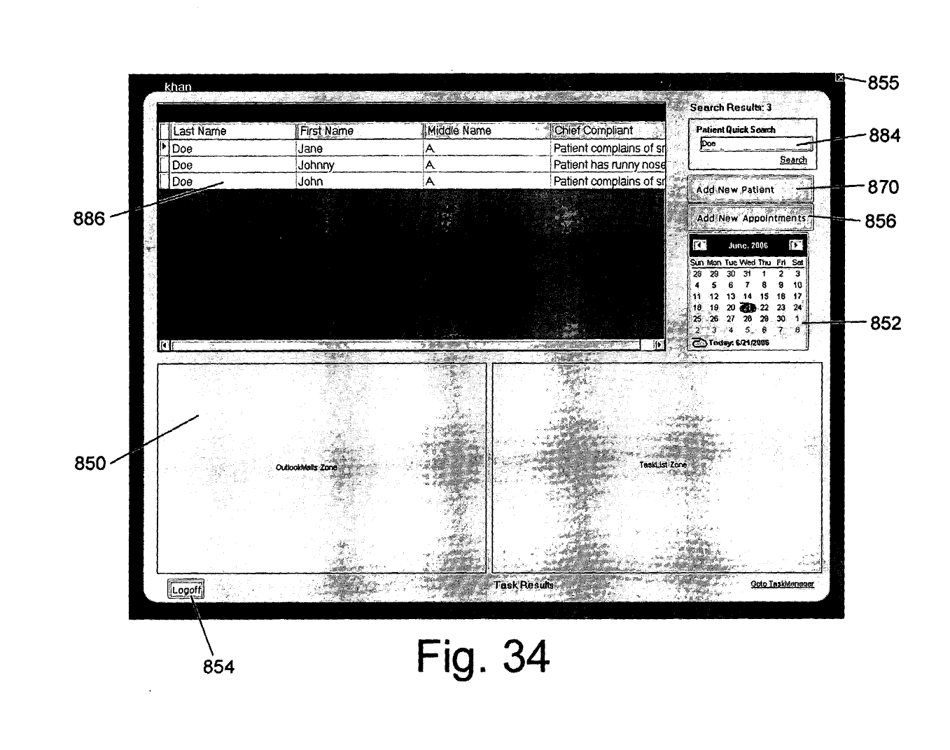

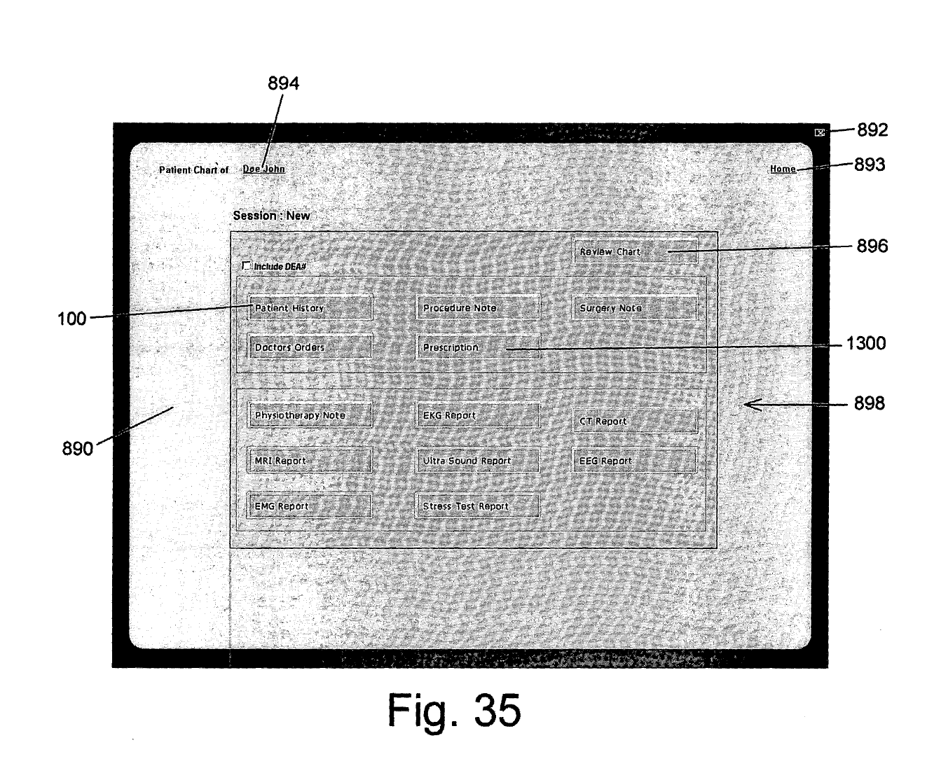

In the present example, a new patient is being added, so a new name basic data record is created and initialized at step 524. The PATIENT ENTRY FORM 872 is displayed at step 528 in a new window as seen in FIG. 32 with all text boxes initialized as blanks. Thereafter, the user can add, edit and delete patient information such as address, gender, date of birth, marital status, telephone number, e-mail address, preferred vending pharmacies and the like at step 530. If it is determined at step 532 that a pharmacy name is entered in the designated text box and the ADD button 874 is selected, then the pharmacy along with any e-mail address and facsimile telephone number therefor is added to the patient's pharmacy vendor list at step 534.

If the user has completed entry of the patient's basic information and the routine determines at step 536 that the user has selected the CANCEL button 876 or the EXIT icon 878, then processing branches to step 542 and any changes to the patient's information is disregarded and not saved to storage and the system returns to the HOME SCREEN 850 through the 1-Z connector 150 (FIGS. 3 and 4). If it is determined at step 538 that the user has selected the SAVE button 880, then the patient's information is saved to storage at step 540 and the system at step 542 returns to the HOME SCREEN 850. If neither option was selected, then processing branches back from step 538 and the name PATIENT ENTRY FORM 872 is redisplayed at step 528.

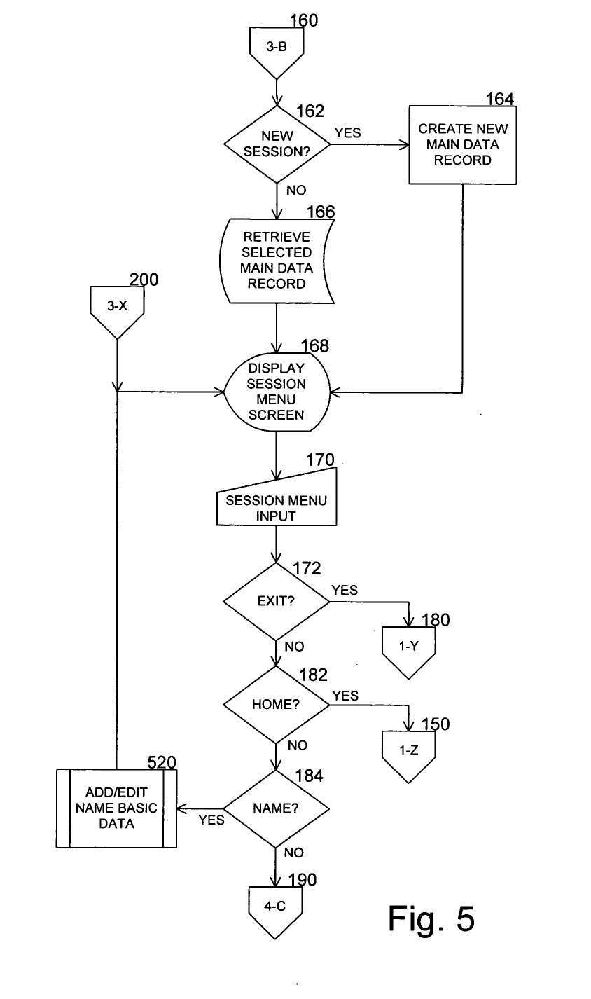

If it is determined at step 136 that the user has entered any text in the name search text box 884 on the HOME SCREEN 850 to specify any name or part of a name as seen in FIG. 33, then the system at step 138 retrieves a list of names matching the text and at step 140 adds them to the display. After continuing through the 1-Z connector 150 (FIGS. 3 and 4), the HOME SCREEN 850 is redisplayed at step 124 with the retrieved names listed in a new window 886 as seen in FIG. 34. With the names so listed, the user can move the cursor unto the name list window 886 and if it is determined at step 152 that a name thereon was selected, the system at step 154 retrieves data relating to the selected name from storage. Processing continues execution through the 3-B connector 160 (FIGS. 4 and 5).

At step 162 in FIG. 5, a decision is made whether the user session is new or continuing. If a new session, then processing branches to step 164 and a new main data record is initialized as a new chart with blank information. If a continuing session, then processing branches to step 166 and any information from the main data record that has been previously saved for that session is retrieved from storage so that an incomplete patient's chart may be completed. Thereafter, processing proceeds to step 168 where the SESSION MENU SCREEN 890 is displayed as seen in FIG. 35. User input is entered at step 170.

The user has a number of options that may be selected from the SESSION MENU SCREEN 890. If it is determined at step 172 that the user has selected the EXIT icon 892, then processing branches and continues through the 1-Y connector 180 (FIGS. 3 and 5), any required data is saved at step 120, any logoff procedures are executed at step 122, and processing terminates at step 118.

If it is determined at step 182 that the user has selected the HOME button 893, then processing branches and continues through the 1-Z connector 150 (FIGS. 3 and 5) and displays the HOME SCREEN 850 at step 124. If it is determined at step 184 that the user has selected the Patient's Name on line 894, then the system branches and executes the ADD/EDIT NAME BASIC DATA Routine 520 where the PATIENT ENTRY FORM 872 is displayed. Once the user has finished adding, editing or deleting data concerning the patient's basic information as described previously and has exited the data entry window, the system returns and executes step 168 to once again display the SESSION MENU SCREEN 890.

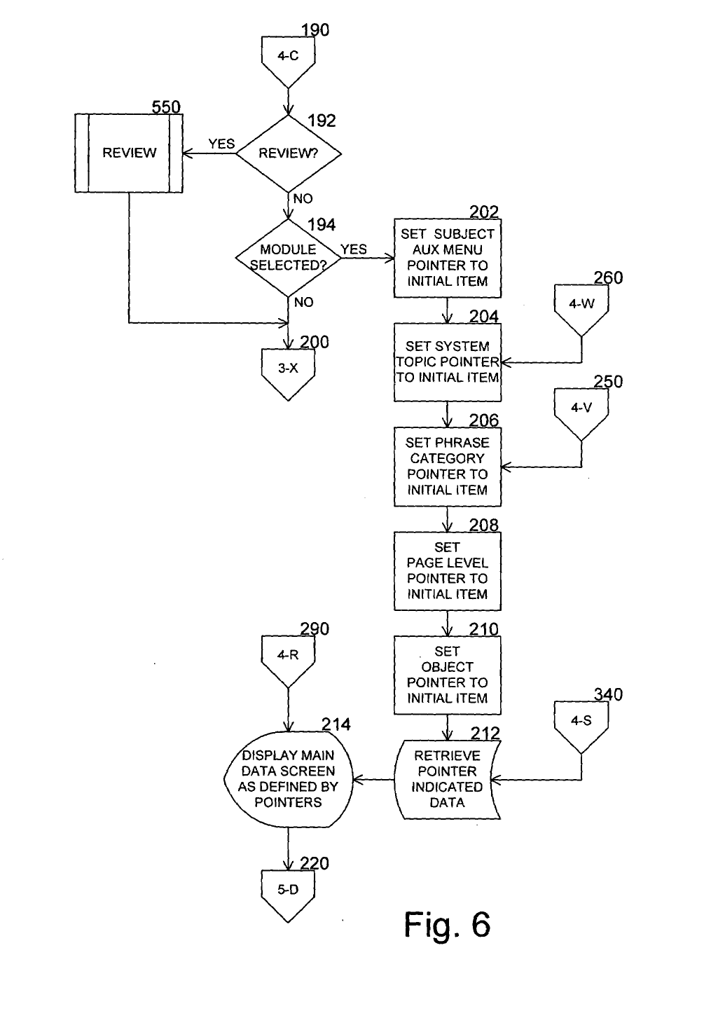

If it is determined at step 184 that the patient's name has not been selected, then processing continues through the 4-C connector 190 (FIGS. 5 and 6), where the computer determines at step 192 whether the user has selected the REVIEW CHART button 896. If the REVIEW CHART button 896 has been selected, processing branches to the Review Routine at subroutine 550. This option permits the user to look at and review previous documentation on the display and to print it out as hardcopy. The details of this operation will be described in further detail below under the subheading “12. Viewing and Printing a Chart/Prescription.”

When the user is viewing the SESSION MENU SCREEN 890, the user may select one of the modules from the plurality of labeled buttons, collectively designated 898, that are listed in the chart in FIG. 25. If it is determined at step 194 that none of the module options available on the SESSION MENU SCREEN 890 have been selected by the user, then processing continues through the 3-X connector 200 (FIGS. 5 and 6) to redisplay the SESSION MENU SCREEN 890 at step 168.

If it is determined at step 194 that a module option has been selected, a number of internal pointers are initialized. These pointers are used to keep track of the user's position within the system. For example, when the PATIENT HISTORY module 100 is selected, the auxiliary menu subject pointer is set at step 202 to indicate Common Complaint, the first subject item at the top of the auxiliary menu (the H&P Menu 924 described hereinafter), and the system topic pointer is set at step 204 to Common, the first topic in the module. The phrase category menu pointer is set at step 206 to indicate Dialect, the first set of text objects. The page level pointer is set at step 208 to indicate the first page of text objects within the first set of text objects. The text object pointer is set at step 210 to indicate the first of the text objects in the first page level. The function of these pointers will become more apparent from the description below.

Once the internal pointers have been set, menus and data are retrieved from storage at step 212 in accordance with the pointers and displayed at step 214 in the main data screen 800 as seen in FIG. 36. The main data screen 800 can be divided into a first display work area 802 or main text box, and a second display work area 804, and a menu area adjoining the work areas and broadly including command buttons 816 and tabs 818 (FIG. 44) and 820.

In the first display work area 802 at the top, the narrative will be written for each subject. In the second display work area 804 in the lower portion of the screen 800 are one or more series or lists of text objects or phrases.

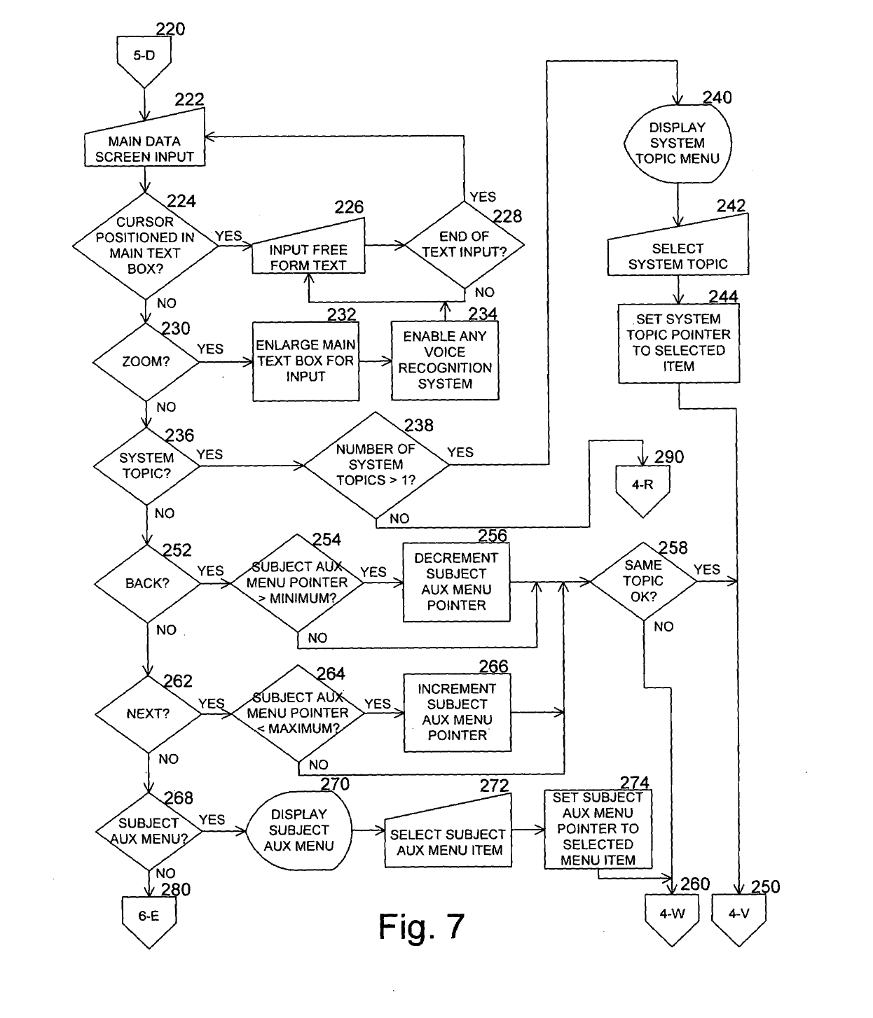

Continuing through the 5-D connector 220 (FIGS. 6 and 7), user input on the main data screen is accepted at step 222. If the user has positioned the cursor within the first display work area 802 as determined at step 224 in FIG. 7, then the user can at step 226 add, modify or delete any narrative text that is displayed within the first display work area 802. The freeform text editing of step 226 will continue until it is determined at step 228 that it has terminated. Narrative text displayed and saved from the first display work area 802 will become part of the generated documentation. While text can be manually entered from the alphanumeric keyboard 54 or handheld terminal 64 in a conventional manner one character at a time, the present invention contemplates an additional method of data entry, which is described in detail below.

### 6. Beginning a Basic Narrative Build

The method of constructing a narrative by building it from text objects contained in a predefined database of text objects or phrases is broadly diagrammed in FIGS. 6 through 11 (steps 202-434) and illustrated in FIGS. 36 through 106. The function of the various buttons diagrammed in FIGS. 7 through 9 will be described after a simple example of data entry is given. To summarize, a main data screen 800 (FIG. 36) is displayed at step 214 in FIG. 6 and user input entered via the main data screen 800 is collected at step 222. When the user is constructing a narrative for a patient chart, processing will generally repeatedly loop back to display step 214 and input step 222. The system then determines whether a text object has been selected or entered by the user or whether a command button has been selected by the user or whether some other function is to be carried out. Generally, during the build of a basic narrative described here, much of the processing occurs at steps 202-222, where the display is updated and data in entered, and at steps 376-388, where text objects are selected from one work area and copied into another work area.

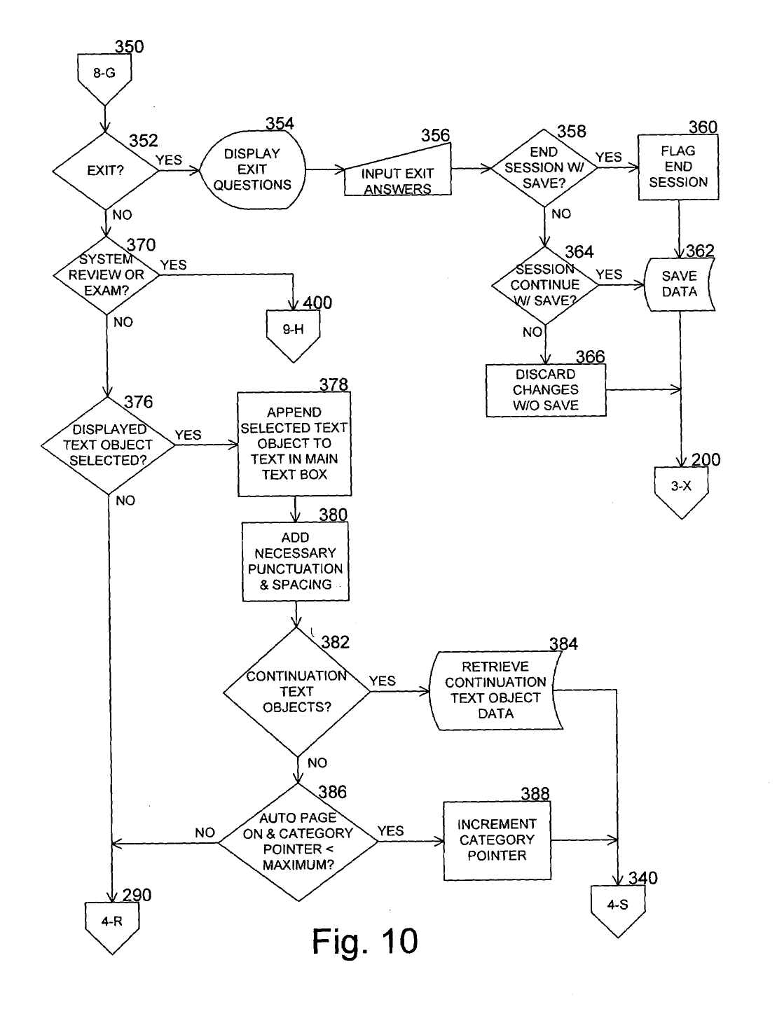

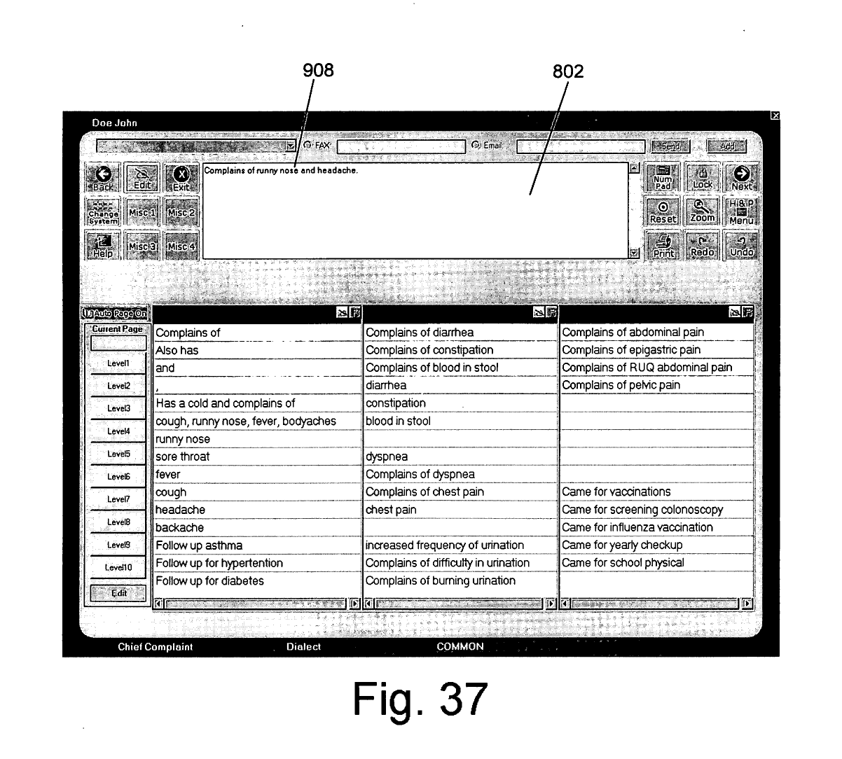

As an example, John Doe, a patient, arrives in a doctor's office with a runny nose, a headache and sinusitis and wants a flu shot. The initial template would be for the subject Chief Complaint, the topic Common, and the category Dialect with the first display work area 802 being blank as shown in FIG. 36. A list of text objects or phrase fragments is displayed in the second display work area 804 on the main data screen 800. If it is determined at step 376 (FIG. 10) that the user has in separate processing loops selected from the second display work area 804, “Complains of” on line 900, “runny nose” on line 902, “and” on line 904, and “headache” on line 906, then these respective text objects are sequentially copied and appended one at a time at step 378 into the first display work area 802 so that the concatenated result 908 as seen in FIG. 37 would be as follows: “Complains of runny nose and headache.” A period is automatically added as punctuation at step 380 when necessary. In this example, the system understands that the word “headache” ends a sentence. Further, the system will insert a period at the end of any text entry where the next text object begins with a capital letter. Since the auto page function, which will be described later herein, is not active at this point since there is only one category of phrases, it is decided at step 386 that processing will branch to step 214 to redisplay the current screen through the 4-R connector 290 (FIGS. 6 and 10).

### 7. Command Buttons

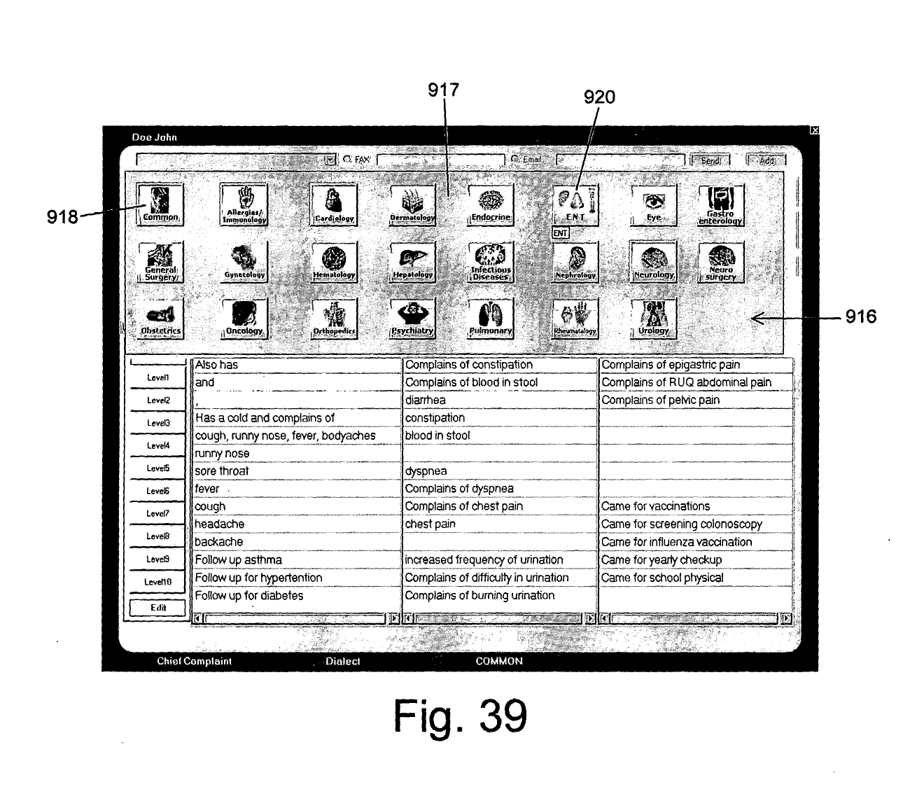

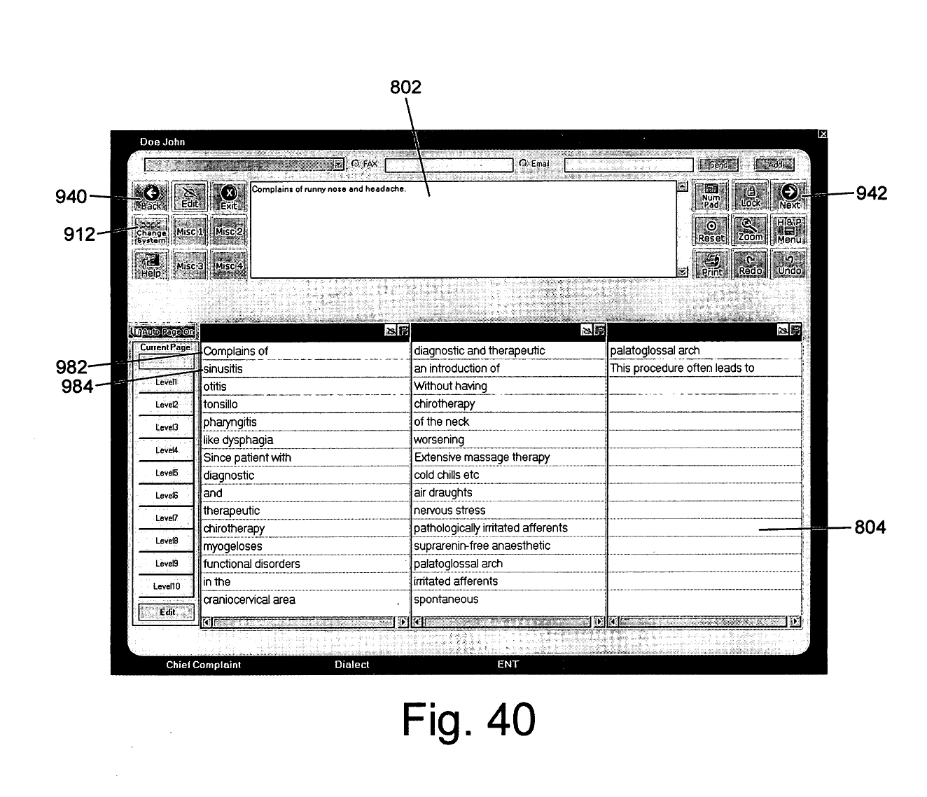

Returning now to FIG. 36, there are many options on a data entry display that the user can employ to increase the functionality of the system. After any user input entered at step 222, the system beginning at step 224 determines whether it should process text information as described above or whether some command function should be executed. For example, the user can add or edit text data, change systems (topics), change phrase categories, edit phrase lists, change icon and menu labels, or the like. The button 910 at the right labeled H&P MENU is used to view the auxiliary Subject Menu 924 (FIG. 43) and change the current subject being displayed and the button 912 at the left labeled CHANGE SYSTEM is used to view the Topic Menu 916 (FIG. 39) and change the current topic being displayed. Changing the subject or topic will result in a change of the visual template displayed as well as the phrases listed in the second display work area 804.

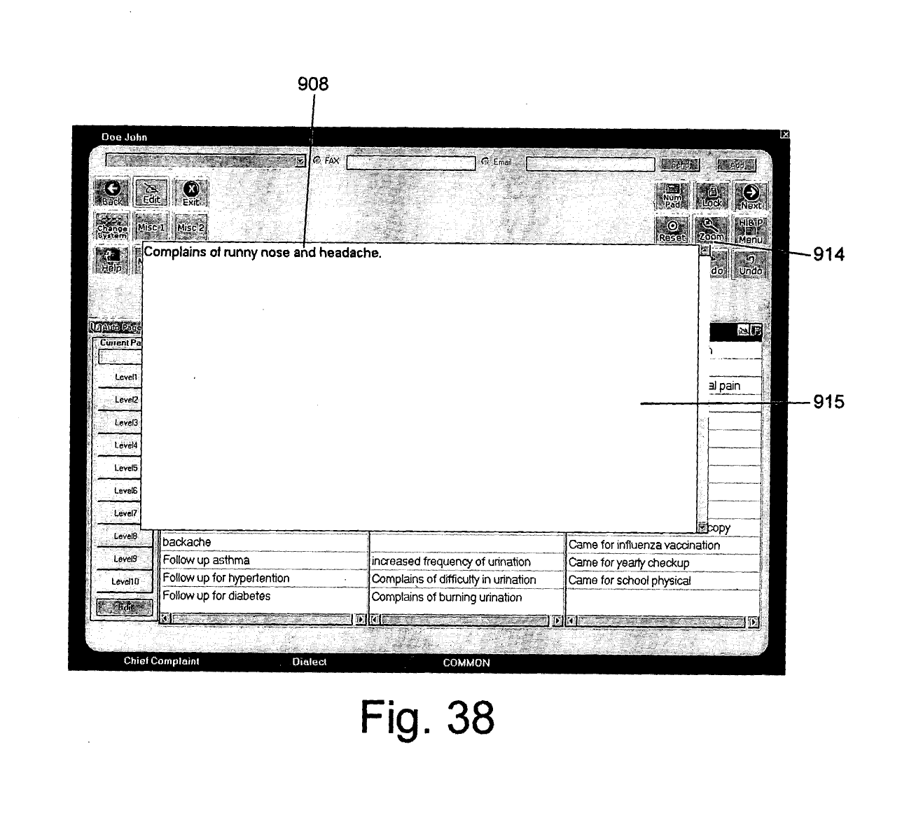

If at step 230 in FIG. 7 it is determined that the ZOOM button 914 has been selected in step 222, then the first display work area 802 is expanded at step 232 and overlies the main data screen 800 in an enlarged window 915 shown in FIG. 38. The text can once again be edited in a freeform format and an optional voice recognition system can be enabled at step 234 to permit entry of text orally.

If at step 236 in FIG. 7 it is determined that the CHANGE SYSTEM button 912 has been selected in step 222, then at step 238 there is a determination if there is more than one topic for the current subject. If not, then processing branches back to redisplay the main data screen 800 at step 214 through the 4-R connector 290 (FIGS. 3 and 7). If the subject has more than one topic, then a topic menu 916 listing the various body system topics that are available under the current subject is displayed at step 240 in an overlying window 917 (FIG. 39). The user then selects a topic at step 242, the topic pointer is set at step 244, and the main data screen 800 is redisplayed at step 214 through the 4-V connector 250 (FIGS. 6 and 7).

If at step 252 in FIG. 7 it is determined that the BACK button 940 has been selected in step 222, then the system at step 256 decrements or goes back one subject when it is also determined at step 254 that it is not already at the first subject. If at step 262 in FIG. 7 it is determined that the NEXT button 942 has been selected in step 222, then the system at step 266 increments or goes forward one subject when it is determined at step 264 that it is not already at the last subject. If at step 258 it is determined that the same topic exists for the old subject as well as for the newly selected subject, processing will continue through the 4-V connector 250 (FIGS. 6 and 7) to step 206 without changing the topic pointer. However, if the same topic does not exist for the old subject and for the newly selected subject, then processing will continue though the 4-W connector 260 (FIGS. 6 and 7) and the topic pointer will be reset at step 204 to the first topic available under the newly selected subject. In both cases, the main data screen 800 for the new subject and topic is displayed at step 214 after the relevant subject, topic category, page and object have been set and relevant data retrieved from storage at step 212.

If at step 268 in FIG. 7 it is determined that the H&P MENU button 910 has been selected in step 222, then the H&P Menu 924 listing the subjects available is displayed at step 270 in an overlying window 925 (FIG. 43) as an auxiliary menu. At step 272 the user selects one of the subjects on the menu 924. At step 274 the subject pointer is reset and the template for the specified subject and topic is displayed at step 214 through the 4-W connector 260 (FIGS. 6 and 7), which resets the topic, category, page and object pointers.

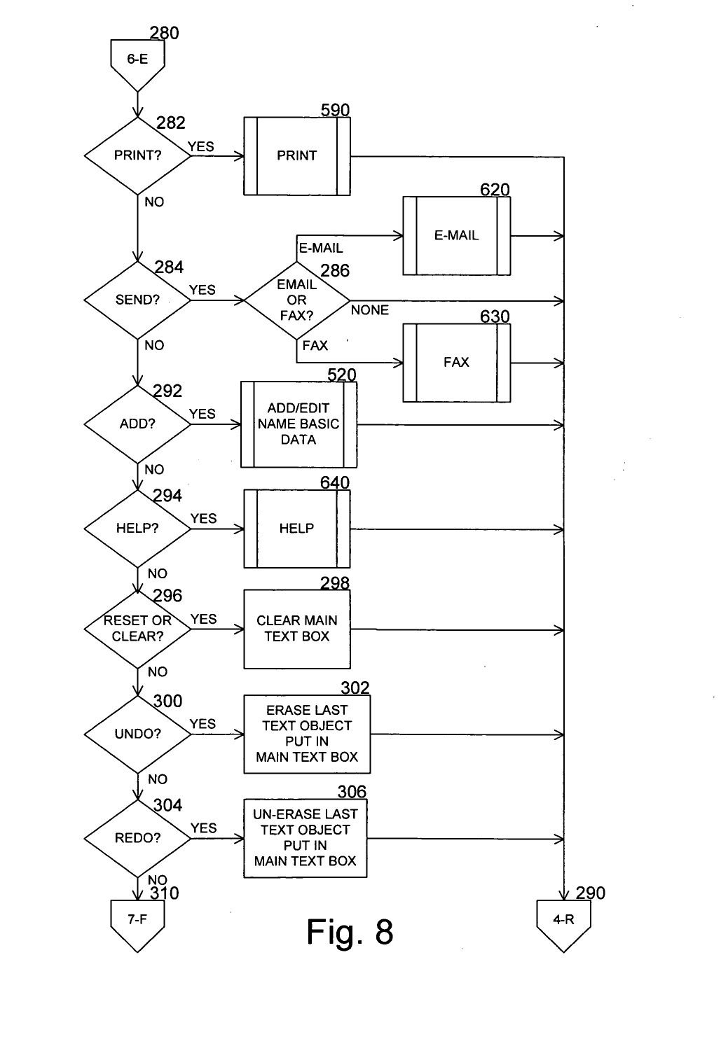

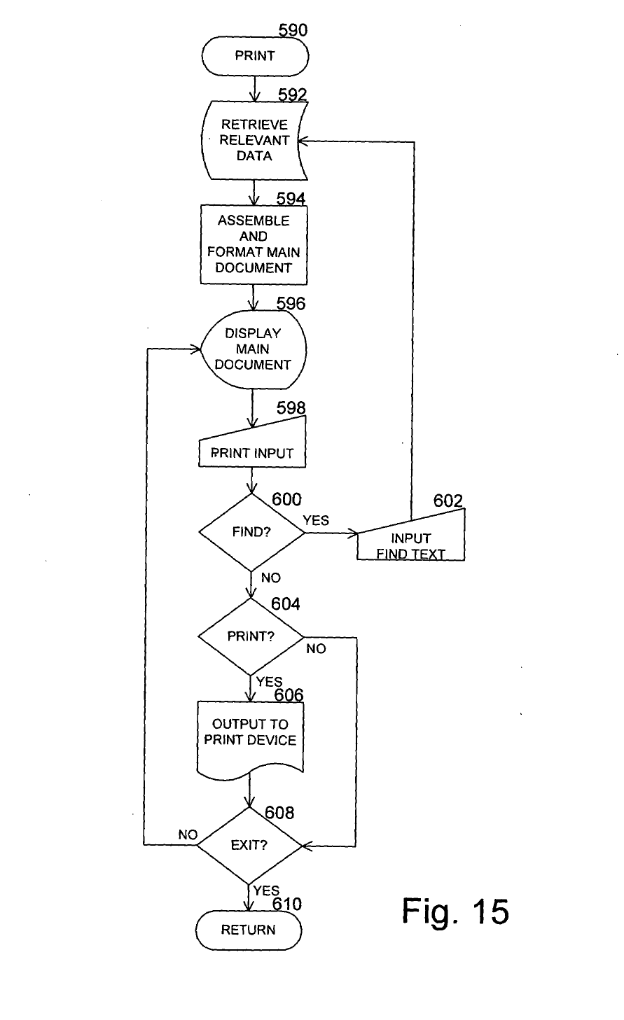

Continuing from the 6-E connector 280 (FIGS. 7 and 8), if at step 282 in FIG. 8 it is determined that the PRINT button 944 has been selected in step 222, then the Print Routine is executed beginning at subroutine 590 (FIG. 15). At step 592 relevant data is retrieved from storage and that data is assembled and formatted at step 594 into the appropriate document and displayed at step 596. The system then waits for user input at step 598. If it is determined at step 600 that the user wants a document with different data, then the user inputs his request at step 602 and processing branches back to step 592 to retrieve the relevant data. If it is determined at step 604 that the user wants to have hardcopy, then the document is output to the print device at step 606. Otherwise, printing is skipped and processing branches to step 608. If it is determined at step 608 that the user wants to continue printing functions, then processing branches back from step 608 and the document is redisplayed at step 596 and further input awaited at step 598. If it is determined at step 608 that the user wants to terminate printing functions, then processing returns at step 610 through the 4-R connector 290 (FIGS. 6 and 8) to redisplay the main data screen 800 at step 214.

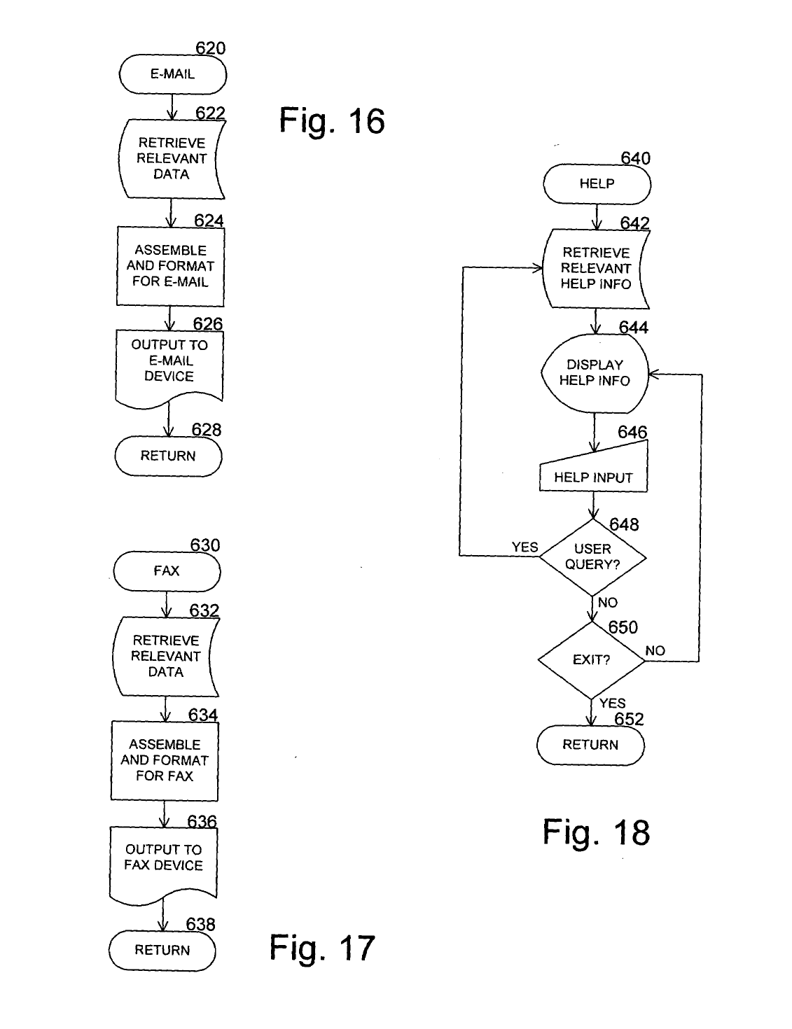

If at step 284 in FIG. 8 it is determined that the SEND button 814a has been selected in step 222, then a decision is made at step 286 whether the E-mail radio button 812b has been marked and, if so, execution of the E-Mail Routine begins at subroutine 620 (FIG. 16), or if the fax radio button 812a has been marked and, if so, execution of the Fax Routine begins at subroutine 630 (FIG. 17).

At the E-mail subroutine 620 (FIG. 16), relevant e-mail information is retrieved from storage at step 622, assembled and formatted at step 624 and sent as output to the e-mail device (internet or fax modem) at step 626. After transmission of the e-mail, processing returns from step 628 and the main data screen 800 is redisplayed at step through the 4-R connector 290 (FIGS. 6 and 8).

At the Fax subroutine 630 (FIG. 17), relevant fax information is retrieved from storage at step 632, assembled and formatted at step 634 and sent as output to the fax device (internet or fax modem) at step 636. After transmission of the fax, processing returns from step 638 and the main data screen 800 is redisplayed at step through the 4-R connector 290 (FIGS. 6 and 8).

If at step 292 in FIG. 8 it is determined that the ADD button 814b has been selected in step 222, then the Add/Edit Name Basic Data subroutine 520 (FIG. 13) is executed. This operation and function of this routine has been described above. The main data screen 800 is then redisplayed at step 214 through the 4-R connector 290 (FIGS. 6 and 8).

If at step 294 in FIG. 8, it is determined that the HELP button 946 has been selected in step 222, then execution of the Help Routine begins at subroutine 640 (FIG. 18). Help information is retrieved from storage at step 642, displayed at step 644 and user input requested at step 646. If there is a user query, then processing branches at step 648 and pertinent information responding to the query is retrieved from storage at step 642 and displayed at step 644. If the user wants to exit, then processing branches at step 650 and returns from step 652 to redisplay the main data screen at step 214 through the 4-R connector 290 (FIGS. 6 and 8). If neither option was selected, then the Help Routine continues with the redisplay of help information at step 644.

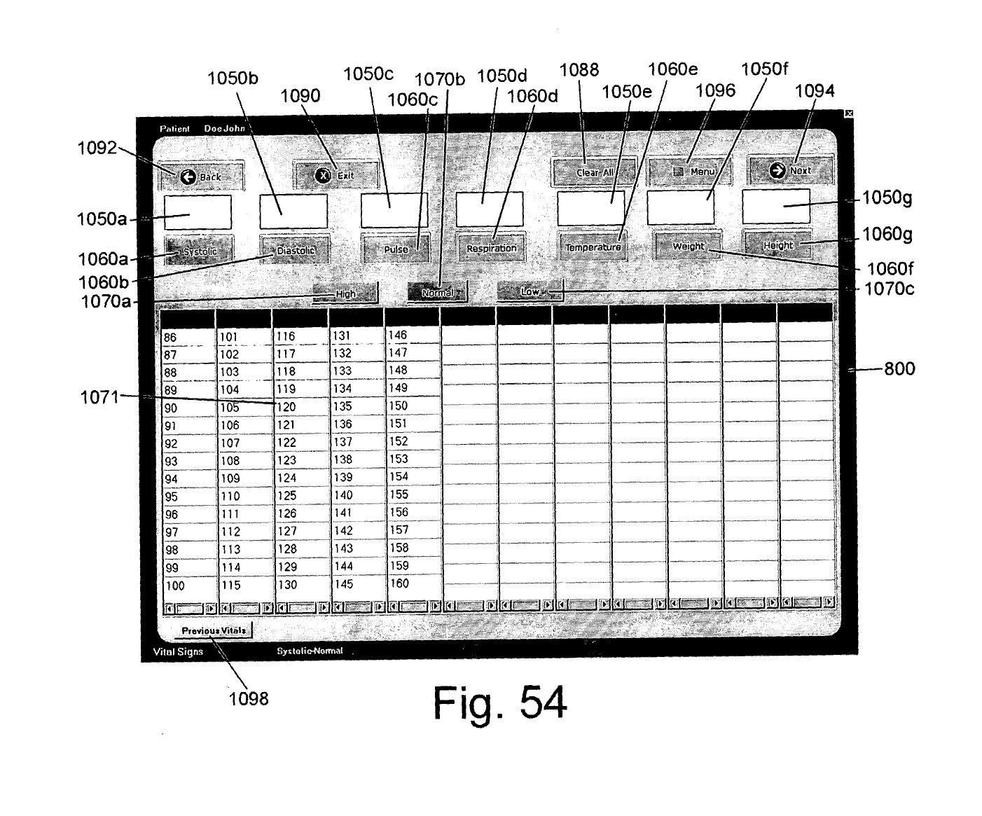

If at step 296 in FIG. 8, it is determined that the CLEAR or RESET button 948 was selected, then the first display work area 802 or work boxes 1050 (FIGS. 54-62) are cleared at step 298 and the main data screen 800 is redisplayed at step 214 through the 4-R connector 290 (FIGS. 6 and 8).

If at step 300 in FIG. 8, it is determined that the UNDO button 950 was selected, then the last text object placed into the first display work area 802 is erased at step 302. The main data screen 800 is then redisplayed at step 214 through the 4-R connector 290 (FIGS. 6 and 8).

If at step 304 in FIG. 8 it is determined that the REDO button 952 was selected, then the last text object that was erased from the first display work area 802 is reinserted at step 306. The main data screen 800 is then redisplayed at step 214 through the 4-R connector 290 (FIGS. 6 and 8).

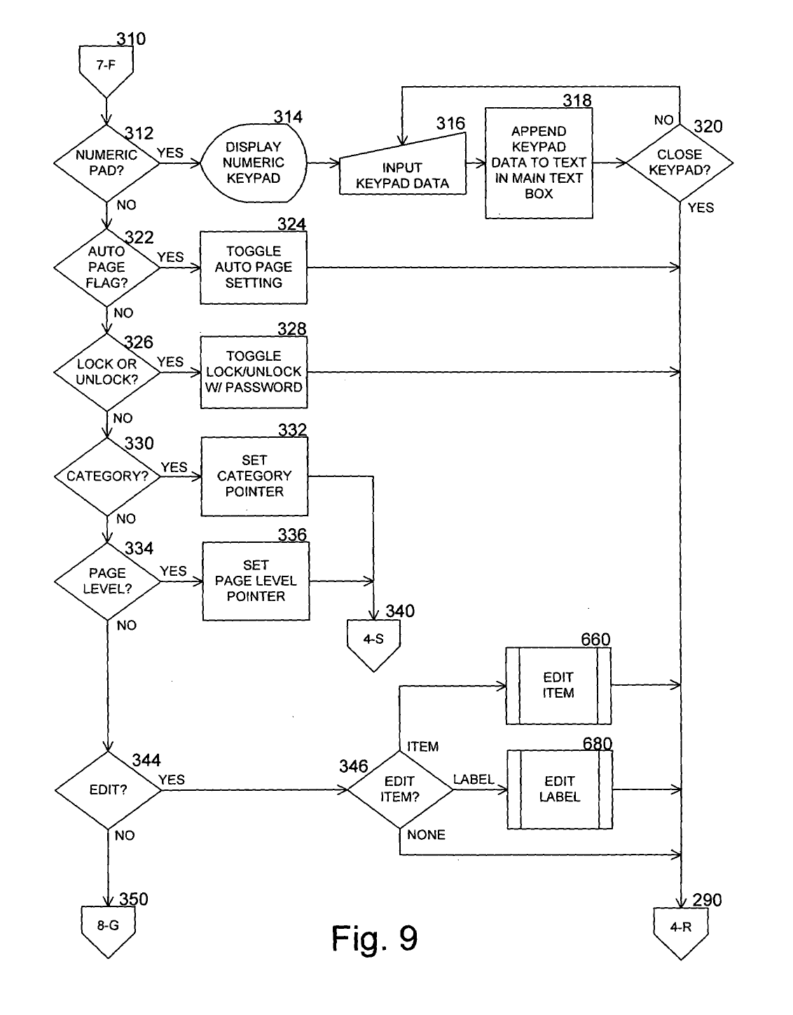

Continuing from the 7-F connector 310 (FIGS. 8 and 9), if at step 312 in FIG. 9 it is determined that the NUM PAD button 954 was selected, then a virtual numeric keypad is displayed at step 314 in an enlarged, overlying window 956 entitled “Numbers, Weight & Measures” as shown in FIG. 102. The user can then enter character data at step 316 using a mouse to click on any displayed alphanumeric key or text object and have it appended at step 318 to existing text data, if any, displayed in the first display work area 802. If the keypad is closed at step 320 by selecting the keypad close key 958, then processing branches to redisplay the main data screen at step 214 through the 4-R connector 290 (FIGS. 6 and 9); otherwise, processing branches to step 316 to accept more characters from the numeric keypad.

If at step 322 it is determined that the AUTO PAGE ON button 960 has been selected, then at step 324 the automatic pagination function will alternately either be toggled on or toggled off. The function of the AUTO PAGE ON button 960, which is located above the Page Level Menu 820, is to toggle on and off automatic sequential display of one list of phrases within one category to another list of phrases within the next category. If turned off, then any selection of a text object within one category will not cause a new set of text objects to be automatically displayed. Without auto paging, the user can select multiple text objects from the list of phrases displayed under one category. After selecting the AUTO PAGE ON button 960, processing continues to step 214 to display the main data screen 800 at step 214 through the 4-R connector 290 (FIGS. 6 and 9).

If at step 326 it is determined that the LOCK button 962 has been selected, then further input to the system is locked at step 328 until the system in unlocked by entering a password. Thereafter, processing continues at step 214 to display the main data screen through the 4-R connector 290 (FIGS. 6 and 9).

If at step 330 it is determined that a PHRASE CATEGORY tab 818 (FIG. 44) has been selected, then the category pointer is set to the selected category at step 332 and the screen template for the active subject, topic and new category is displayed at step 214 through the 4-S connector 340 (FIGS. 3 and 9).

To the left of the text objects listed in the second display work area 804 is the Page Level Menu 820, which has a plurality of vertically arranged page level buttons for selecting the current page of text objects to be displayed in the phrase lists. The phrase pages are initially set to the first or topmost page of list. However, if at step 334 it is determined that a PAGE LEVEL icon button 820 has been selected, then the page level pointer is set to the selected page at step 336 and the screen template for the active subject, topic, category and new page level is displayed at step 214 through the 4-S connector 340 (FIGS. 3 and 9). As a result, new phrase lists of text objects are displayed. The current active Page Level may be displayed in the dialog box at the top of the Page Level Menu 820. The labels on the Page Level Menu buttons are protected but may be changed as more fully described hereinafter by clicking on the Edit icon 966 below the Page Level Menu buttons to enable editing, clicking on a page menu item, typing in a new label, and clicking on the Edit icon 966 again to disable editing.

In the header lines of each column of listed text objects in the second display work area 804 are an EDIT icon 970 and a SAVE icon 972. The text objects in the second display work area 804 are protected and not editable until editing is affirmatively enabled. Text objects may be modified by clicking on the EDIT icon 970, editing, adding or deleting one or more text objects on the list, and then saving the changes by clicking on the SAVE icon 972 to disable further editing. If phrases are too long to be displayed, then the horizontal scroll bars at the column bottoms may be used to reposition the text within the displayed columns.

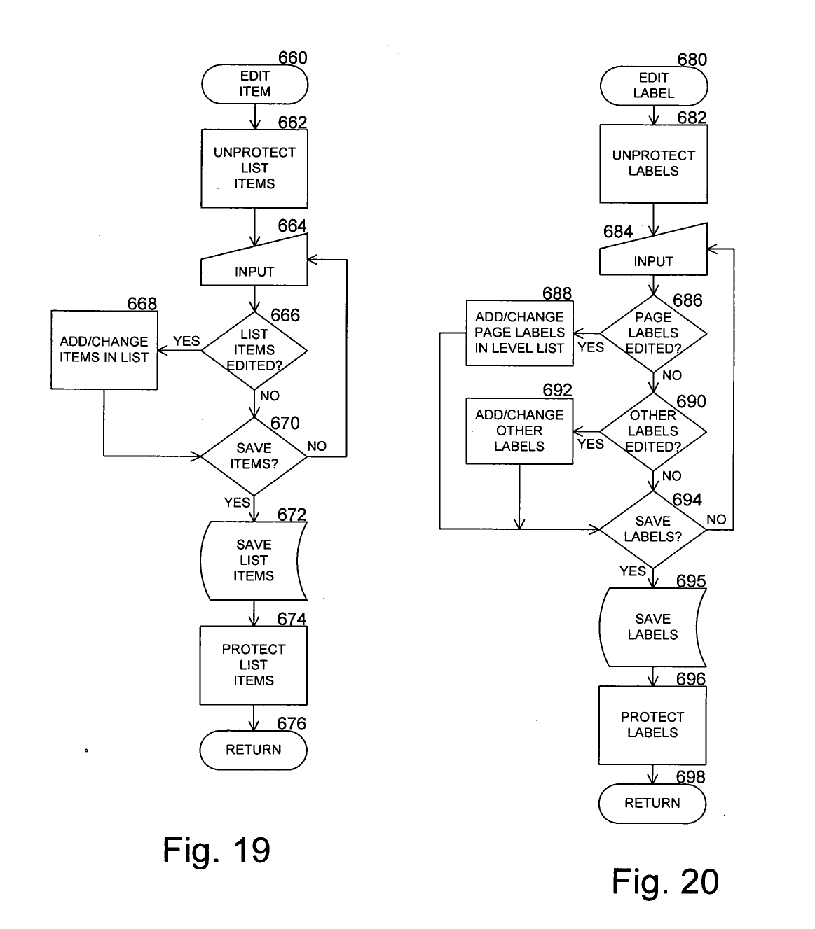

At step 344 a determination is made whether an edit icon has been selected. If not, then processing will continue through the 8-G connector 350 (FIGS. 9 and 10) to determine if any other functions have been selected. If an edit icon was selected, then processing will branch to step 346 where a decision is made whether the user wants to edit a text item or not. If so, execution branches to the Edit Item Routine beginning at subroutine 660 (FIG. 19). If the user wants to edit a label, then execution branches to the Edit Label Routine beginning at subroutine 680 (FIG. 20).

If text objects or phrase items are to be edited in any column in the second display work area 804, then the Edit Item subroutine 660 (FIG. 19) is executed and the text objects listed in the second display work area 804 are changed to unprotected editable fields at step 662. At step 664 user input is accepted and if at step 666 it is determined that text object has been selected, then the user is allowed to edit the text object at step 668. If after continuing, it is determined at step 670 that the user has not selected the Save icon 972, then processing branches back to await additional user input once again at step 664. If the Save icon 972 has been selected, then processing branches to step 672 to save the changes to storage, the text objects are changed back to protected uneditable fields at step 674, and processing returns at step 676 to redisplay the main data screen 800 at step 214 through the 4-R connector 290 (FIGS. 6 and 9).

If labels are to be edited, then the Edit Label subroutine 680 (FIG. 20) is executed and the labels listed in the Page Level Menu 820 are changed to unprotected editable fields at step 682. At step 684, user input is accepted. If at step 686, it is determined that a page label has been selected, then the user is allowed to edit the page label at step 688. If at step 690 it is determined that another label has been selected for editing, then the user is allowed to edit that label at step 692. If after continuing, it is determined at step 694 that the user has not picked the Edit button 966 again, then at step 694 processing branches back to await additional user input once again at step 684. If the Edit button 966 has been picked again, then processing branches to step 695 to save the changes to storage, the labels are changed back to protected uneditable fields at step 696, and processing returns at step 698 to redisplay the main data screen 800 at step 214 through the 4-R connector 290 (FIGS. 6 and 9).

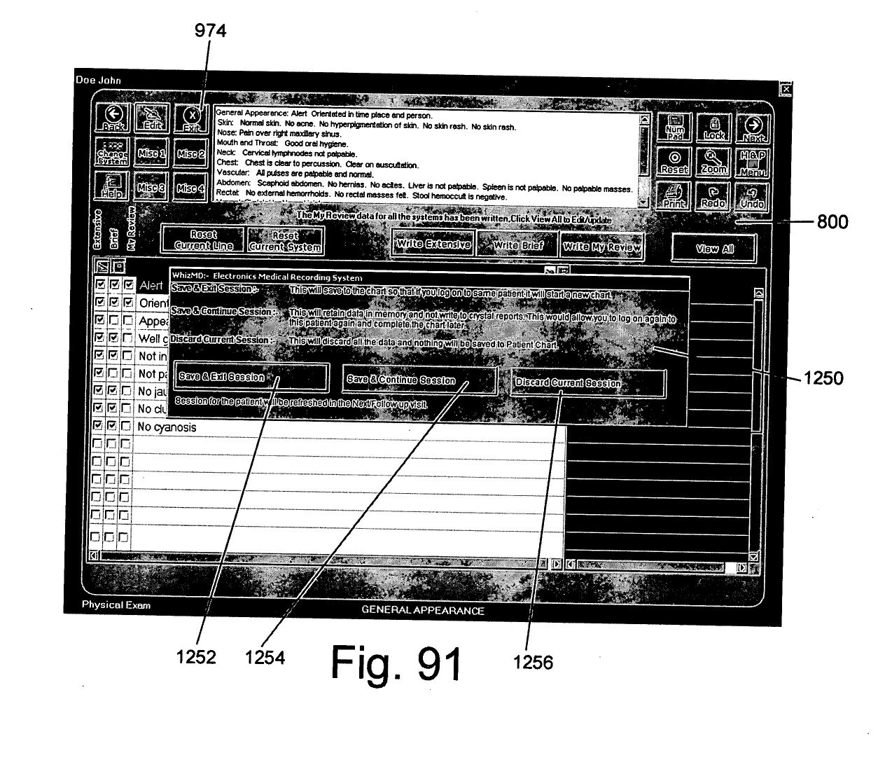

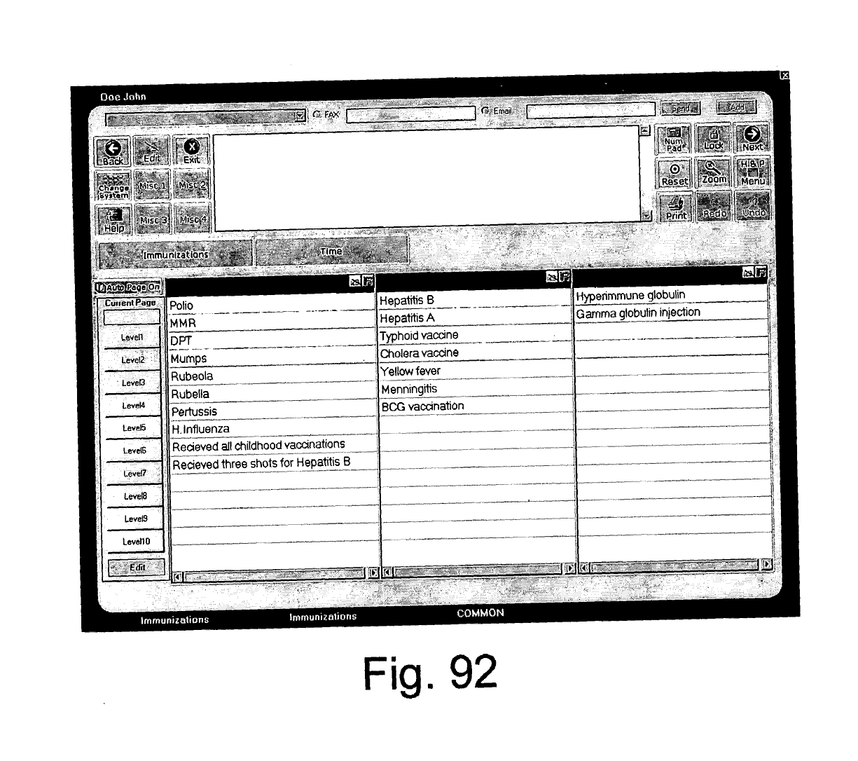

When processing continues through the 8-G connector 350 (FIGS. 9 and 10), if at step 352 it is determined that the EXIT button 974 or the Exit icon 976 has been selected, then exit questions posed in the overlying window 1250 shown of FIG. 91 are displayed at step 354 and input from the user awaited at step 356. As seen, the user can click on the Save & Exit Session button 1252, or the Save & Continue Session button 1254, or the Discard Current Session button 1256. If it is determined at step 358 that the user wants to end the session and save data, then the session is flagged as ended at step 360 and relevant data is saved to storage at step 362. Otherwise, processing branches to step 364. If the user wants to continue the session and save data, then processing branches from step 364 and relevant data is saved at step 362. Otherwise, processing branches to step 366 and any new data is discarded and not saved. Upon exit, the SESSION MENU SCREEN 890 is redisplayed at step 168 through the 3-X connector 200 (FIGS. 5 and 10).

The EDIT button 978 to the left of the EXIT button 966 permits a user to edit labels and menus.

The MISC1, MISC2, MISC3 and MISC4 icons, collectively designated 980, are merely dummy buttons for additional functions that might be implemented in the future.

### 8. Continuing the Basic Narrative Build

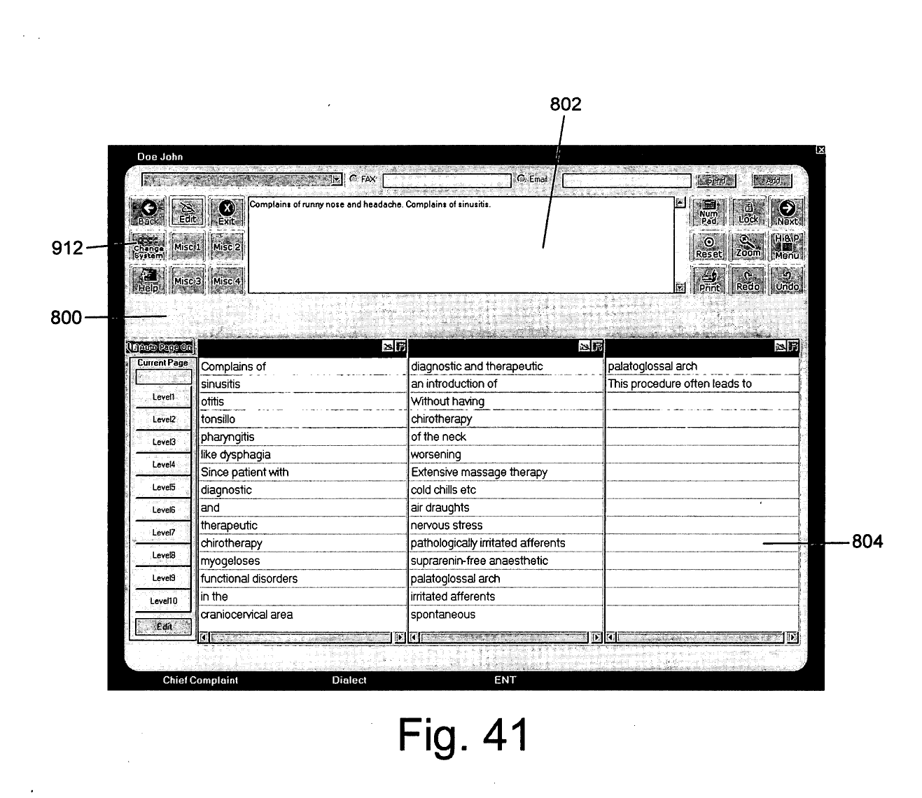

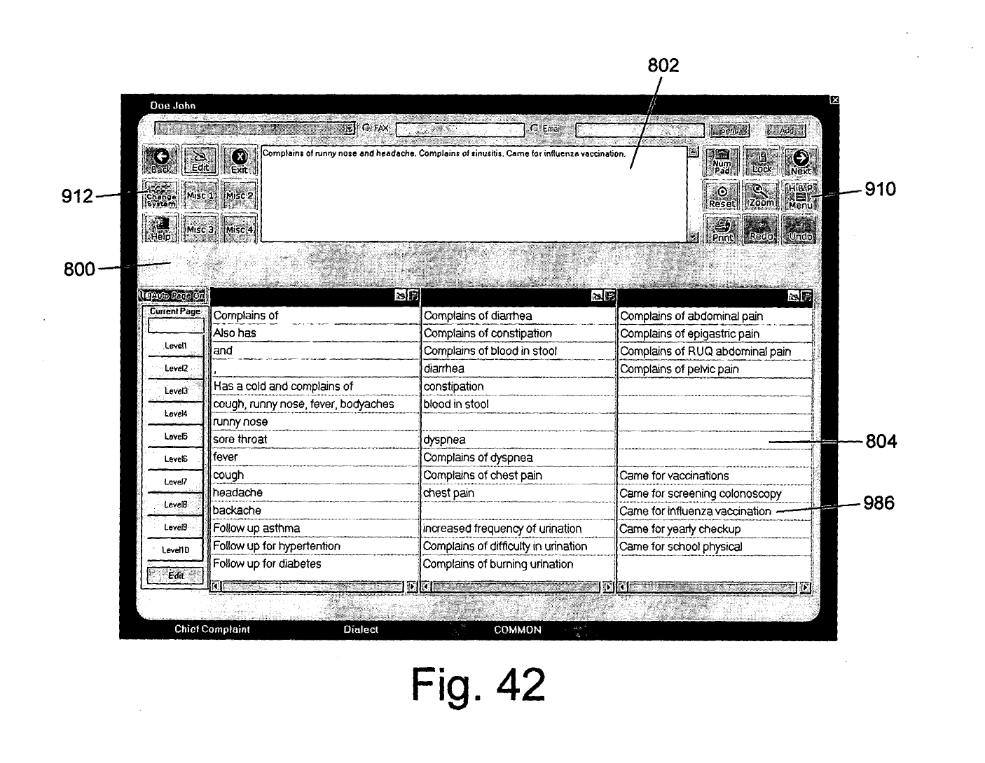

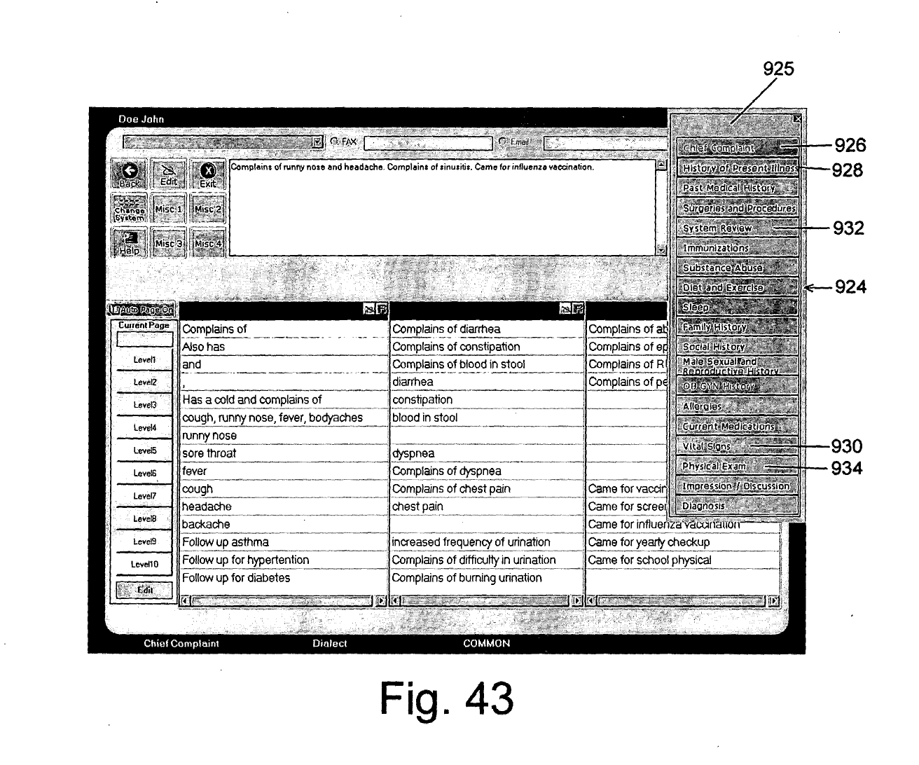

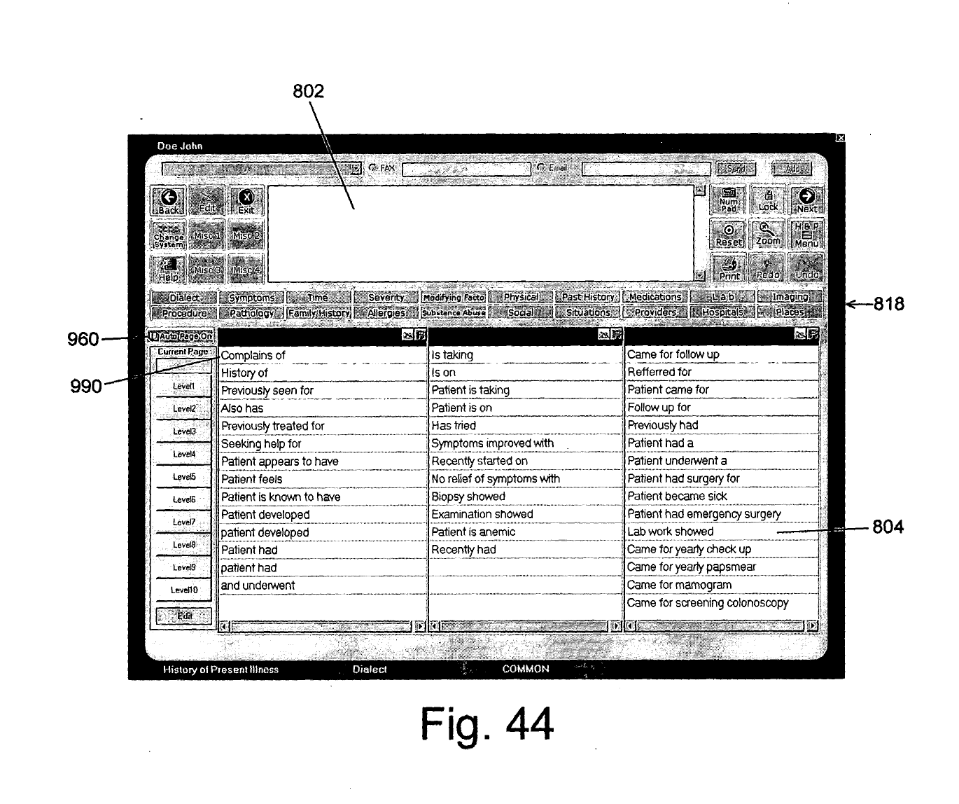

If the patient complains further that he believes that he also has sinusitis, the user may continue with the patient interview and select the CHANGE SYSTEM button 912 to change the topic. By so doing, a new window 917 is opened as seen in FIG. 39 showing a menu 916 of the various body system topics that are available under the Chief Complaint subject. The user selects the ENT (Eye Nose Throat) icon 920 to change the system to ENT. As seen at the bottom of FIG. 40, the screen template would now be for the subject Chief Complaint, the topic ENT, and the category Dialect with a new list of relevant text objects. The user, in turn, selects from the second display work area 804, “Complains of” on line 982 and “sinusitis” on line 984, which are appended to the text already displayed in the first display work area 802 as seen in FIG. 41.

Thereafter, the user selects the CHANGE SYSTEM button 912, picks the “Common” icon 918 from the choices in the Topic Menu window 917, and selects “Came for influenza vaccination” on line 986 from the third column of the second display work area 804. As a result, the first display work area 802 has a complete narrative of the patient's complaints and wants as seen in FIG. 42.

Next, the user enters a history of the present illness. By selecting the H&P MENU button 910 in the main data screen menu area, a list of subjects are listed in an overlying menu window 925 as seen in FIG. 43, including the currently active subject Chief Complaint 926, which is out of focus and cannot be selected because it is already active. Similarly, “OB GYN” is inactive and cannot be selected because that subject only relates to females and John Doe is coded as a male. To construct a history narrative, the user selects the subject “History of Present Illness” 928 from the H&P (History and Physical) Menu 924. Thereafter, the screen template as shown in FIG. 44 would be displayed for the subject History of Present Illness, the topic Common, and the category Dialect.

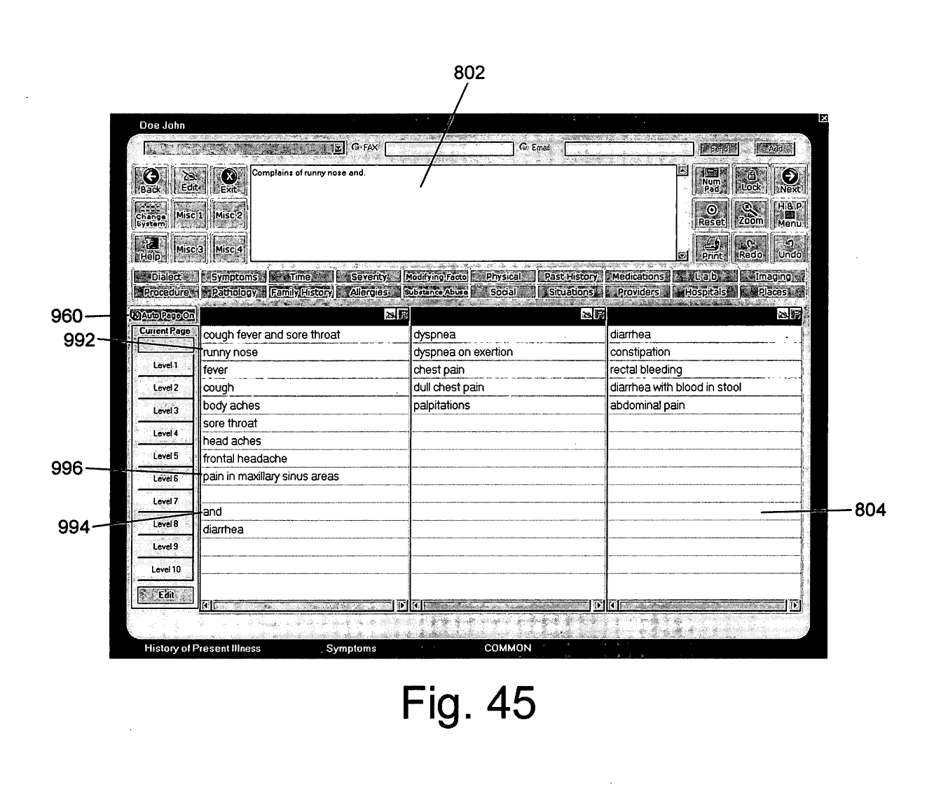

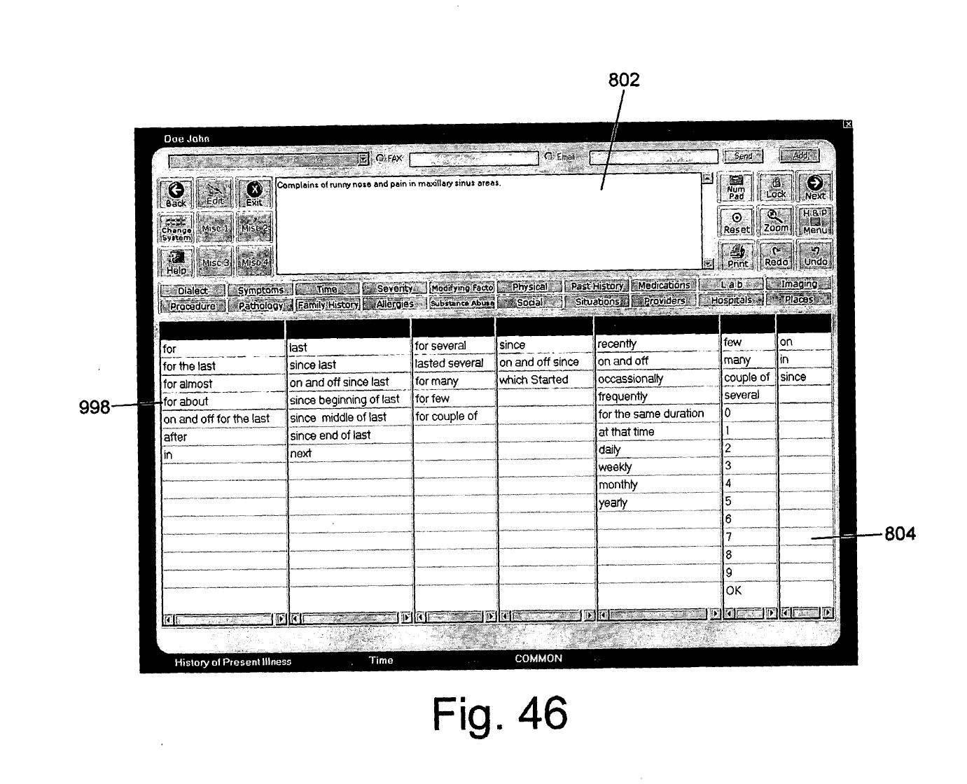

When the user takes the patient's history, which begins as an empty text area 802, the user will now select the phrase “Complains of” on line 990 from the second display work area 804. Since automatic paging is turned on and there is more than one category of phrases for the currently active subject and topic as determined by step 386, the category is incremented at step 388 to “Symptoms.” The user now turns automatic paging off by clicking on the AUTO PAGE ON icon 960 to toggle an “X” over the page icon so that the categories will not be automatically incremented until automatic paging is turned back on. The user the, in turn, selects the phrases “runny nose” on line 992 and “and” on line 994, which are appended to the end of “Complains of” in the first display work area 802 as seen in the template displayed in FIG. 45. Thereafter, the user, in turn, toggles the automatic paging back on and selects the phrase “pain in maxillary areas” on line 996, which is appended to the text already present the first display work area 802. The system then increments to the next phrase category Time as seen in FIG. 46.

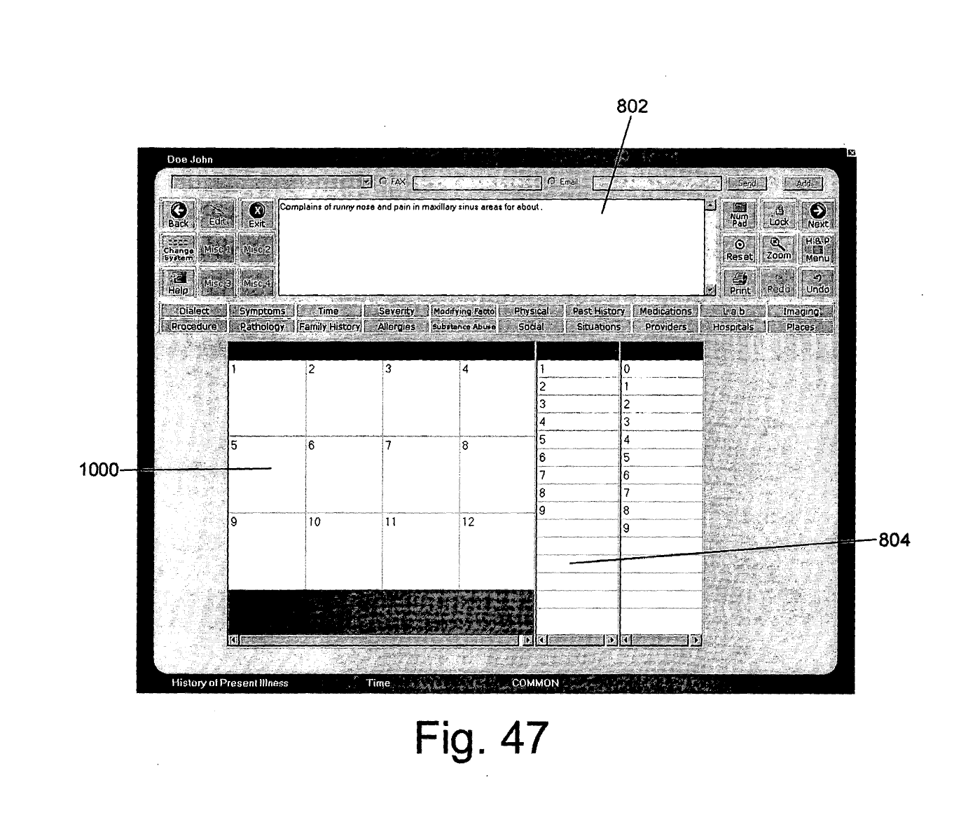

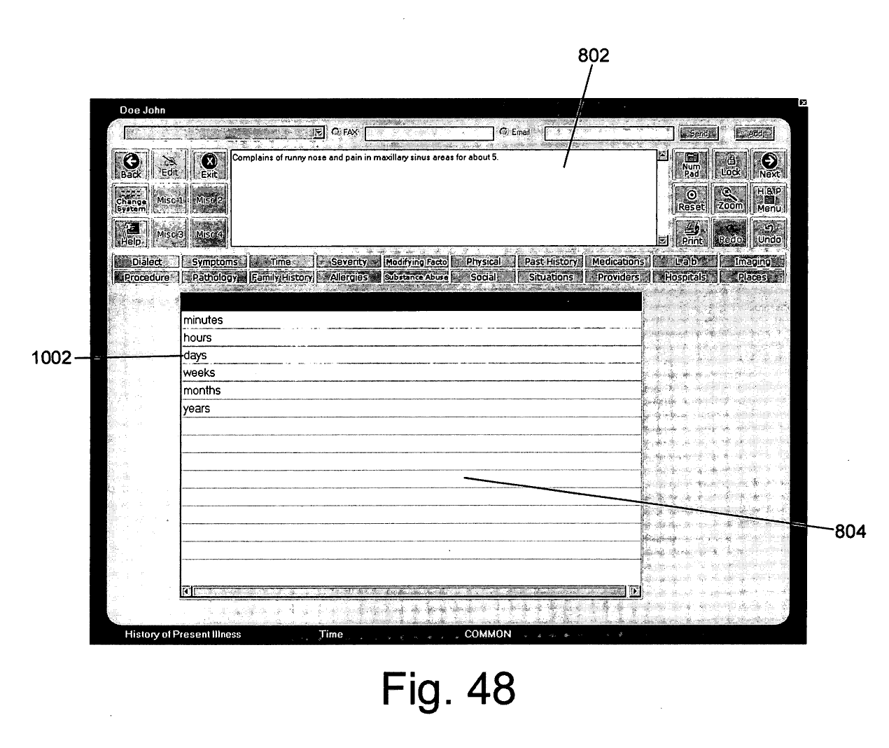

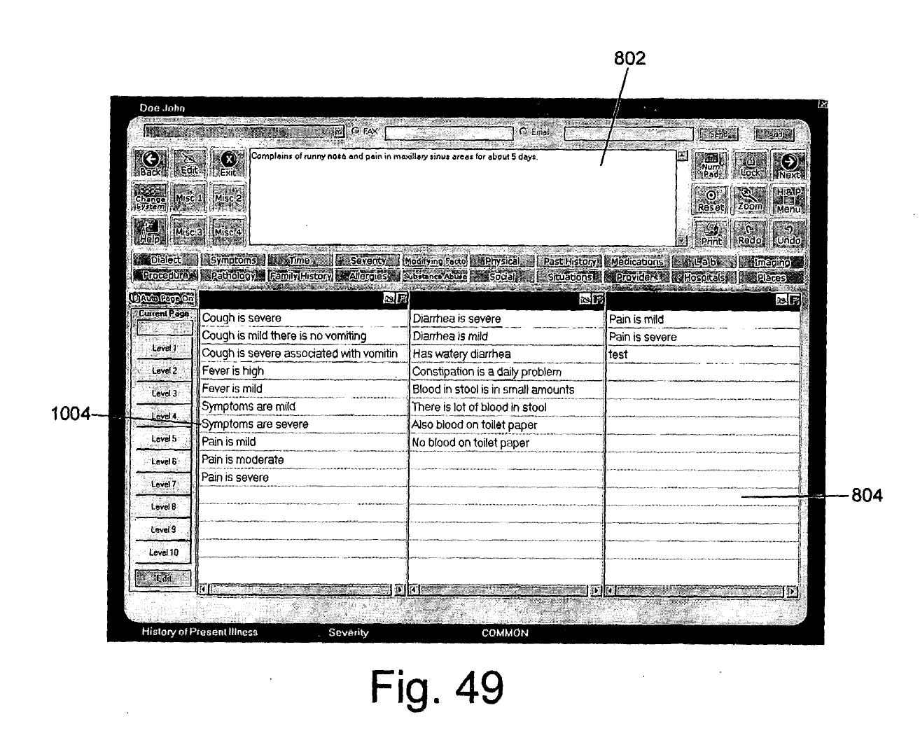

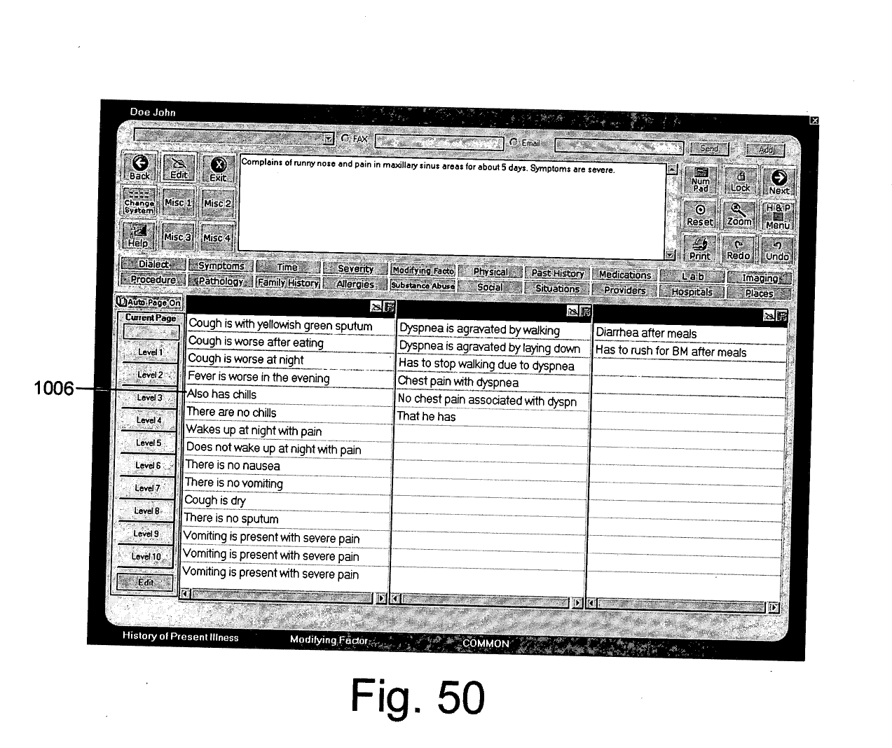

In the template seen in FIG. 46, the user selects from the second display work area 804 the phrase “for about” on line 998 in the first column, and then the number “5” in box 1000 from the template seen in FIG. 47. When it is determined at step 382 that additional or continuation phrases are required for any phrase to construct a complete or grammatically proper phrase construction, as required here for the phrase category Time, one or more continuation phrase lists, or text object lists, are retrieved from storage at step 384. Processing continues through the 4-S connector 340 (FIGS. 6 and 10) and a display template is generated with an array of the newly retrieved continuation text objects listed in the second display work area 804. The specific text objects displayed in the second display work area 804 is dependent on the subject, topic, and any previously selected text that have been copied into the first display work area 802. Thereafter, when the user selects the phrase “days” on line 1002 from the second display work area 804 of FIG. 48 and it is appended to the text already in the first display work area 802, the narrative “Complains of runny nose and pain in maxillary areas for about 5 days” will have been generated in the first display work area 802 as the narrative for the History of Present Illness. Thereafter, the phrase category is automatically incremented to the next category Severity as displayed in FIG. 49.

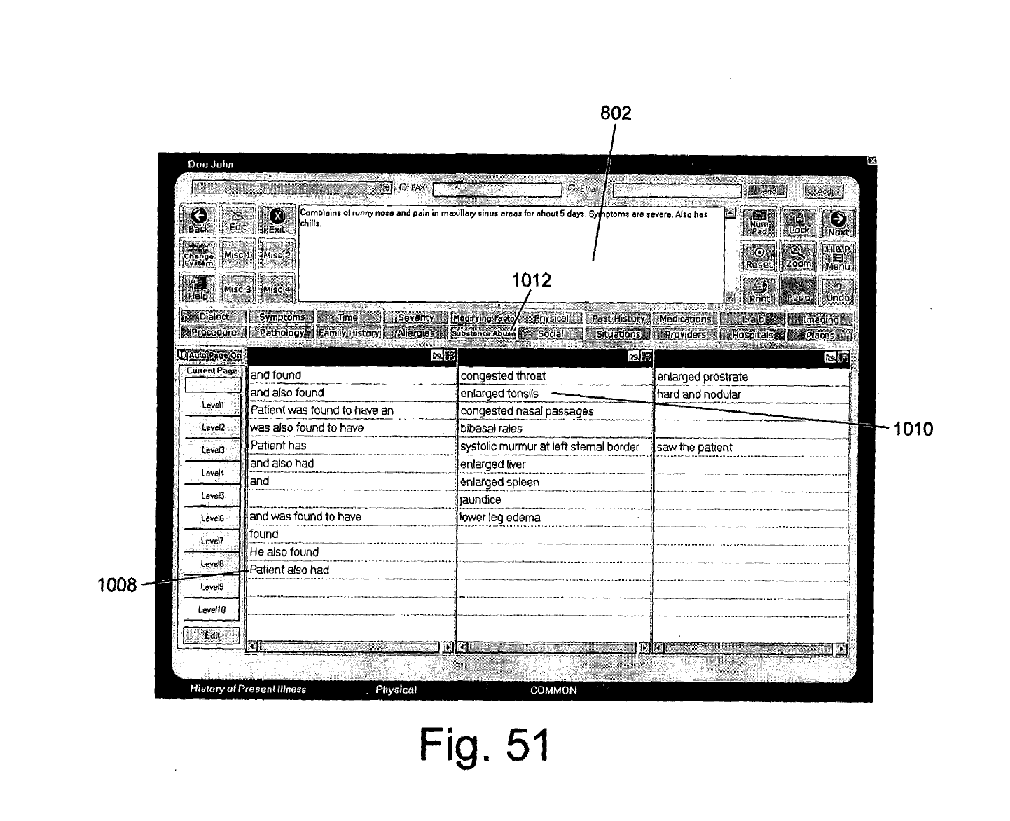

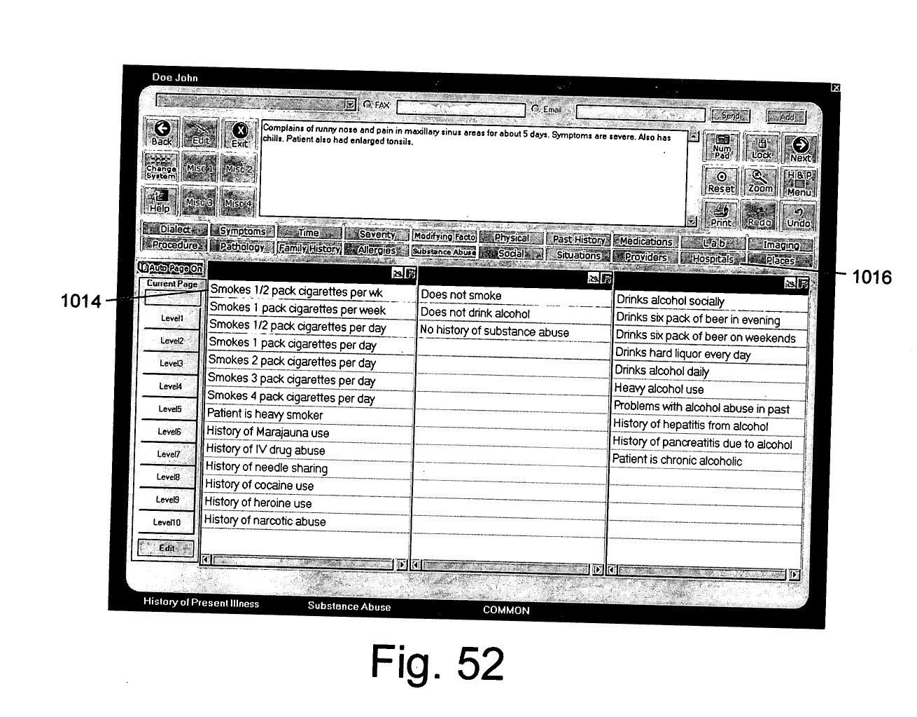

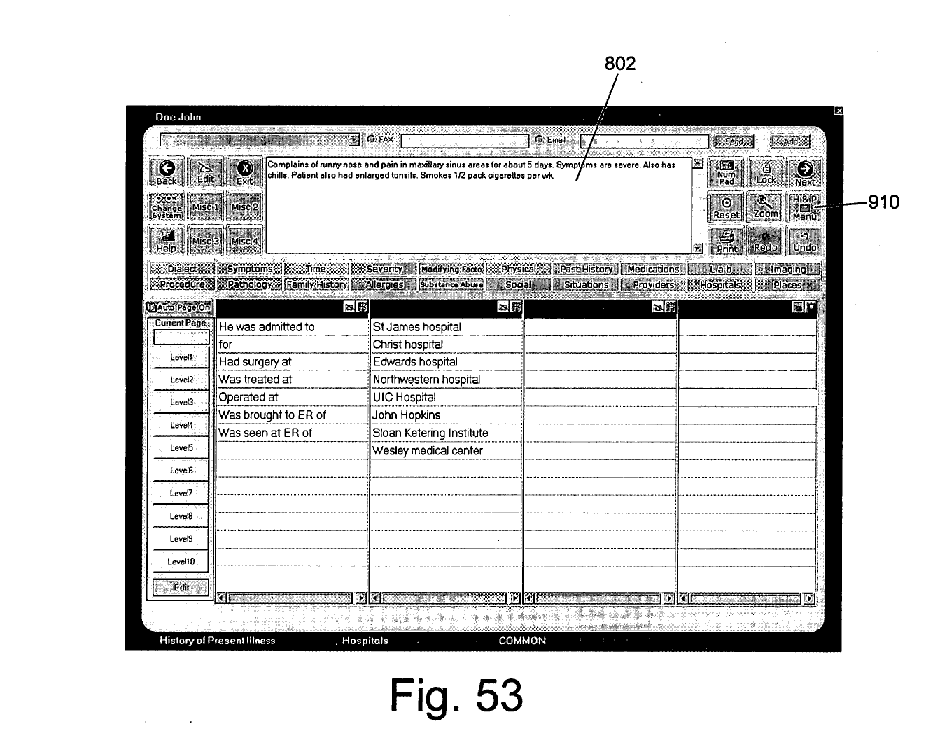

From the category Severity, the user selects from the first column “Symptoms are severe” on line 1004. Thereafter, the phrase category is automatically incremented to the next category “Modifying Factor” as displayed in FIG. 50. From the Modifying Factors category, the user selects from the first column “Also has chills” on line 1006. As displayed in FIG. 51, the first display work area 802 now has the additional text “Symptoms are severe. Also has chills”. The template displayed in FIG. 51 shows the phrases appropriate for the category Physical. Here, the user, in turn, selects “Patient also had” on line 1008 and “enlarged tonsils” on line 1010, which are appended onto the text within the first display work area 802.

Now proceeding to the “Substance Abuse” category, the display template shown in FIG. 52 for the subject History of Present Illinois, topic Common and category Substance Abuse will be active. From FIG. 52, the user selects “Smokes ½ pack of cigarettes per wk” on line 1014 from column 1. Thereafter, the user can proceed to the category “Hospitals.” The display template shown in FIG. 53 will then be active with all of the previous constructed narrative built for the subject History of Present Illness being displayed in the first display work area 802.

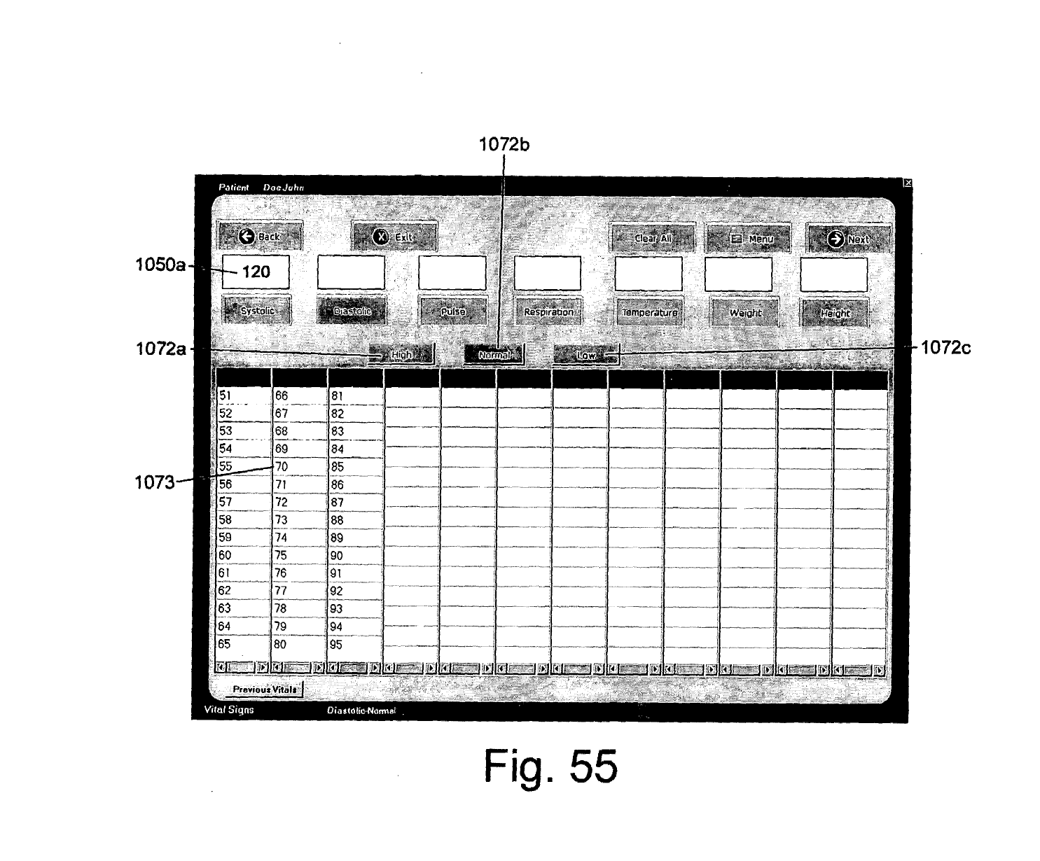

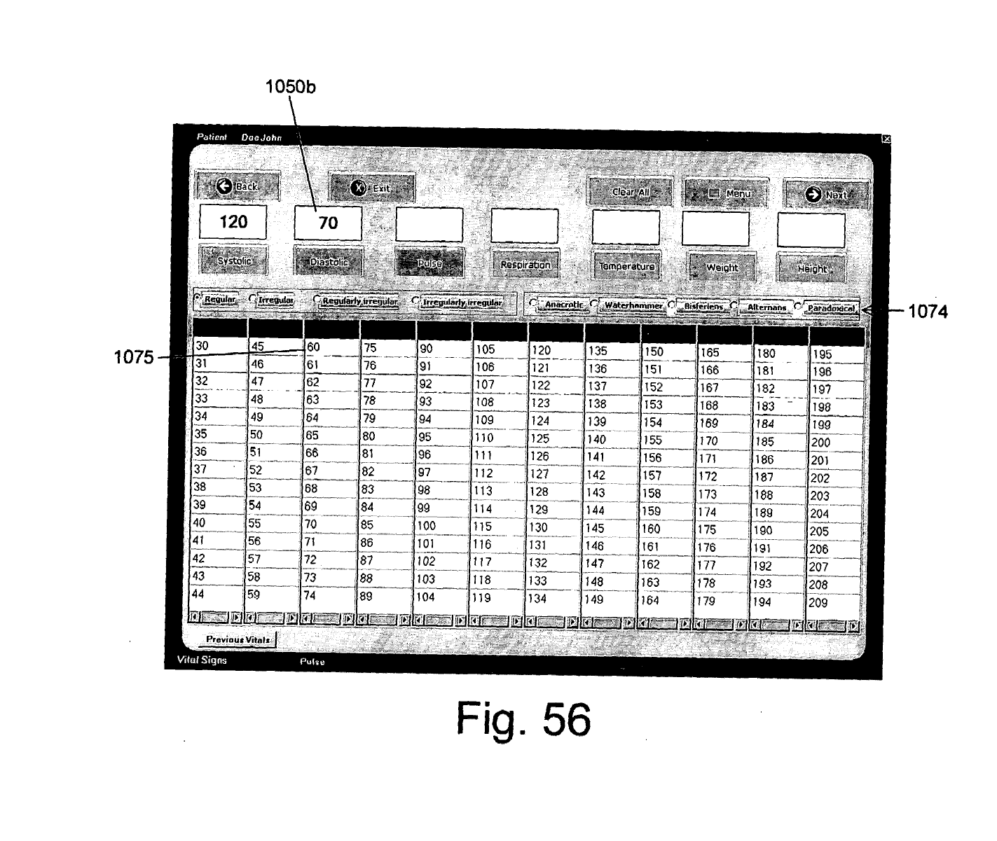

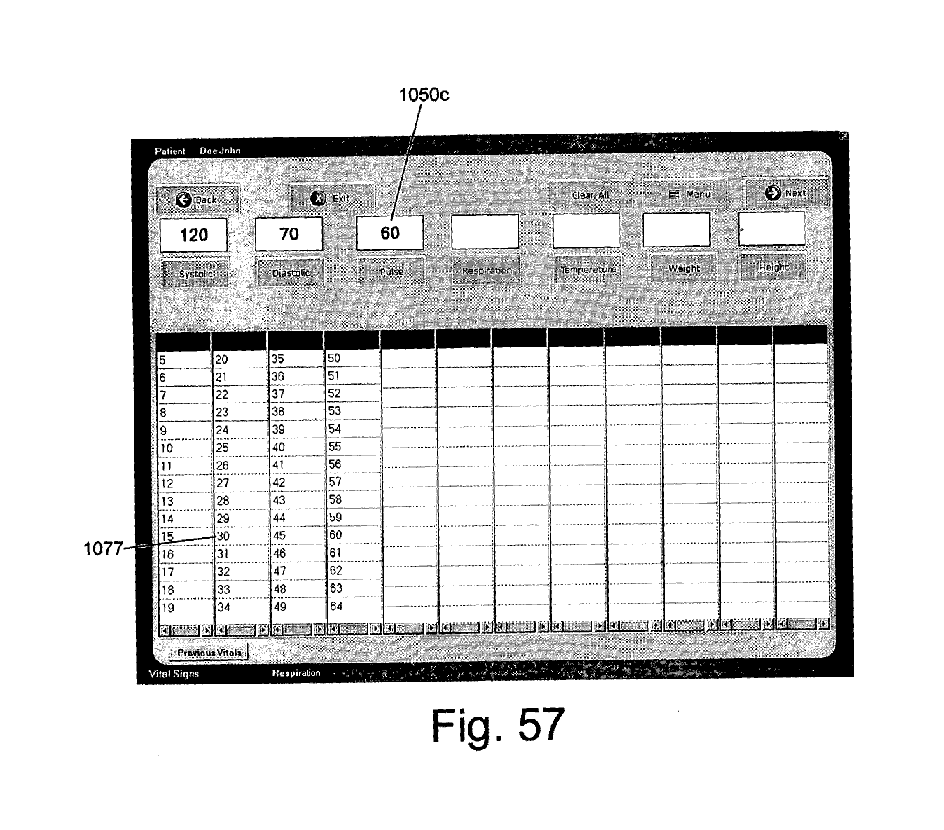

In FIGS. 54-62, a method for taking a patient's vital signs is shown illustrating a convenient means for recording numerical data. Here, the sequence of templates displayed prompt the user in making specific required body measurements during a patient's visit. To record vital sign data, the user opens the H&P Menu 924 (FIG. 26, column 1) by selecting the H&P MENU button 910 in FIG. 53 (or from any other screen) and picks the Vital Signs subject 930 from the list of topics in the auxiliary menu (not shown). At step 214, the main data screen 800 for Systolic-Normal Blood Pressure (FIG. 54) is shown with seven editable boxes together comprising the first display work area, designated 1050a to 1050g, seven category options, designated 1060a to 1060g, and three pages, designated 1070a to 1070c, of numeric ranges labeled High, Normal and Low, respectively. The user may change the ranges of values displayed by picking High or Low, or as an example here pick the number “120” on line 1071, which will be copied into box 1050a (FIG. 55).

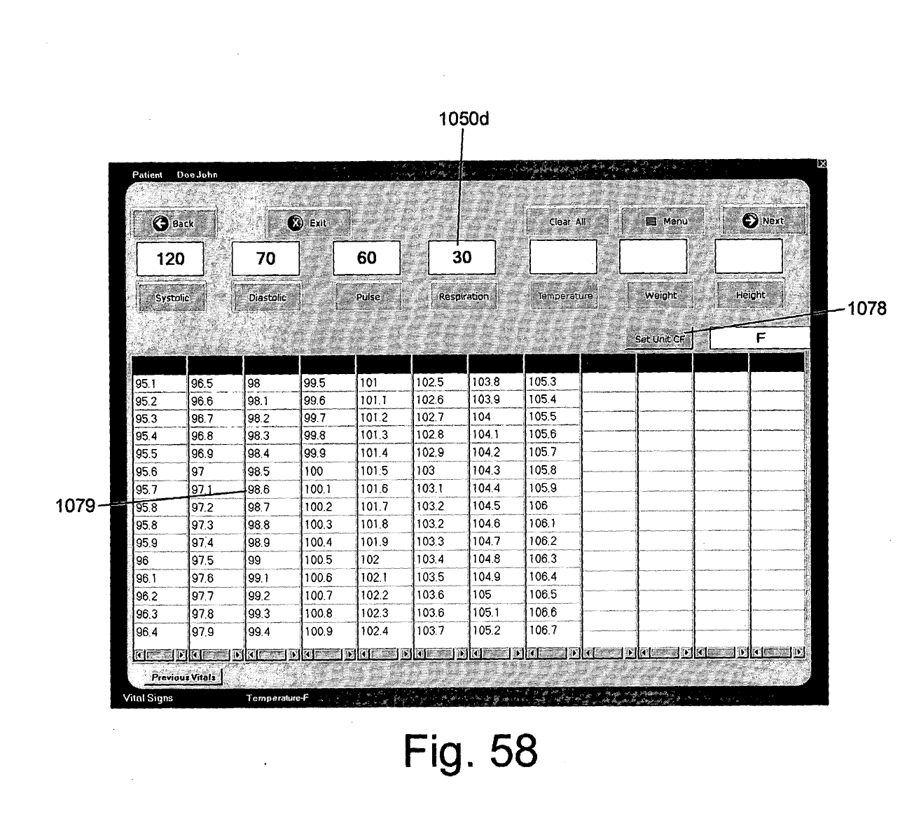

After picking “120,” the auto page feature will automatically display the screen template for Diastolic-Normal as seen in FIG. 55 and prompt for the next entry. Again, there are three pages, designated 1072a to 1072c, of numeric ranges labeled High, Normal and Low, respectively. The user may change the ranges of values displayed to High or Low, or as an example here pick the number “70” on line 1073 in the Normal category, which will be copied into box 1050b (FIG. 56).

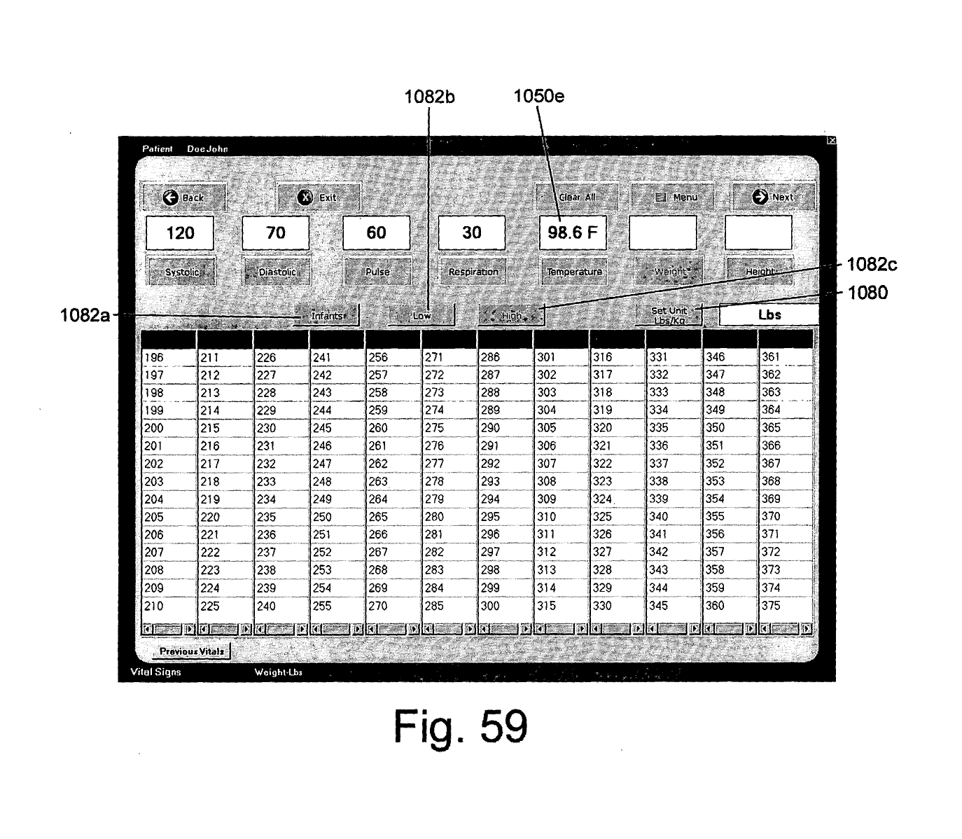

After picking “70,” the auto page feature will automatically display the screen template for Pulse as seen in FIG. 56 and prompt for the next entry. The user may toggle one of the radio buttons, collectively designated 1074, for indicating the type of pulse, or as an example here simply pick the number “60” on line 1075 from the displayed list of numeric text objects, which will be copied into box 1050c (FIG. 57).

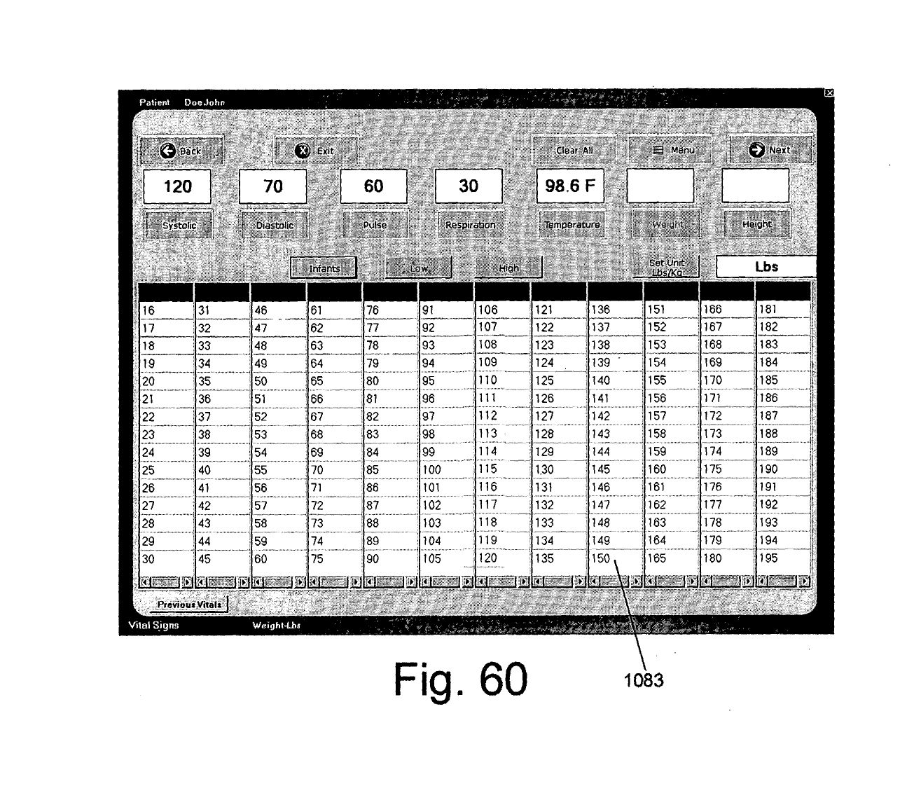

After picking “60,” the auto page feature will automatically display the screen template for Respiration as seen in FIG. 57 and prompt for the next entry. The user as an example here picks the number “30” on line 1077 from the displayed list of numeric text objects, which will then be copied into box 1050d (FIG. 58).

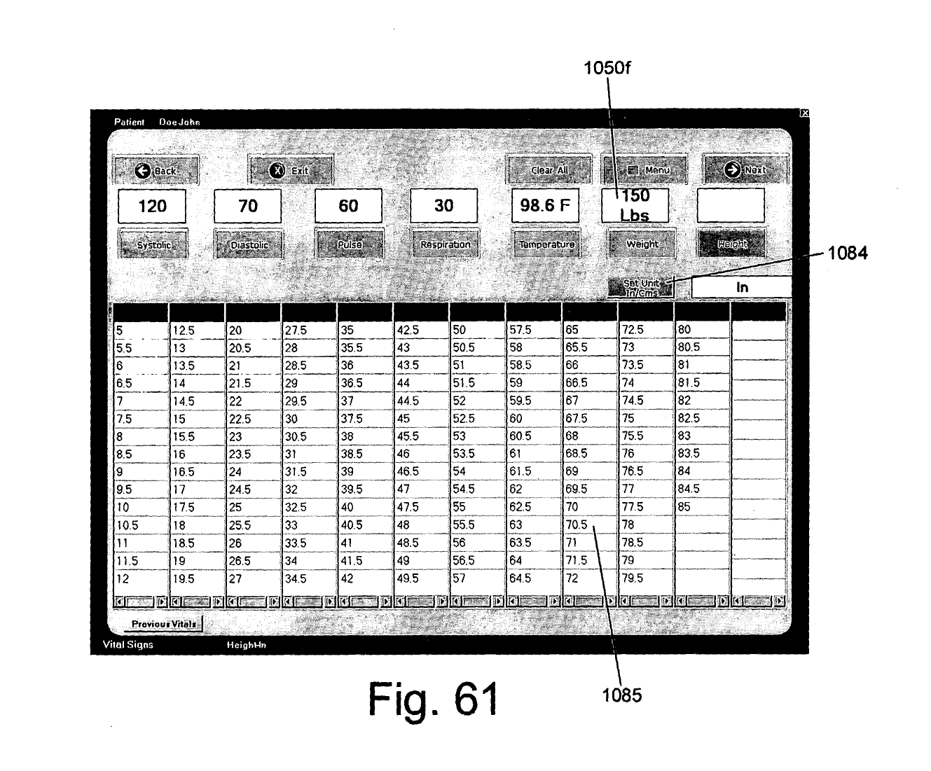

After picking “30,” the auto page feature will automatically display the screen template for Temperature-F as seen in FIG. 58 and prompt for the next entry. The user may change the scale of temperatures displayed by clicking the temperature unit button 1078 to show a range of Celsius temperatures, or as here for example simply pick the “98.6” on line 1079 from the numeric list of Fahrenheit text objects, which will be copied into box 1050e (FIG. 59).

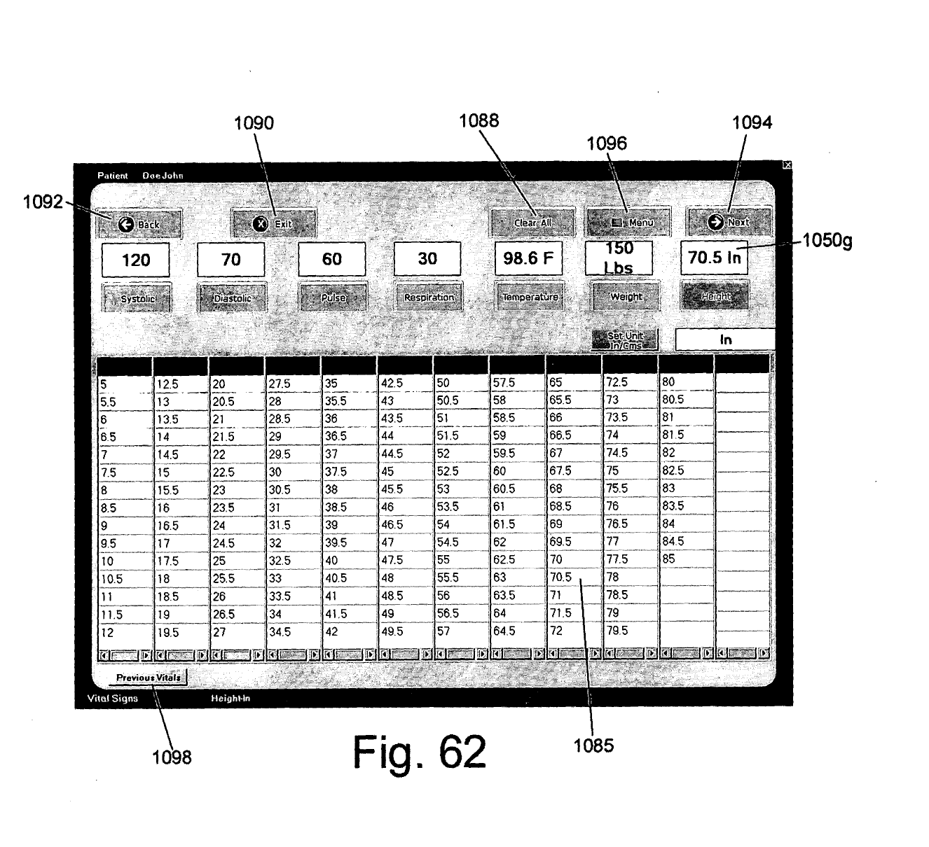

After picking “98.6,” the auto page feature will automatically display the screen template for Weight-Lbs as seen in FIG. 59 and prompt for the next entry. The user may change the page units by clicking the weight unit button 1080 to show a range of weights in kilograms or change the weight ranges by clicking on a range icon, 1082a, 1082b, or 1082c, or as here click the button 1082b to show the Low weight range page to view the display seen in FIG. 60. Thereafter, the user as an example here picks the number “150” on line 1083 from the numeric list of pound text objects, which will be copied into box 1050f (FIG. 61).

After picking “150,” the auto page feature will automatically display the screen template for Height-In as seen in FIG. 61 and prompt for the next entry. The user may change the page units by clicking on the height unit button 1084 to show a range of heights in centimeters, or as an example here simply pick the number “70.5” on line 1085 from the numeric list of inch text objects set forth for the inch scale, which will be copied into box 1050g (FIG. 62).

After all of these entries have been picked or entered into the text boxes, the screen appears as shown in FIG. 62. The user can then clear all of the vital sign entries by selecting button 1088, exit by selecting button 1090, go back to the previous subject by selecting button 1092, go forward to the next subject by selecting button 1094, change subjects by selecting button 1096 to display the H&P Menu 924 and picking a listed option therefrom, or view previously entered vital signs by selecting button 1098.

### 9. Building a Summary Narrative

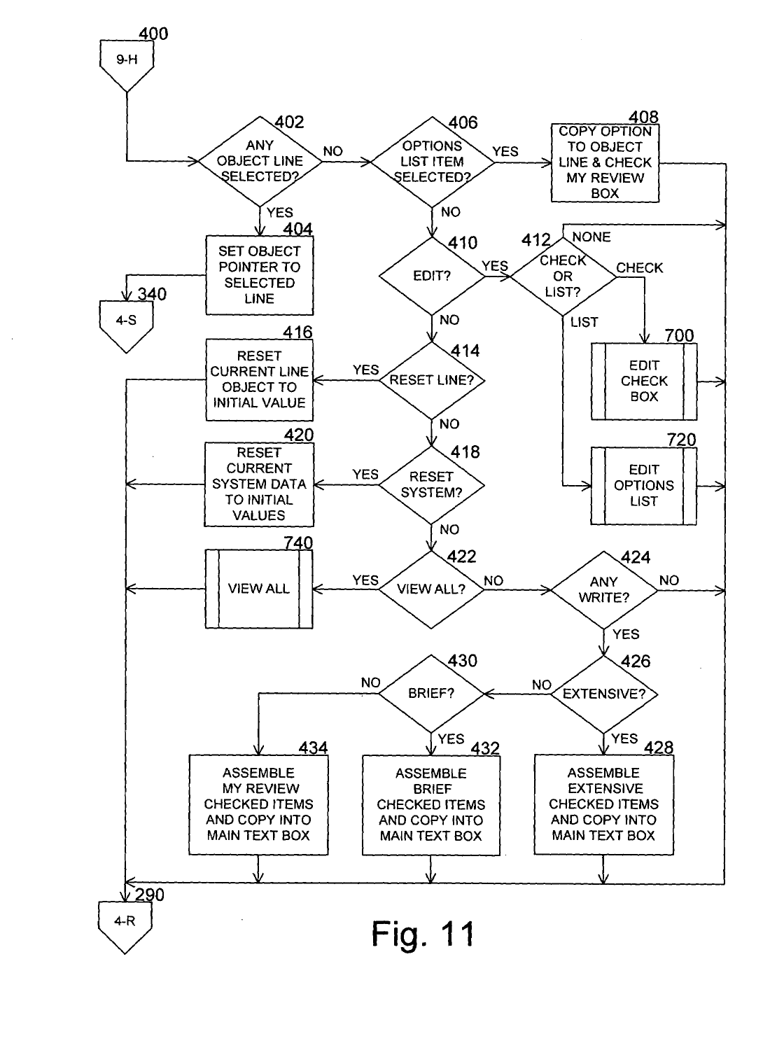

Continuing with the example illustrated by the screenshots in FIGS. 36 through 106, processing once again returns to steps 214 and 222. If it is determined at step 370 (FIG. 10) that the user has selected the System Review subject 932 or the Physical Exam subject 934 from the H&P Menu 924 and will be building a summary narrative, then processing branches to steps 402-434 (FIG. 11) through the 9-H connector 400 (FIGS. 10 and 11). Here, a subset of text objects (usually whole sentences) are selected from a larger set of text objects; the selected text objects are written into the first display work area 802 depending on the user's preferences. Generally, during the build of a summary narrative, much of the processing occurs at steps 202-222, where the display is updated and data in entered, and at steps 402-434, where text objects are selected from one work area and copied into another work area.

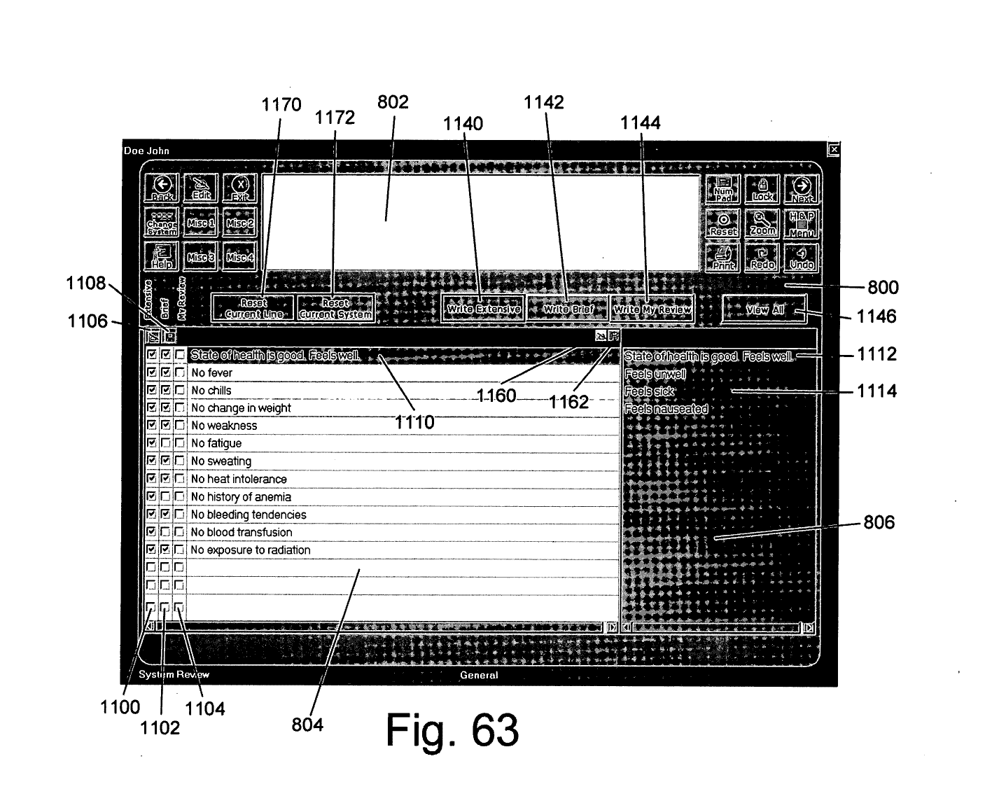

Referring to FIGS. 63 through 77, inclusive, the display templates for building a summary narrative for the subject System Review are shown. In the upper center portion the display is a first display work area 802; in the lower center part of the display is a second display work area 804 that is protected; in the lower right portion of the display is a third display work area 806 that is also protected; and in the lower left portion of the display are 3 vertical columns of protected check boxes, 1100, 1102 and 1104, respectively, the columnar groups being labeled Extensive, Brief, and My Review, respectively. The check boxes, when checked, indicate lines in the second display work area 804 that are marked or flagged and may later be selectively copied as a group into the first display work area 802. Each line in the second display work area 804 has an associated set of text objects which will be respectively displayed in the third display work area 806 depending on which line is highlighted in the second display work area 804. The common or normal text object for each line in the second display work area 804 will be displayed at the top of each list displayed in the third display work area 806.

Check boxes in the Extensive and Brief columns can only be toggled by picking the Edit Check Box icon 1106 and directly editing the check boxes as described below. The check boxes in the My Review column are toggled on by picking a text object line in the second display work area 804 and subsequently picking an associated text object in the third display work area 806. The checks under the Extensive and Brief headings may act as a convenient prompt or reminder to the user to make those observations or measurements that are necessary to complete either an extensive or a brief patient review. Whichever the user undertakes, the user can elect to cover those topics which the user personally deems necessary to include. The process of selecting text objects under this subject is relatively straight forward and efficient.

If it is determined at step 402 that a text object line has been selected, then a pointer is set at 404 to highlight it as seen at line 1110 in FIG. 63. Thereafter, the text objects for that line category are retrieved from storage at step 212 and the display updated at step 214 through the 4-S connector 340 (FIGS. 3 and 11) to show the retrieved list in the third display work area 806. Typically, sentences denoting common or normal conditions are positioned at the top of the third display work area 806 to facilitate quick selection thereof. If it is determined at step 406 that any item from the options list in the third display work area 806 has been picked, then that text object item is copied to the highlighted line in the second display work area 804 and the associated My Review check box is checked at step 408. The screen is then redisplayed at step 214 and input awaited at step 222 through the 4-R connector 290 (FIGS. 3 and 11).

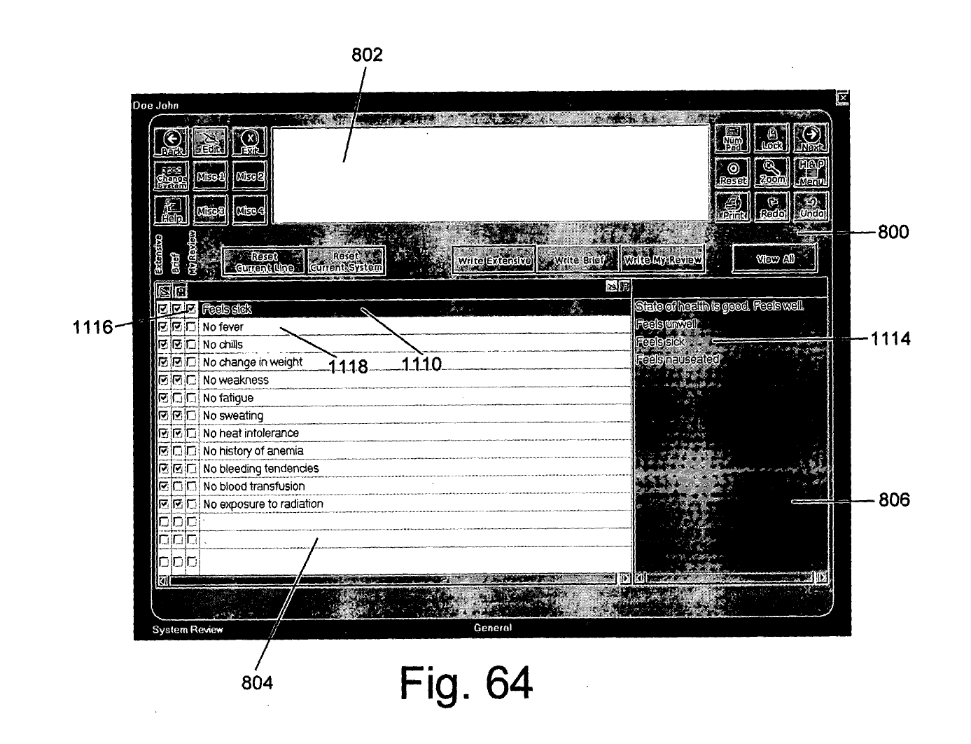

Referring now to FIG. 63, the initial main data screen 800 for the subject System Review and the topic General is shown. The first line 1110 in the second display work area 804 shows the words “State of health is good. Feels well”, the third display work area 806 shows a list of text objects that may be selected by the user to replace the text object for the category relating to the highlighted line in the second display work area 804, including the default text object on line 1112, which appears at the top of the list. To toggle a check in a check box in the My Review column, one item in the third display work area 806 must be picked by the user. As an example here, the “Feels sick” text object on line 1114 is picked from the third display work area 806 so that the text object “Feels sick” replaces the original text on line 1110 in the second display work area 804 and a check is placed in the first check box 1116 under My Review and as shown in FIG. 64.

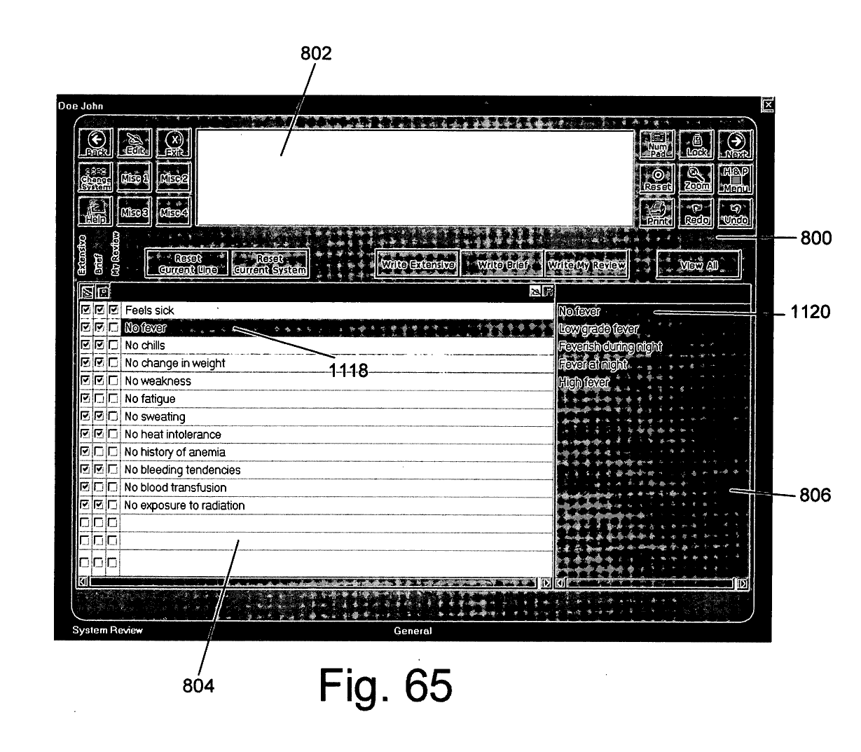

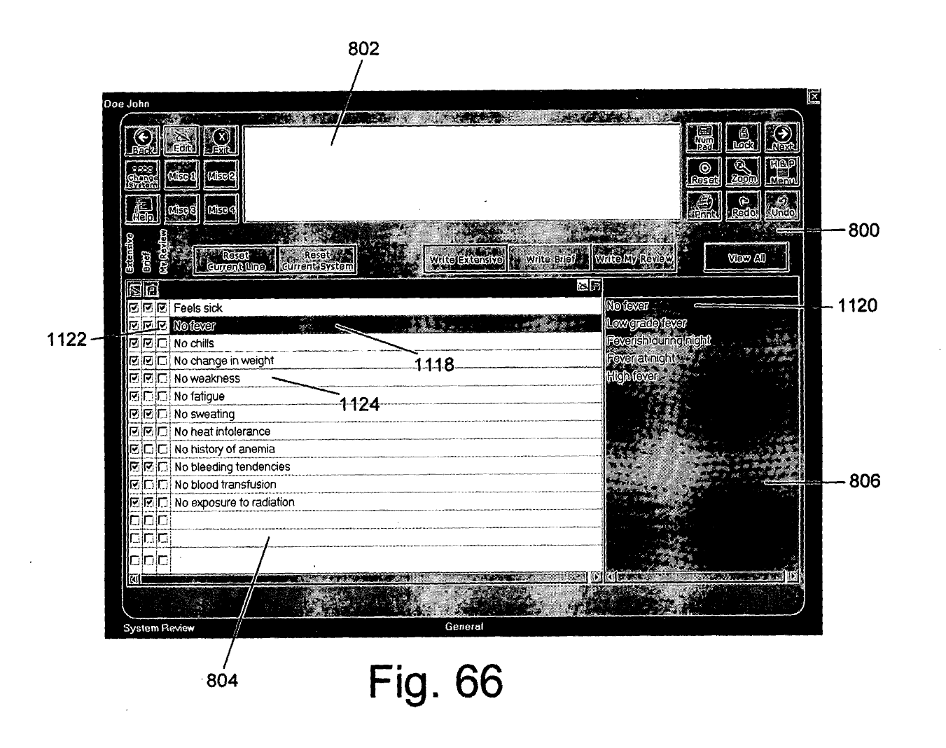

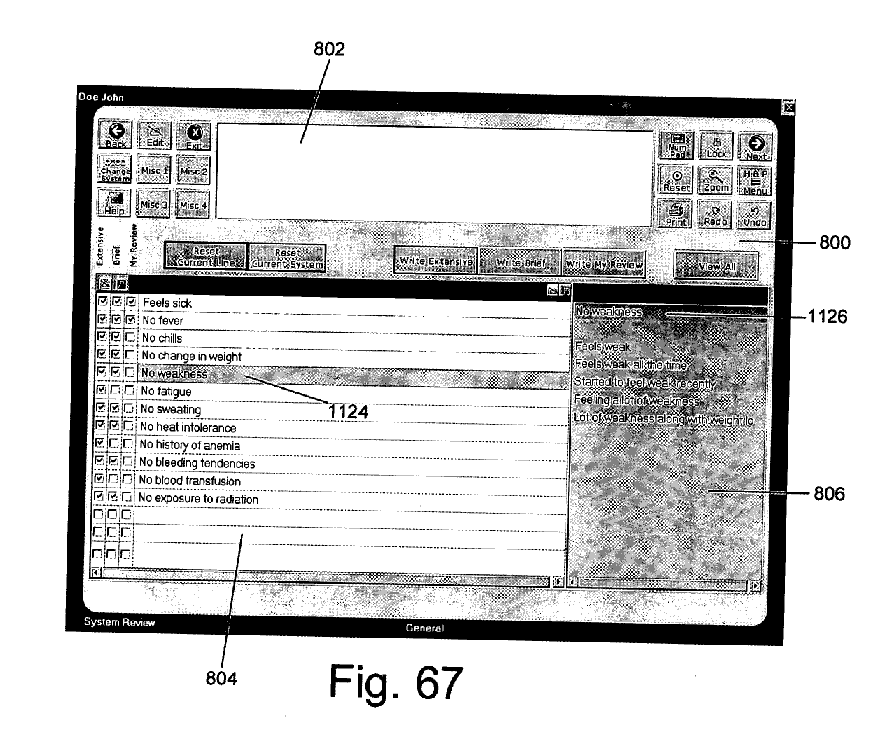

Thereafter, “No fever” on line 1118 in the second display work area 804 is picked to highlight it and retrieve the options list available in the third display work area 806 for that line as seen in FIG. 65. The “No fever” text object on line 1120 is picked from the third display work area 806 so that a check is placed in the second check box 1122 under My Review as shown in FIG. 66.

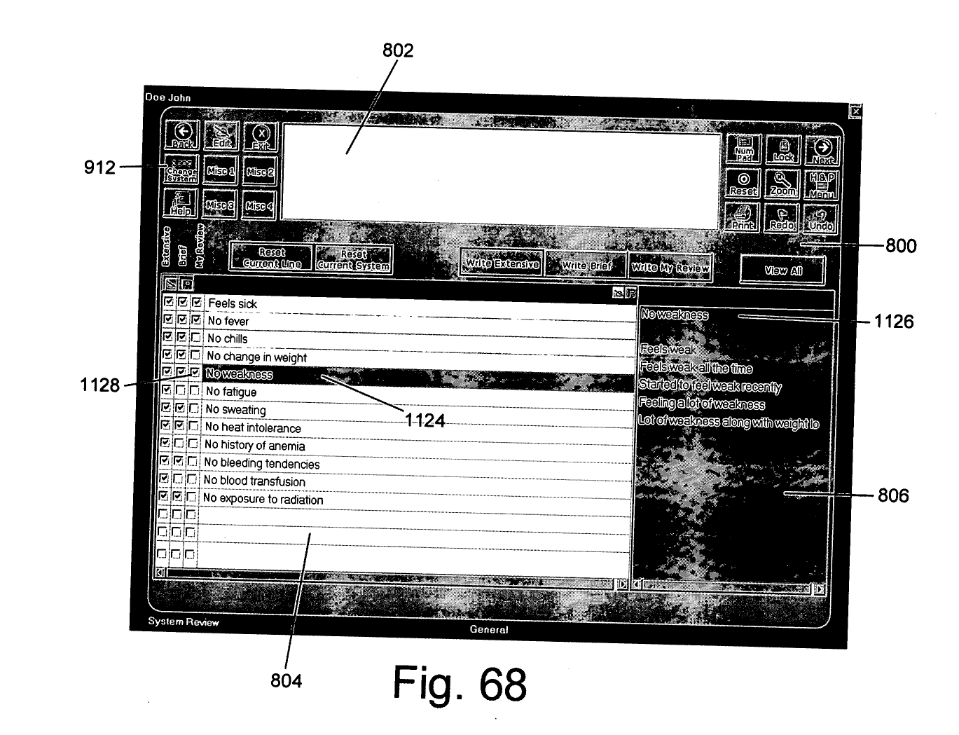

In turn, “No weakness” on line 1124 in the second display work area 804 is picked to highlight it and retrieve the options list available in the third display work area 806 for that line as seen in FIG. 67. The “No weakness” text object on line 1126 is picked from the third display work area 806 so that a check is placed in the fifth check box 1128 under My Review as shown in FIG. 68.

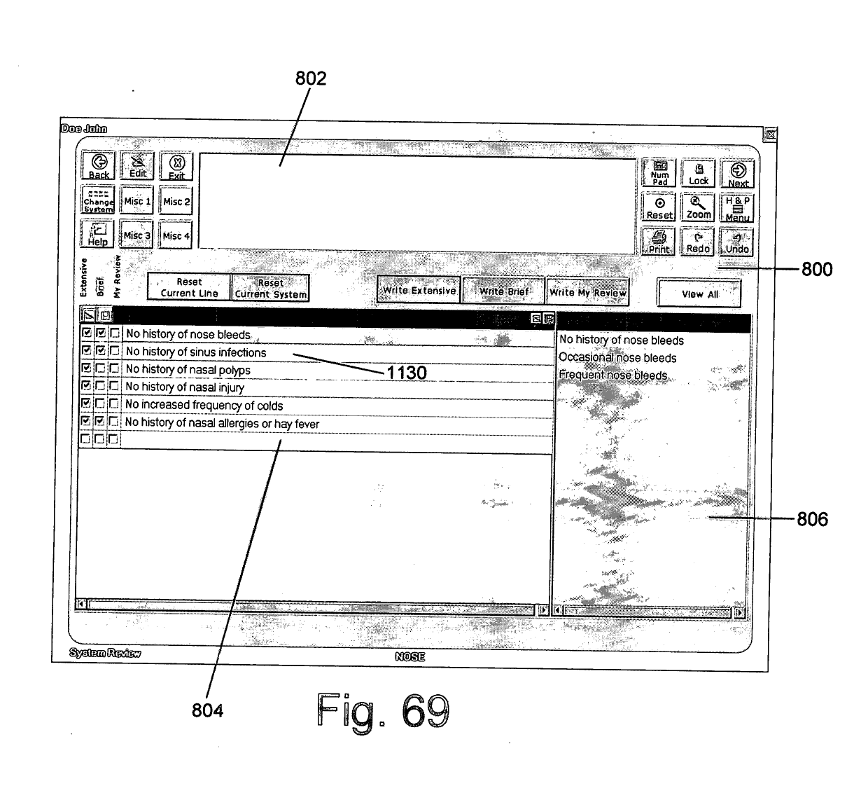

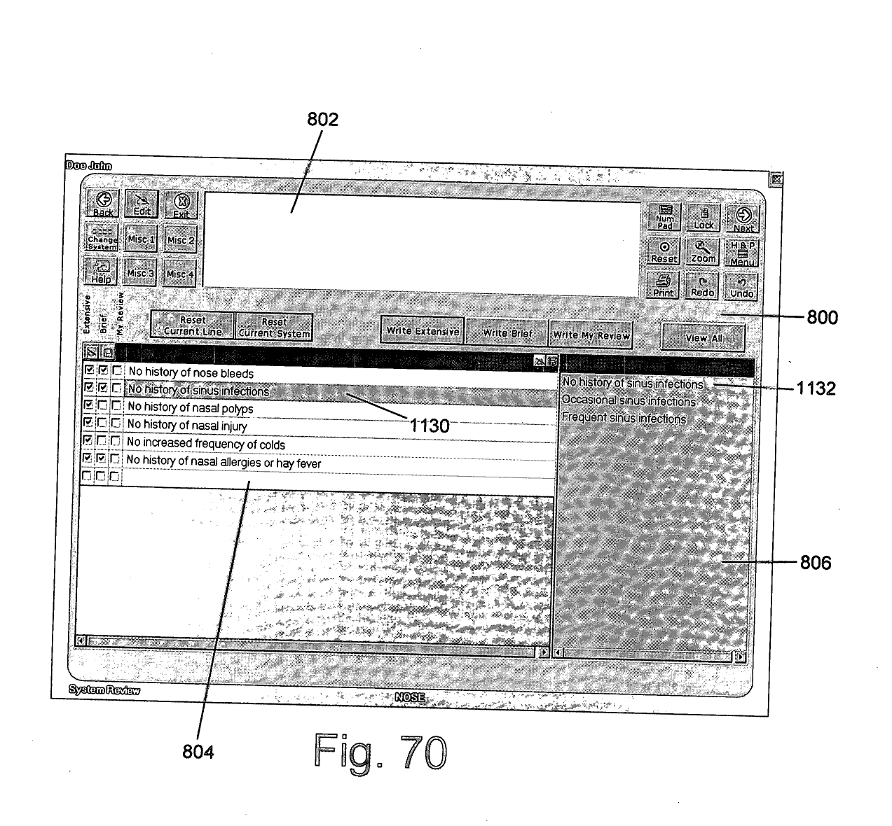

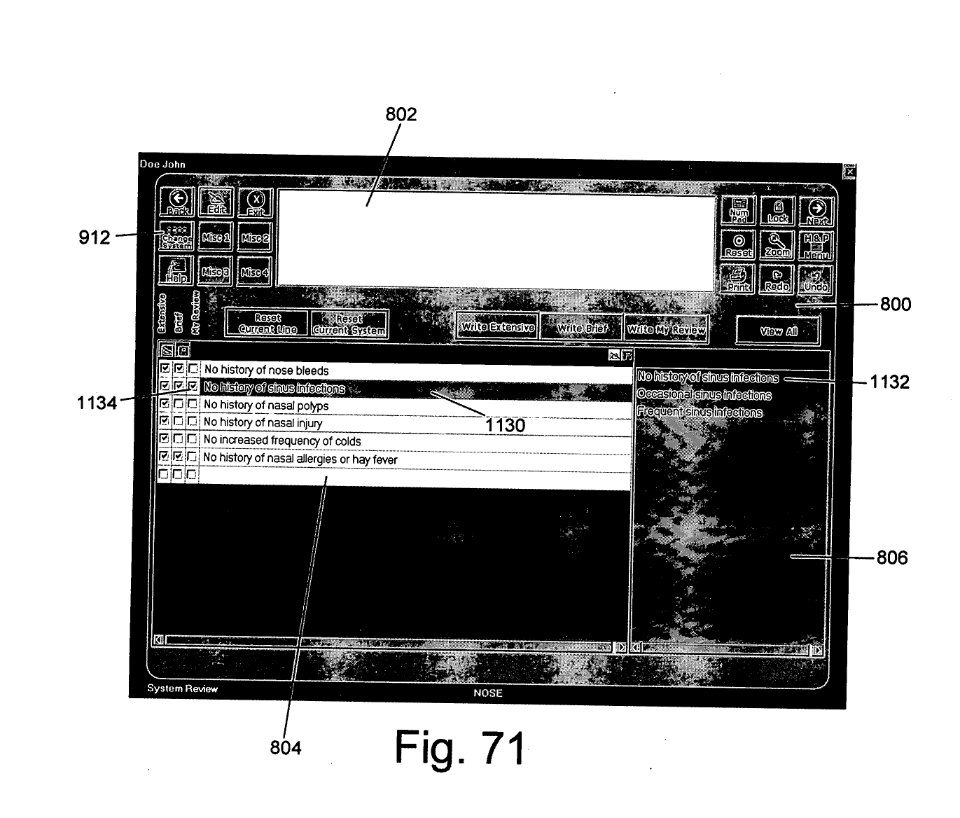

By selecting the CHANGE SYSTEM button 912 and changing the topic to NOSE, the MAIN DATA SCREEN 800 for the subject SYSTEM REVIEW and the topic NOSE is retrieved and shown in FIG. 69. “No history of sinus infections” on line 1130 in the second display work area 804 is picked to highlight it and retrieve the options list available in the third display work area 806 for that line as seen in FIG. 70. “No history of sinus infections” text object on line 1132 is picked from the third display work area 806 so that a check is placed in the second check box 1134 under My Review as shown in FIG. 71.

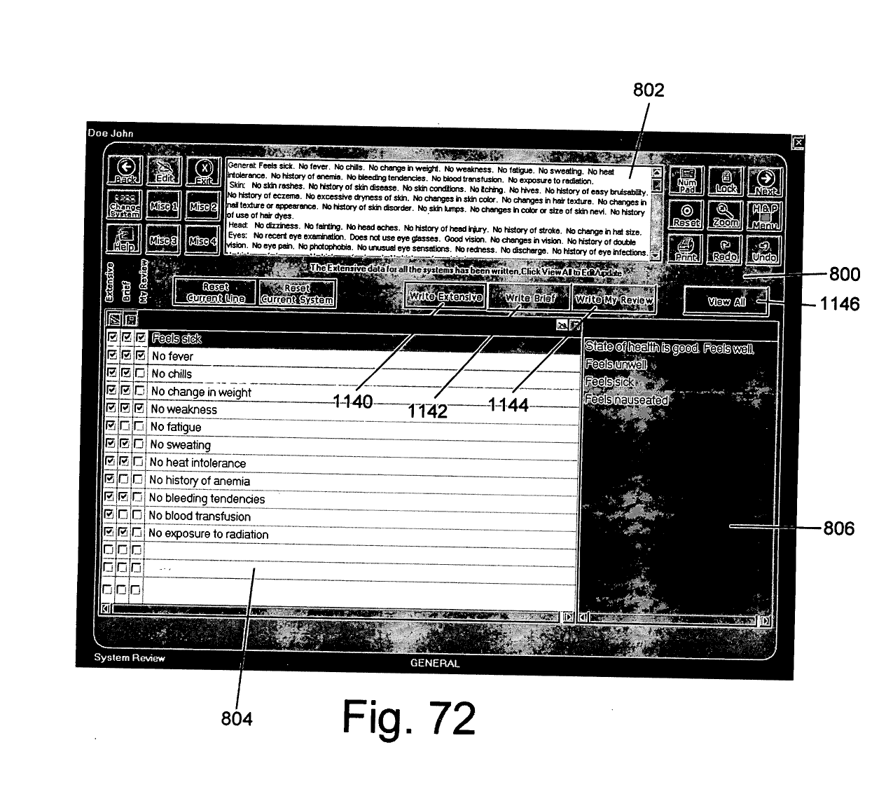

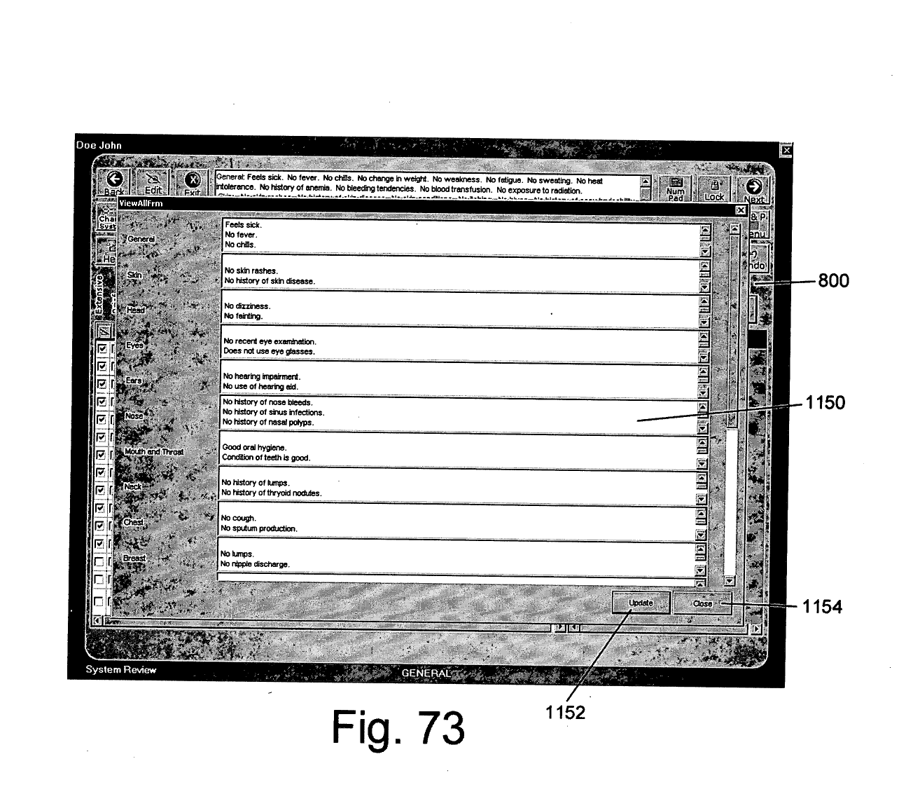

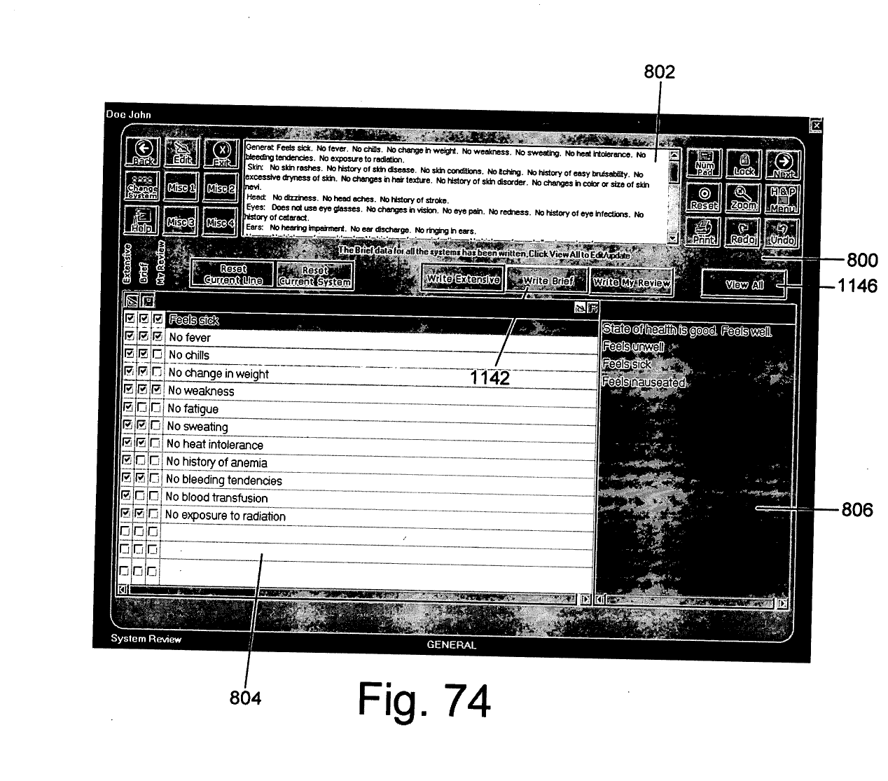

Subsequently, by selecting the CHANGE SYSTEM button 912 and changing the topic to GENERAL, the data for the subject SYSTEM REVIEW and the topic General is retrieved and shown previously in FIG. 68. Now, if it is determined at step 424 and 426 that the user has selected the WRITE EXTENSIVE button 1140 (FIG. 63), all of the lines in the second display work area 804 having a check in the respective check box under the first column 1100 labeled Extensive for all topics is formatted and copied at step 428 into the first display work area 802 with suitable topical headings as seen in FIG. 72. Since most of the lines are checked by default, it is not necessary to enter or modify this data as long as there are no extraordinary or abnormal conditions or items to report. As a result, a complete extensive report can be generated quickly and efficiently.

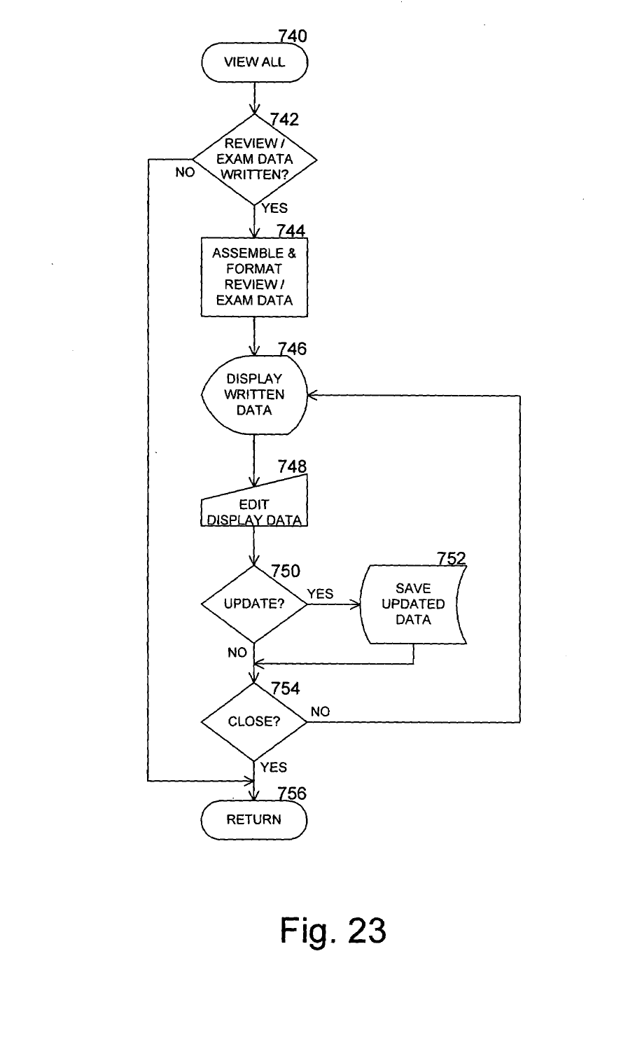

If it has determined at step 422 that the user has selected the VIEW ALL button 1146, then the View All Routine is executed beginning at subroutine 740 (FIG. 23). If it is determined at step 742 that data has not been written to the first display work area 802, then processing branches and returns at step 756 to redisplay the main data screen 800 at step 214 through the 4-R connector 290 (FIGS. 3 and 11). If is determined at step 742 that data has been written to the first display work area 802 then the data is assembled and formatted at step 744 and displayed at step 746 in an overlying window 1150 as seen in FIG. 73.

The user may edit the data displayed in the View All window 1150 at step 748 and if it is determined at step 750 that the user wants to save the updated data and has selected the Update option 1152, the data is saved at step 752. If the close option 1154 is not selected, processing branches at step 754 to redisplay the View All window 1150 at step 746. If it is determined at step 754 that the close option 1154 has been selected, then processing returns from step 756 and the main data screen 800 is redisplayed at step 214 through the 4-R connector 290 (FIGS. 6 and 11).

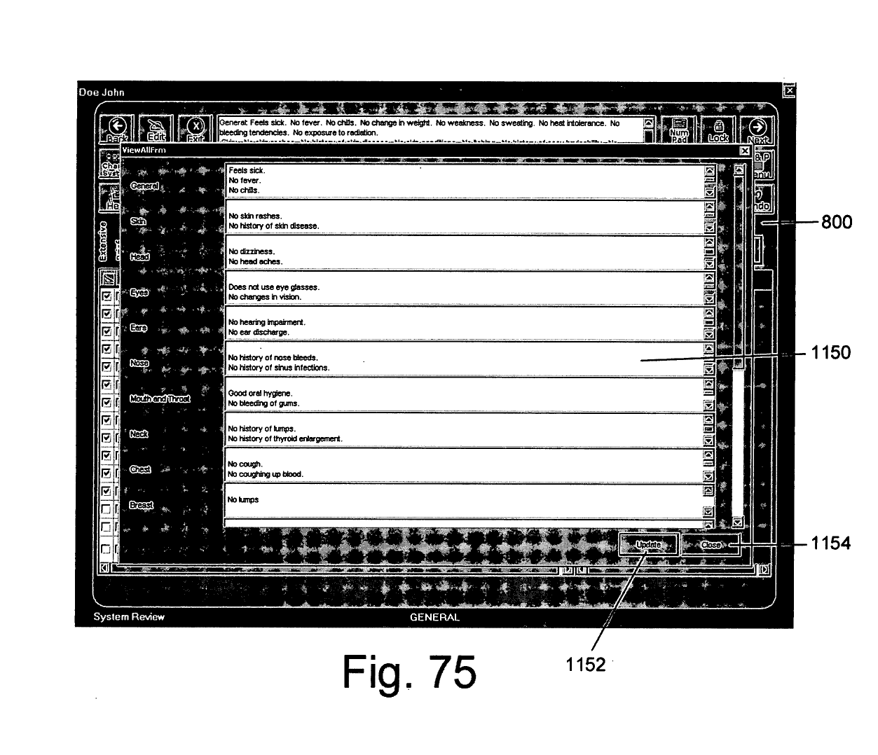

Alternatively, if it is determined at steps 424 and 430 that the user has selected the WRITE BRIEF button 1142 (FIG. 63), all of the lines in the second display work area 804 having a check in the respective check box under the second column 1102 labeled Brief for all topics is formatted and copied at step 432 into the first display work area 802 with suitable topical headings as seen in FIG. 74. Since many of the lines are checked by default, it is not necessary to enter or modify this data as long as there are no extraordinary or abnormal conditions or items to report. As a result, a complete brief report can be generated quickly and efficiently. As described above with respect to the Extensive review, the user may select the VIEW ALL button 1146 to then view, edit and update the data in the first display work area 802 as seen in FIG. 75.

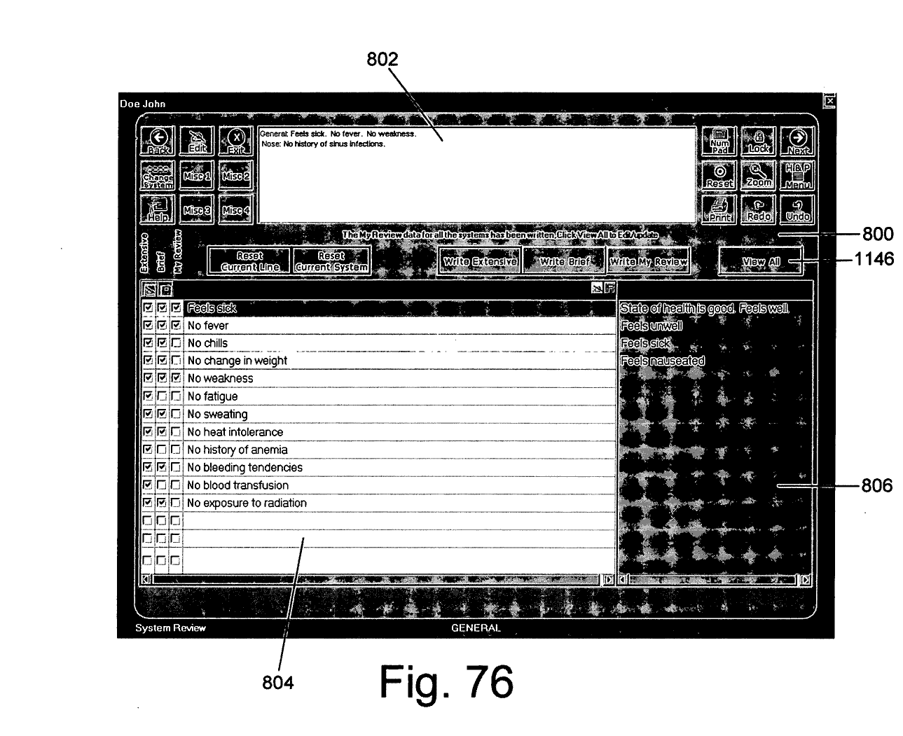

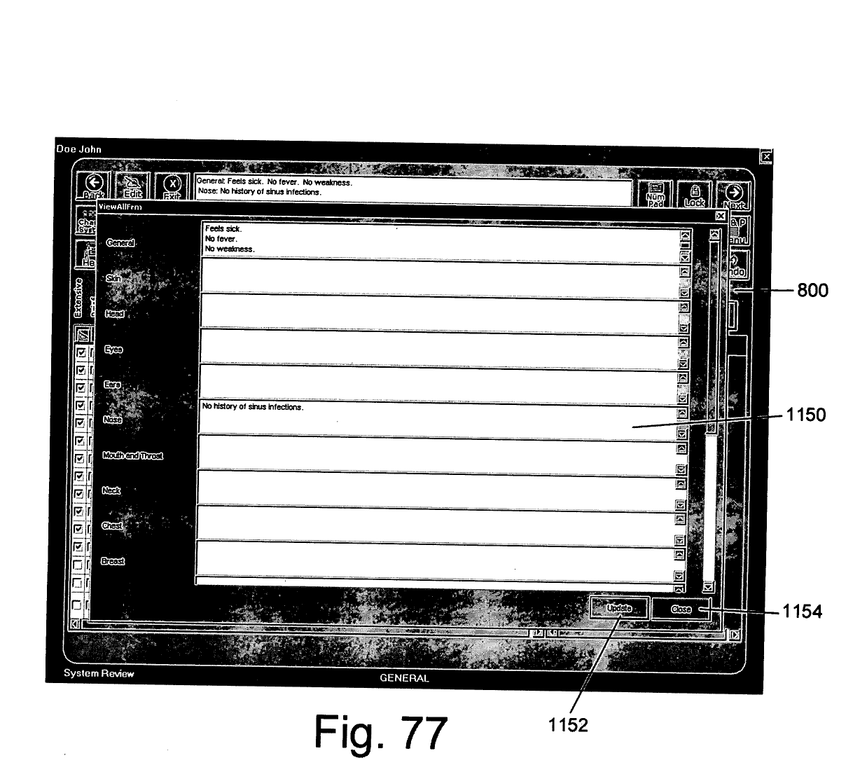

And lastly, if it is determined at steps 424 and 430 that the user has selected the WRITE MY REVIEW button 1144 (FIG. 63), all of the lines in the second display work area 804 having a check in the respective check box under the third column 1104 labeled My Review for all topics is formatted and copied at step 434 into the first display work area 802 with suitable topical headings as seen in FIG. 76. Here, the user has selected the lines that are checked. Unlike the Extensive and Brief boxes which can only be changed by direct editing thereof, under My Review the user indirectly selects the lines in the second display work area 804 to be checked by selecting items in the third display work area 806. As a result, a complete report can be generated quickly and efficiently describing only what the user intended to document and report. As described above with respect to the other reviews, the user may select the VIEW ALL button 1146 and then the view, edit and update the data in the first display work area 802 as seen in FIG. 77.

The command buttons for the summary narrative display provide functions similar to those for the basic narrative build described above. If it is determined at step 410 that the user wants to edit checks boxes or the options list, then it is further determined at step 412 whether the check boxes are to be edited or whether the options list is to be edited.

If the check boxes in columns 1100, 1102 and 1104 (FIG. 63) are to be edited by checking the Edit icon 1106, then the Edit Check Box subroutine 700 (FIG. 21) is executed and the check boxes are changed to unprotected editable fields at step 702. At step 704 user input is accepted and if at step 706, it is determined that a check box has been picked, then the check box is toggled at step 710 to add or remove the check in the selected box. If after continuing, it is determined at step 712 that the user has not selected the Save icon 1108, then processing branches back to step 704 to await additional user input. If the Save icon 1108 has been selected, then the changes are saved to storage at step 714, the check boxes are changed to protected uneditable fields at step 716, and processing returns from step 718 to redisplay the main data screen 800 at step 214 through the 4-R connector 290 (FIGS. 3 and 11).

Possible options that may be copied to the second display work area 804 are listed in the third display work area 806. Default entries, i.e., those entries which are common or normal, are listed on the top line of the third display work area 806. That is, for each available topic and category, the top item in the respective third display work area 806 will display by default on the appropriate line in the second display work area 804 provided that the line has not been selected by the user and checkmarked under the “My Review” column.

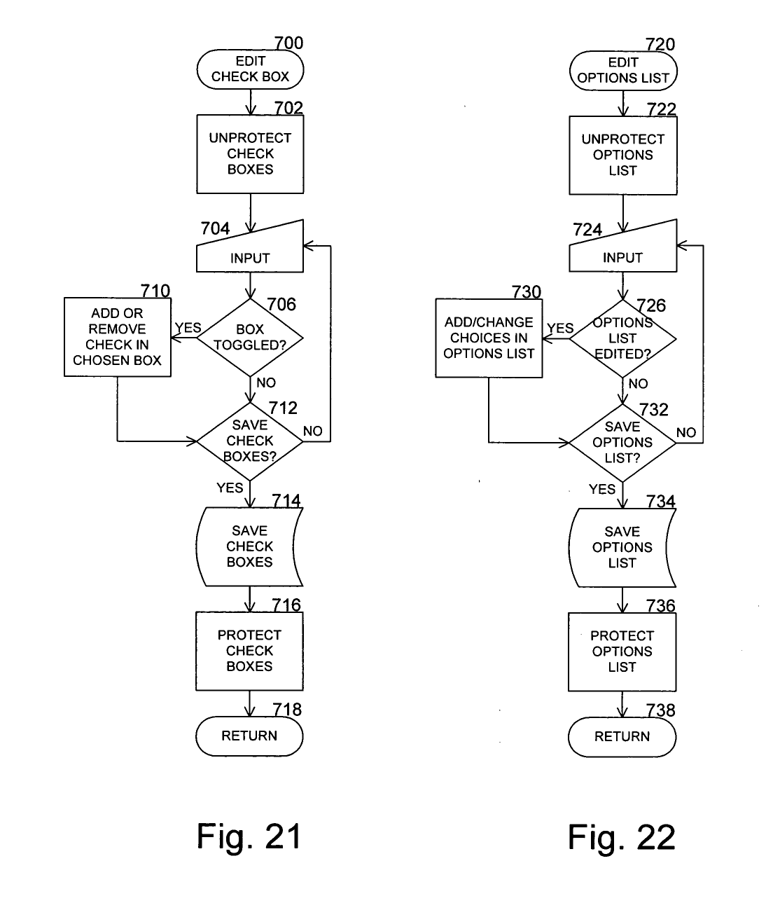

If the options list in the third display work area 806 is to be edited by picking the Edit icon 1160, then the Edit Options List subroutine 720 (FIG. 22) is executed and the options list text objects in the third display work area 806 are changed to unprotected editable fields at step 722. At step 724 user input is accepted and if at step 726, it is determined that an options list text object has been edited, then the options list is changed at step 730. If after continuing, it is determined at step 732 that the user has not selected the Save icon 1162, then processing branches back to step 724 to await additional user input. If the Save icon 1162 has been selected, then the changes are saved to storage at step 734, the options list text objects in the third display work area 806 are changed to protected uneditable fields at step 736, and processing returns by step 738 to redisplay the main data screen 800 at step 214 through the 4-R connector 290 (FIGS. 3 and 11).

If it is determined at step 414 that the RESET LINE button 1170 (FIG. 63) has been selected, then the current text object check box is reset at step 416 to its initial value. Processing continues with the redisplay of the main data screen 800 at step 214 through the 4-R connector 290 (FIGS. 3 and 11).

If it is determined at step 418 that the RESET SYSTEM button 1172 (FIG. 63) has been selected, then all of the current text object check boxes are reset at step 420 to their initial values. Processing continues with the redisplay of the main data screen 800 at step 214 through the 4-R connector 290 (FIGS. 3 and 11).

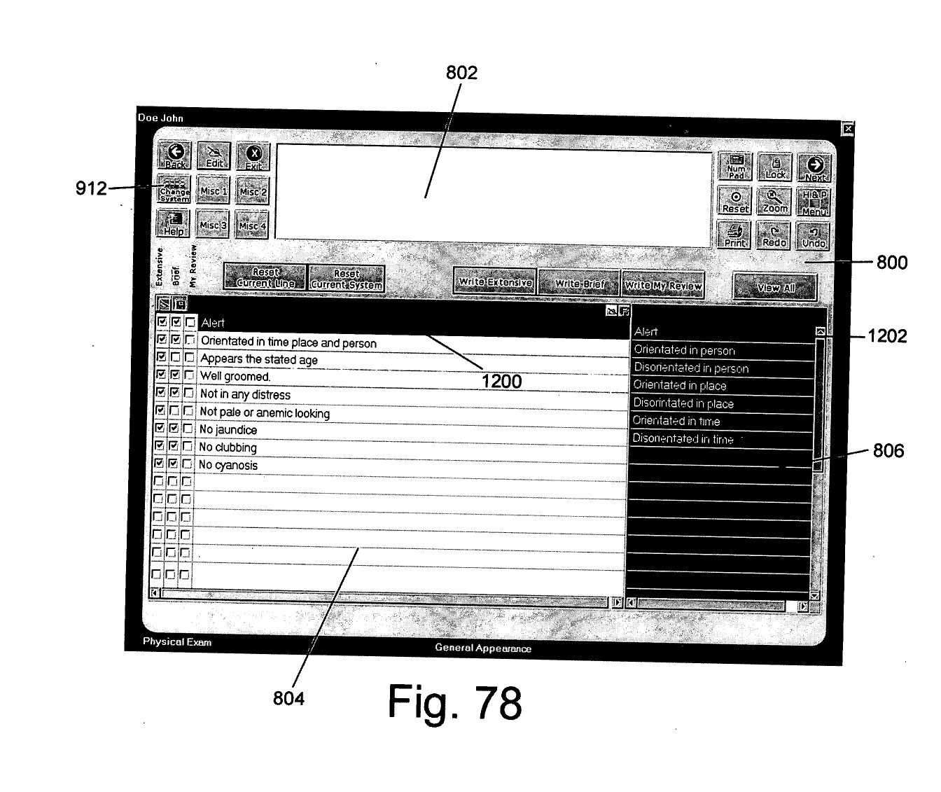

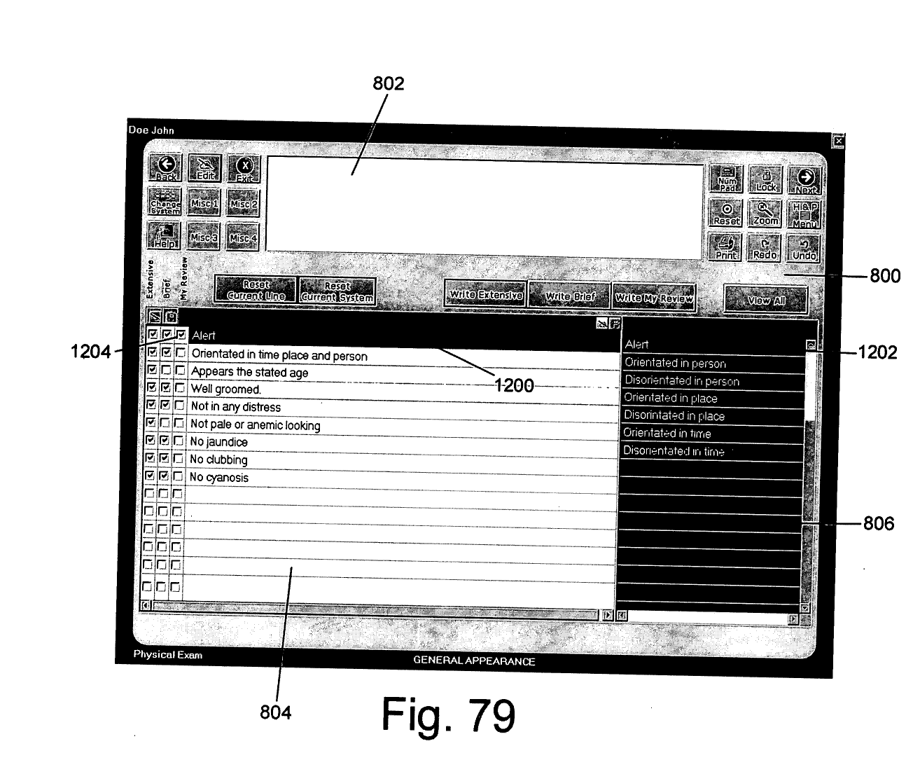

Referring to FIGS. 78 through 90, inclusive, the display templates for building a summary narrative for the subject Physical Exam are shown. Data entry for Physical Exam is similar to that for System Review. Referring now to FIG. 78, the initial main data screen 800 for the subject Physical Exam and the topic General Appearance is shown. The first line 1200 in the second display work area 804 shows the words “Alert”, the third display work area 806 shows a list of text object items that may be selected by the user to replace text objects on line 1200 in the second display work area 804, including the default text object on line 1202, which appears at the top of the list. To toggle a check in a check box in the My Review column, the “Alert” text object on line 1202 is picked from the third display work area 806 so that the “Alert” text object replaces the original text on line 1200 in the second display work area 804 and a check is placed in the first check box 1204 under My Review and as shown in FIG. 79.

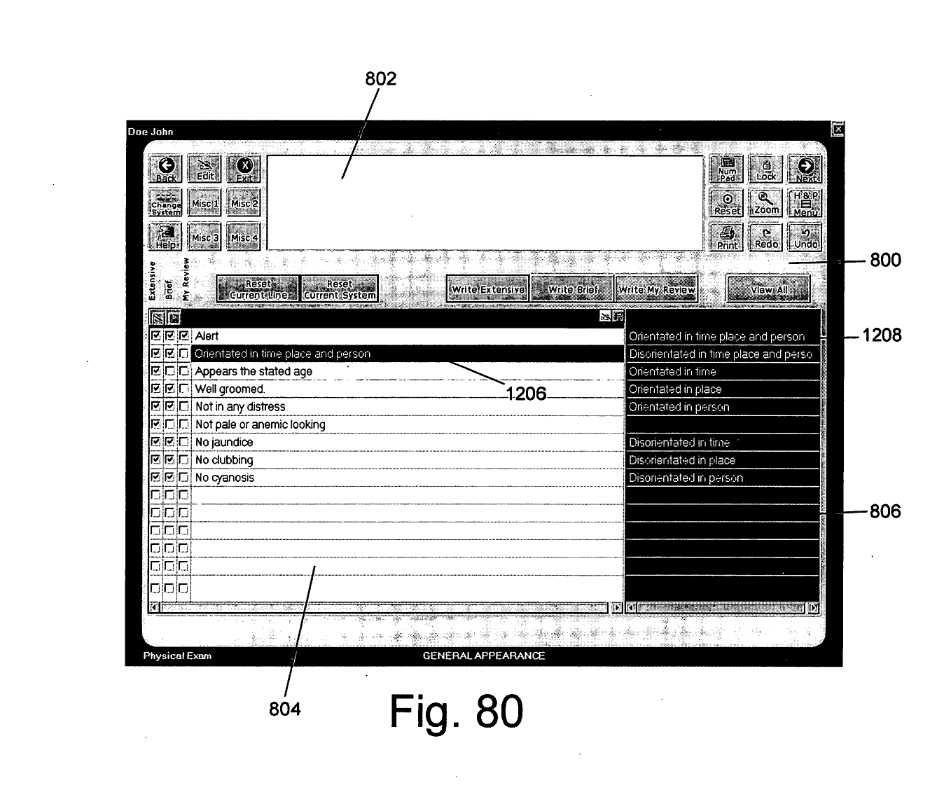

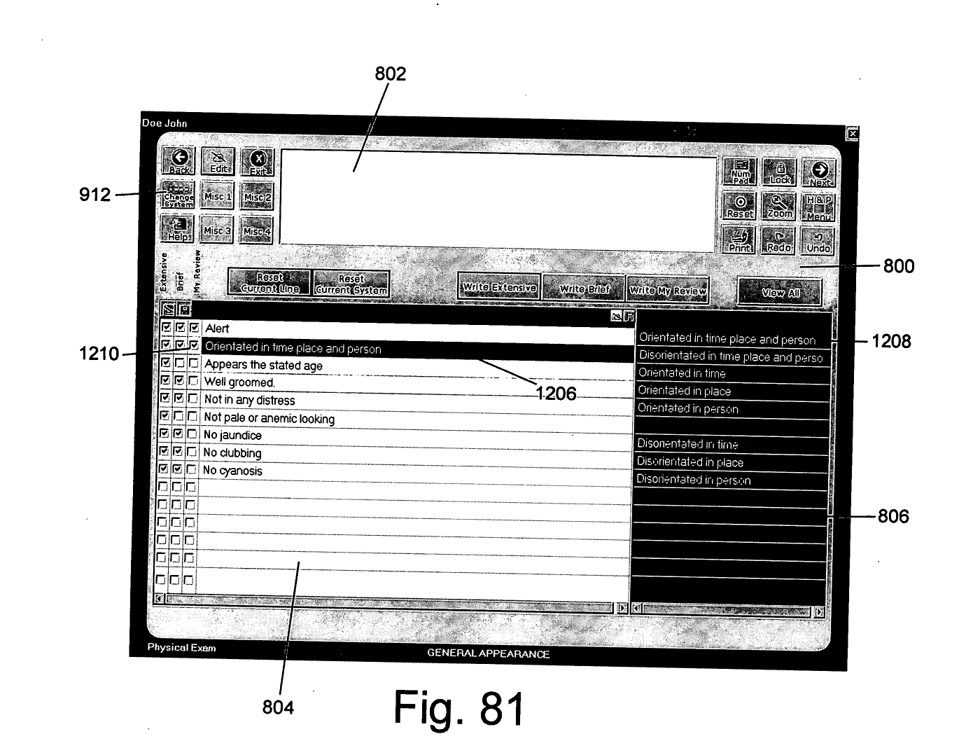

Thereafter, “Orientated in time place and person” on line 1206 in the second display work area 804 is picked to highlight it and retrieve the options list available in the third display work area 806 for that line as seen in FIG. 80. The “Orientated in time place and person” text object on line 1208 is picked from the third display work area 806 so that a check is placed in the second check box 1210 under My Review as shown in FIG. 81.

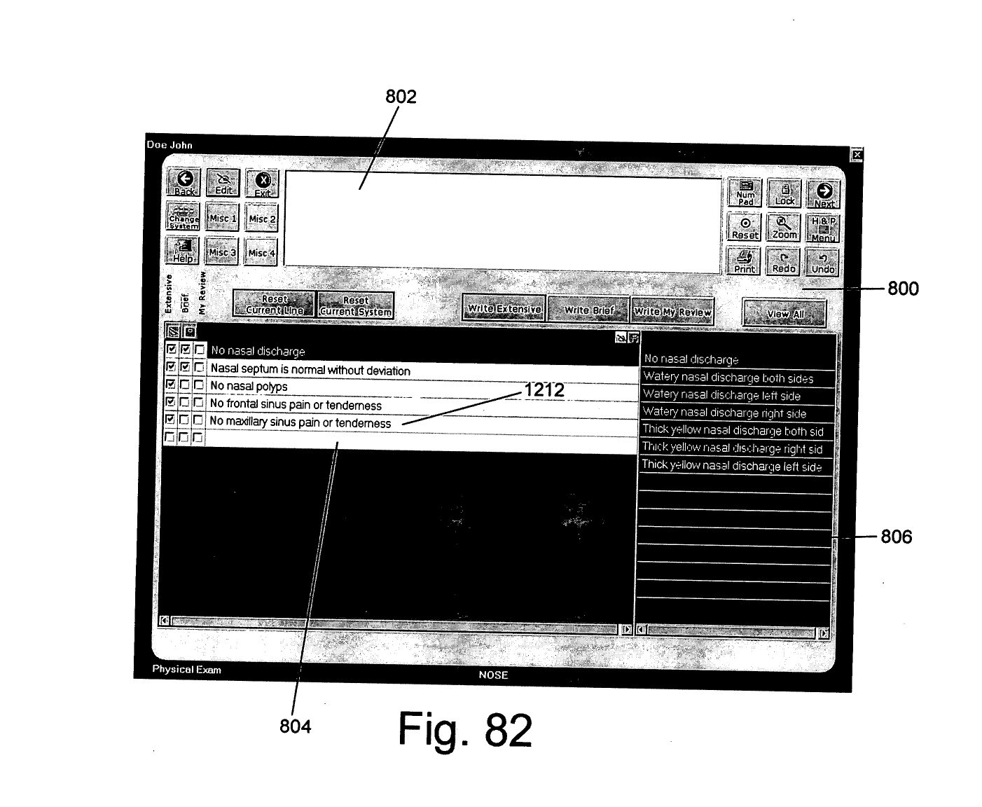

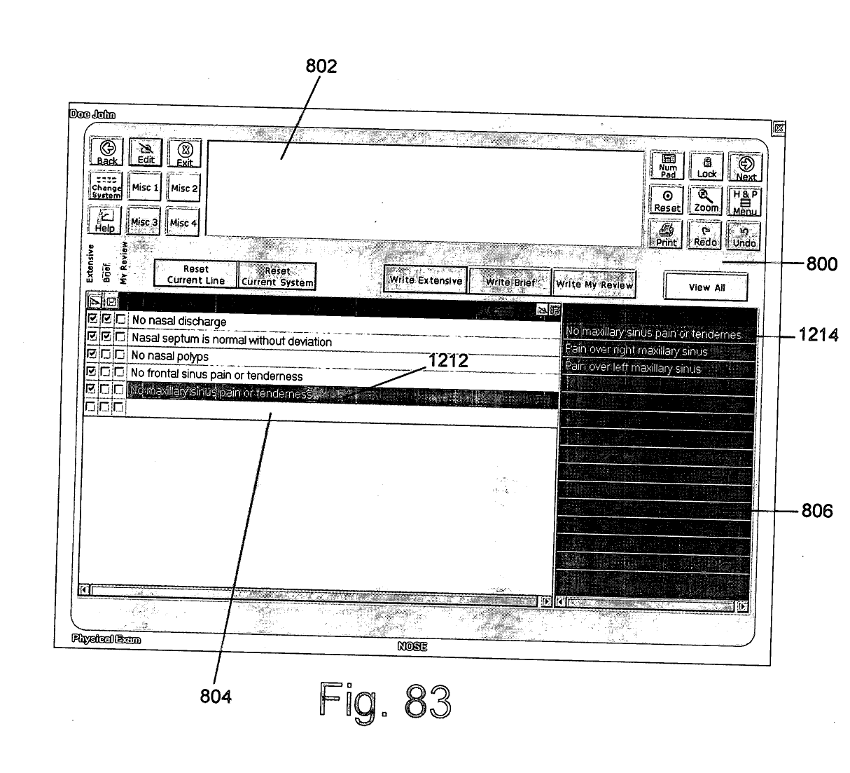

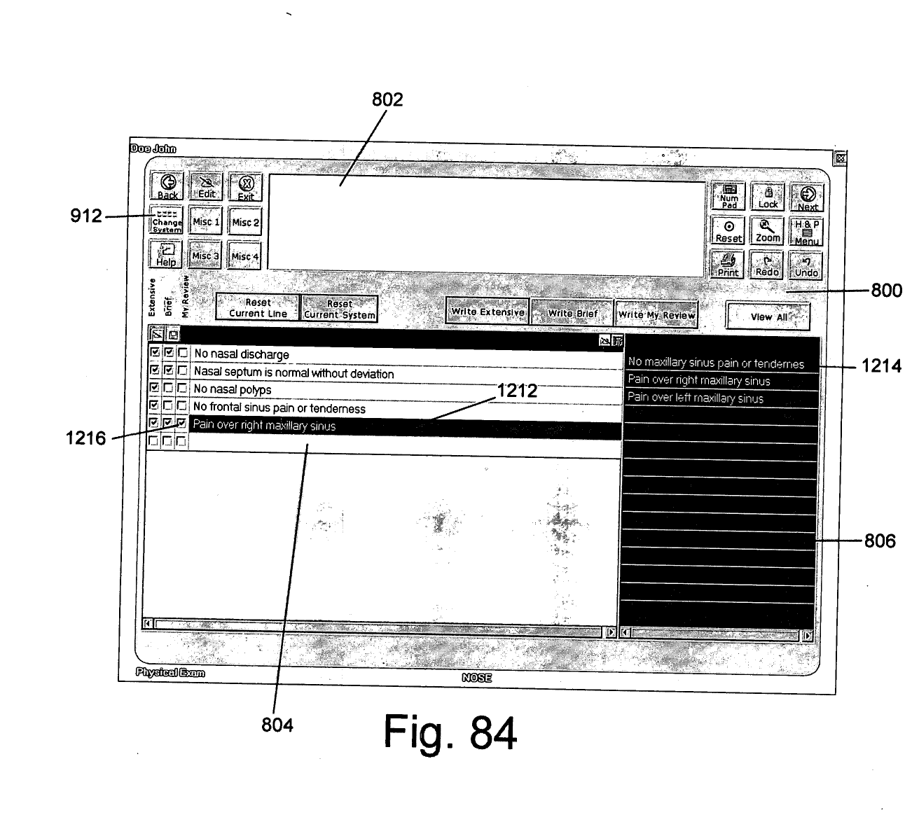

By selecting the CHANGE SYSTEM button 912 and changing the topic to NOSE, the MAIN DATA SCREEN 800 for the subject PHYSICAL EXAM and the topic NOSE is retrieved and shown in FIG. 82. “No maxillary sinus pain or tenderness” text object on line 1212 in the second display work area 804 is picked to highlight it and retrieve the options list available in the third display work area 806 for that line as seen in FIG. 83. The “Pain over right maxillary sinus” text object on line 1214 is picked from the third display work area 806 so that a check is placed in the fifth check box 1216 under My Review as shown in FIG. 84.

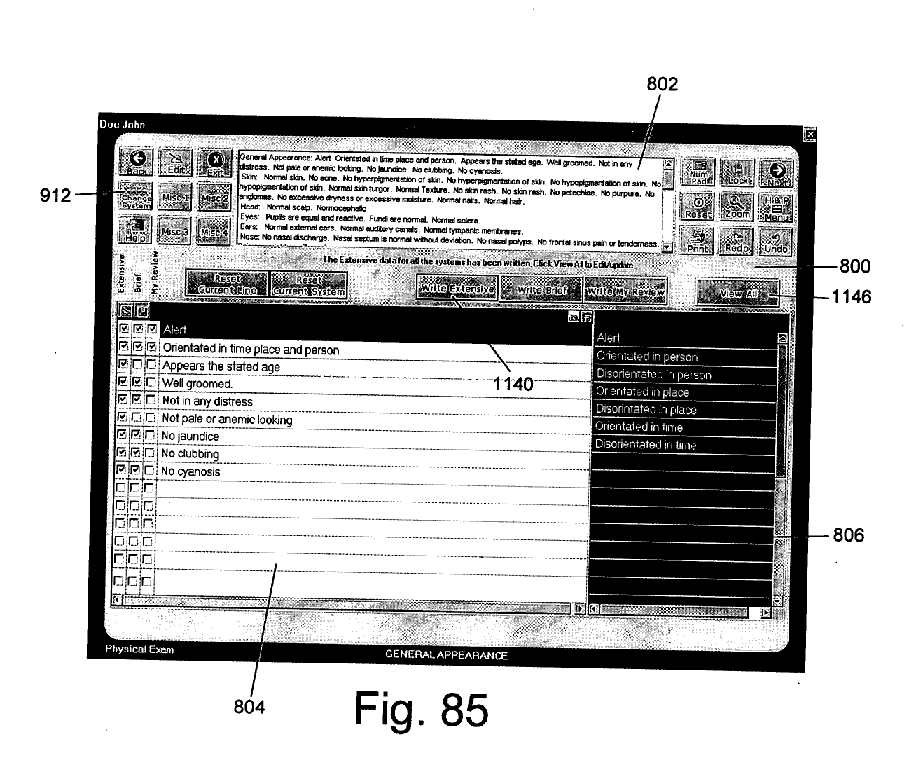

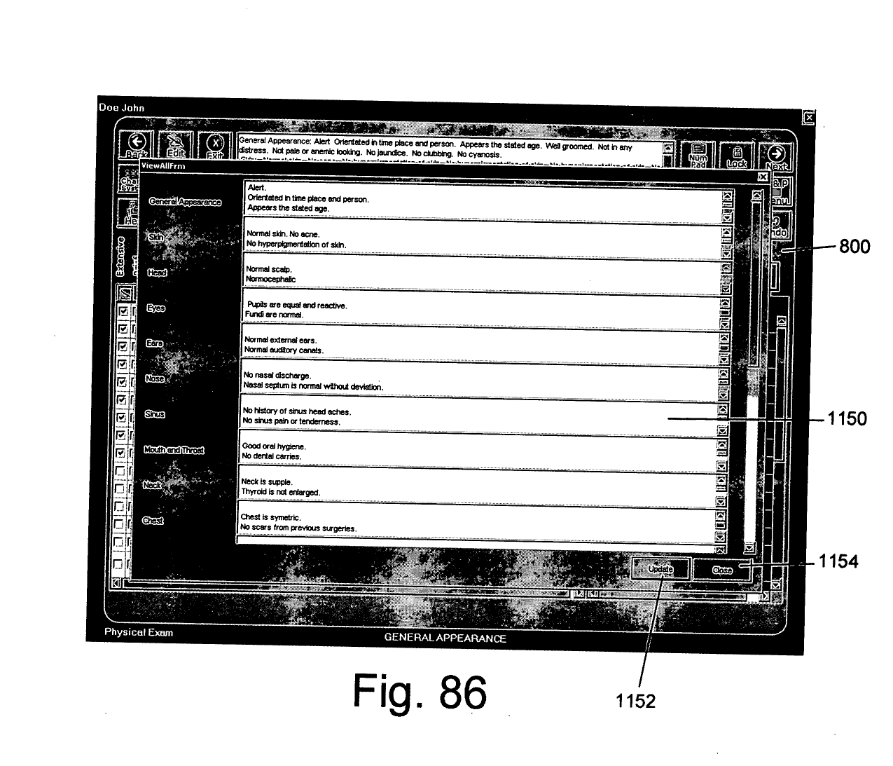

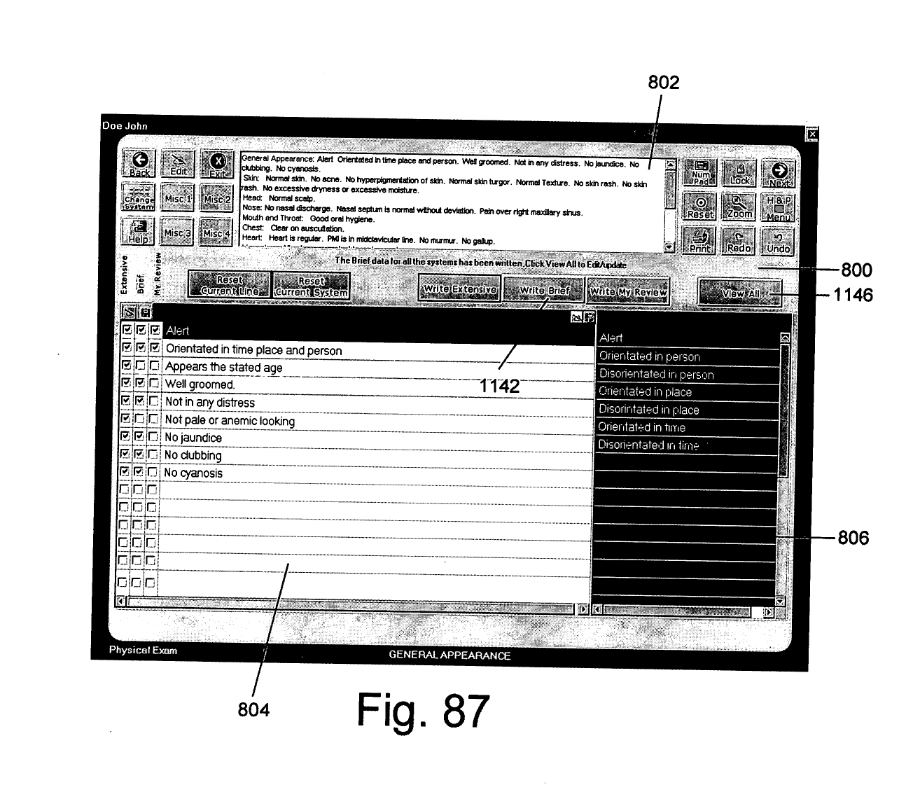

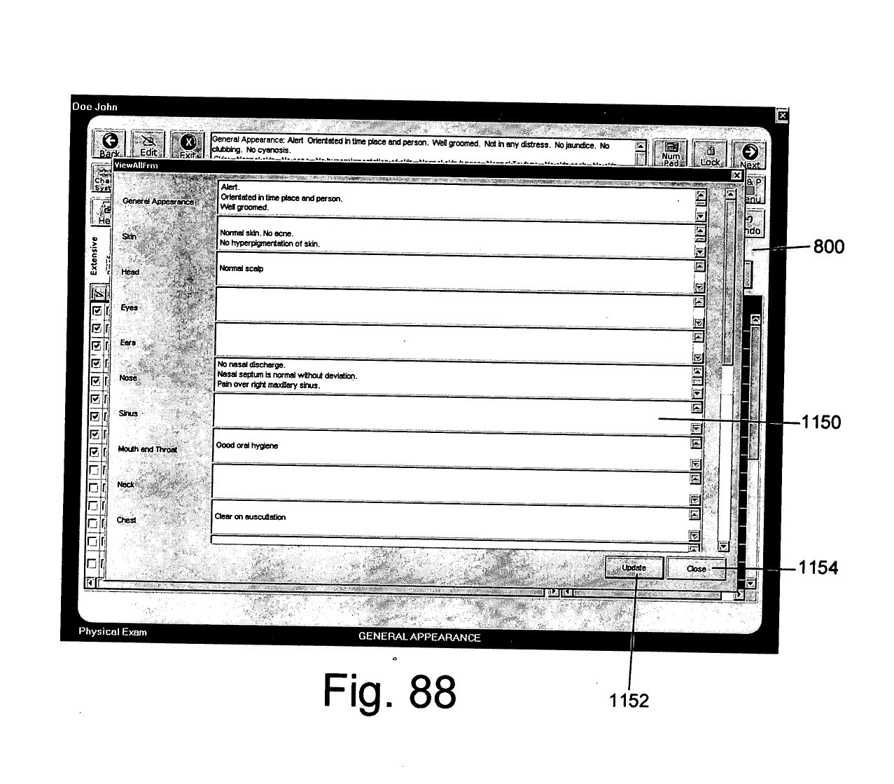

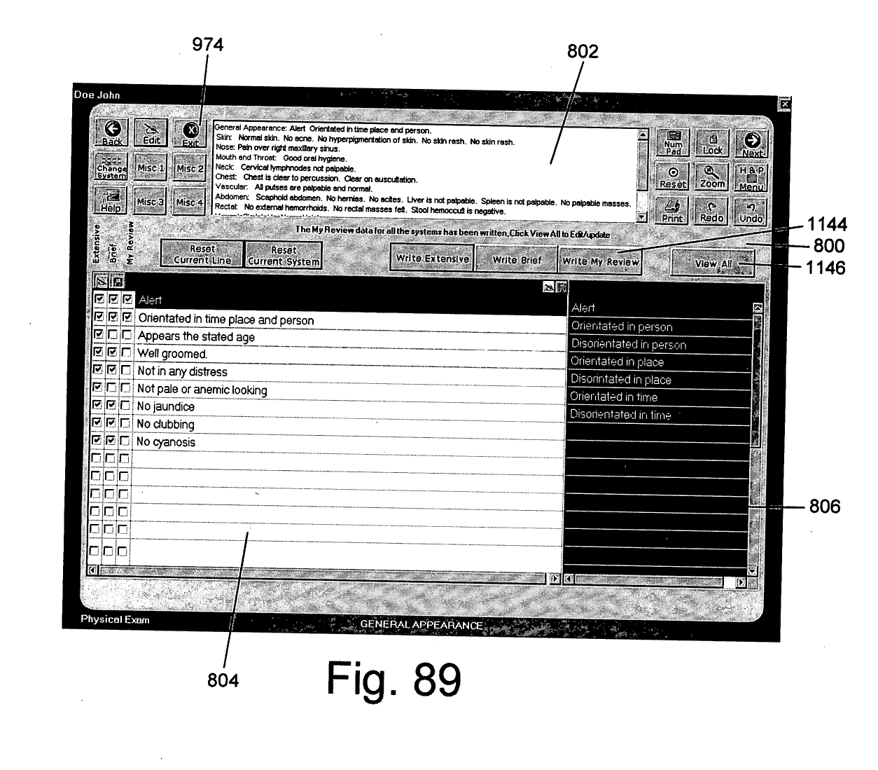

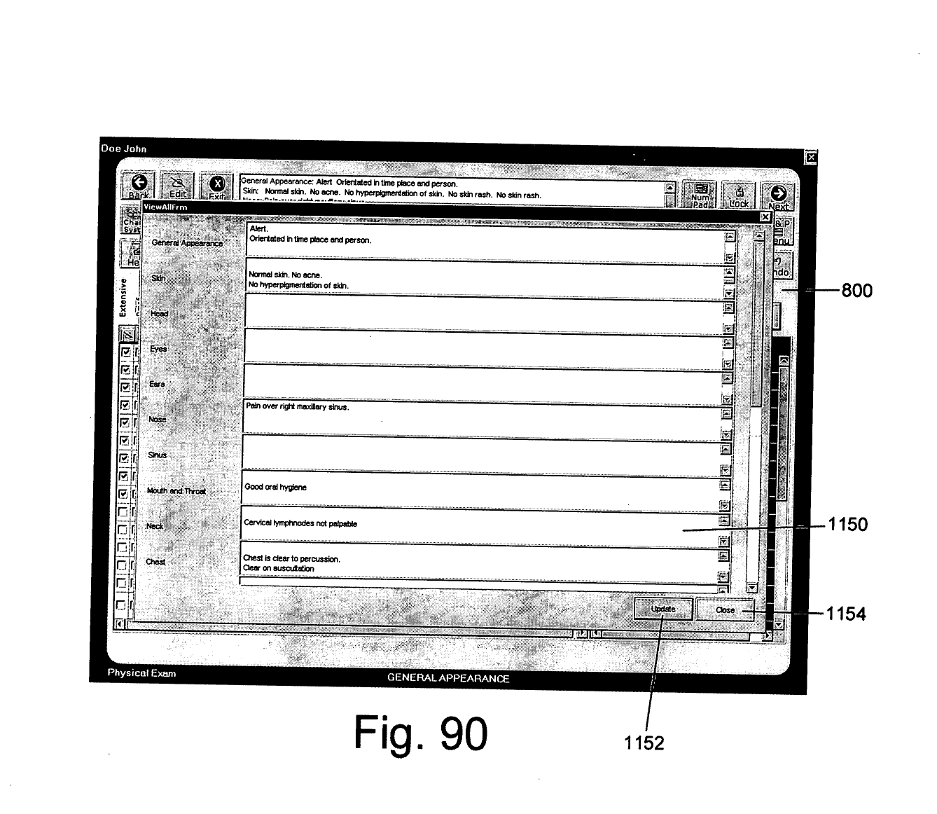

Subsequently, by selecting the CHANGE SYSTEM button 912 and changing the topic back to GENERAL APPEARANCE, the data for the subject PHYSICAL EXAM and the topic General Appearance and selecting the WRITE EXTENSIVE button 1140, all of the lines in the second display work area 804 having a check in the respective check box under the first column labeled Extensive for all topics is formatted and copied in the first display work area 802 with suitable topical headings as seen in FIG. 85 and in the window 1150 in FIG. 86 after VIEW ALL was executed. The written Brief summary generated by picking the WRITE BRIEF button 1142 is shown in the first display work area 802 of FIG. 87 and in the window 1150 in FIG. 88 after VIEW ALL was executed. The written My Review summary generated by picking the WRITE MY REVIEW button 1144 is shown in the first display work area 802 of FIG. 89 and in the window 1150 in FIG. 90 after VIEW ALL was executed.

### 10. Other Narrative Screen Templates

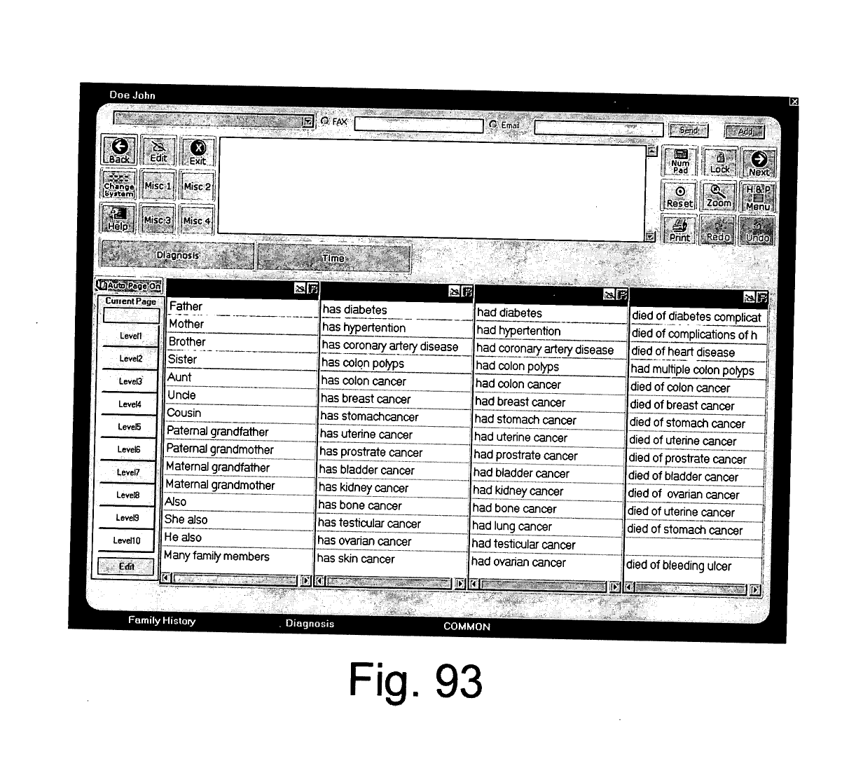

In FIG. 92, a display template is shown for the subject Immunizations. There is only one topic, which is called Common as noted at the bottom center margin of the screen. The only two phrase categories are Immunizations and Time.

In FIG. 93, a display template is shown for the subject Family History. There is only one topic, which is called Common as noted at the bottom center margin of the screen. The only two phrase categories are called Diagnosis and Time.

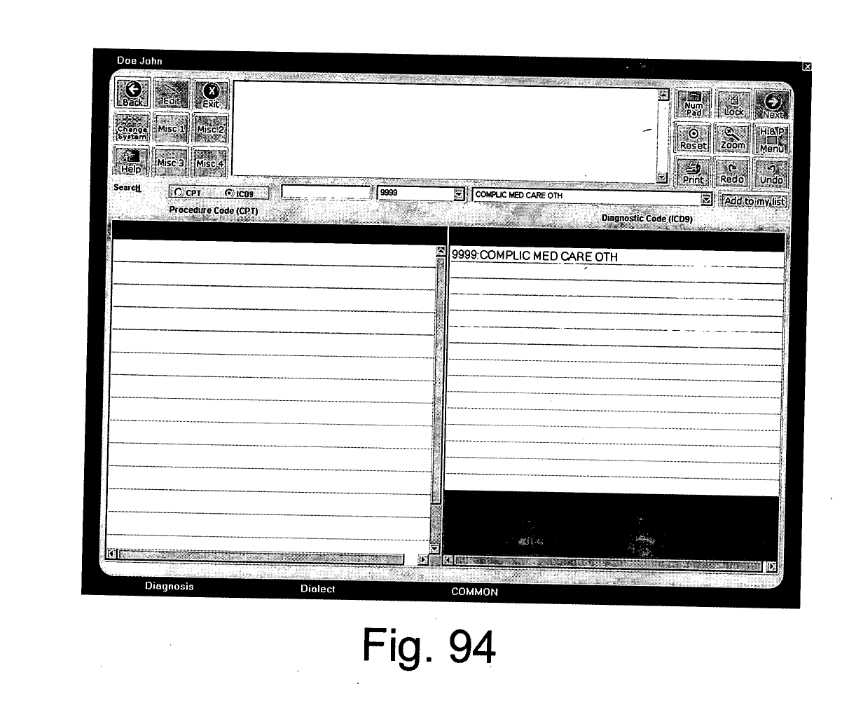

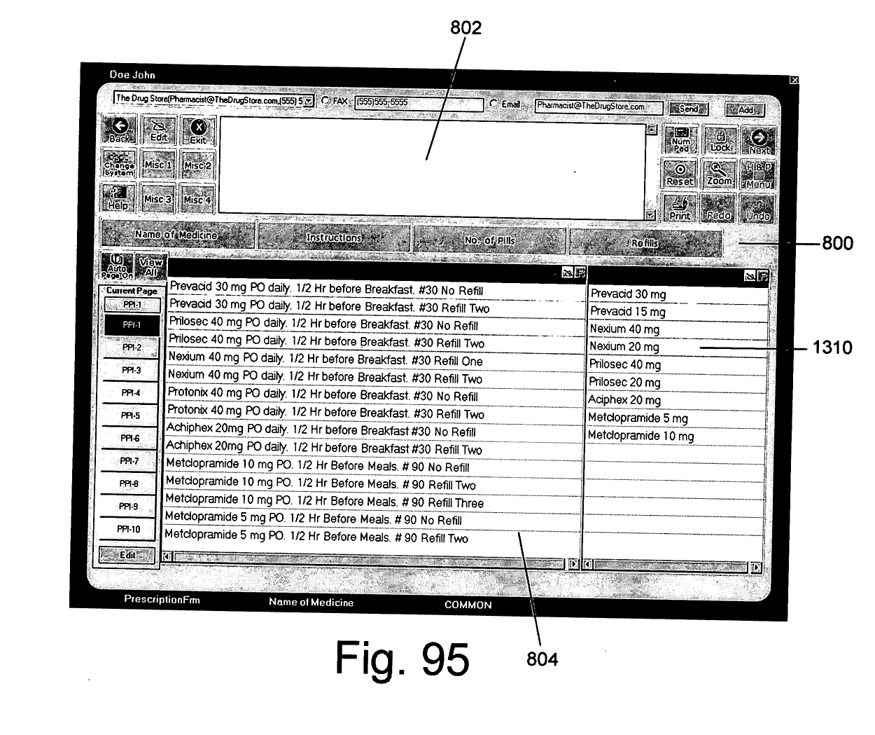

In FIG. 94, a display template is shown for the subject Diagnosis. There is only one topic, which is called Common as noted at the bottom center margin of the screen. There is only one phrase category called Dialect, which contains procedure codes and diagnostic codes.

### 11. Prescription Module

The operation of the prescription module can be described by referring to FIGS. 95 through 101, inclusive. Using the prescription module is generally similar to building the basic narrative described above. When the prescription module is initiated by selecting the Prescription button 1300 on the SESSION MENU SCREEN 890 in FIG. 35, a screen template is displayed as shown in FIG. 95 for the subject Prescription (PrescriptionFrm) and the topic Common. Here, the first display work area 802 is initially blank with the categories of text objects being “Name of Medicine,” “Instructions,” “No. of Pills,” and “Refills.” Note that with Auto Page On, the user is prompted and reminded to complete fully his instructions to the pharmacy and patient.

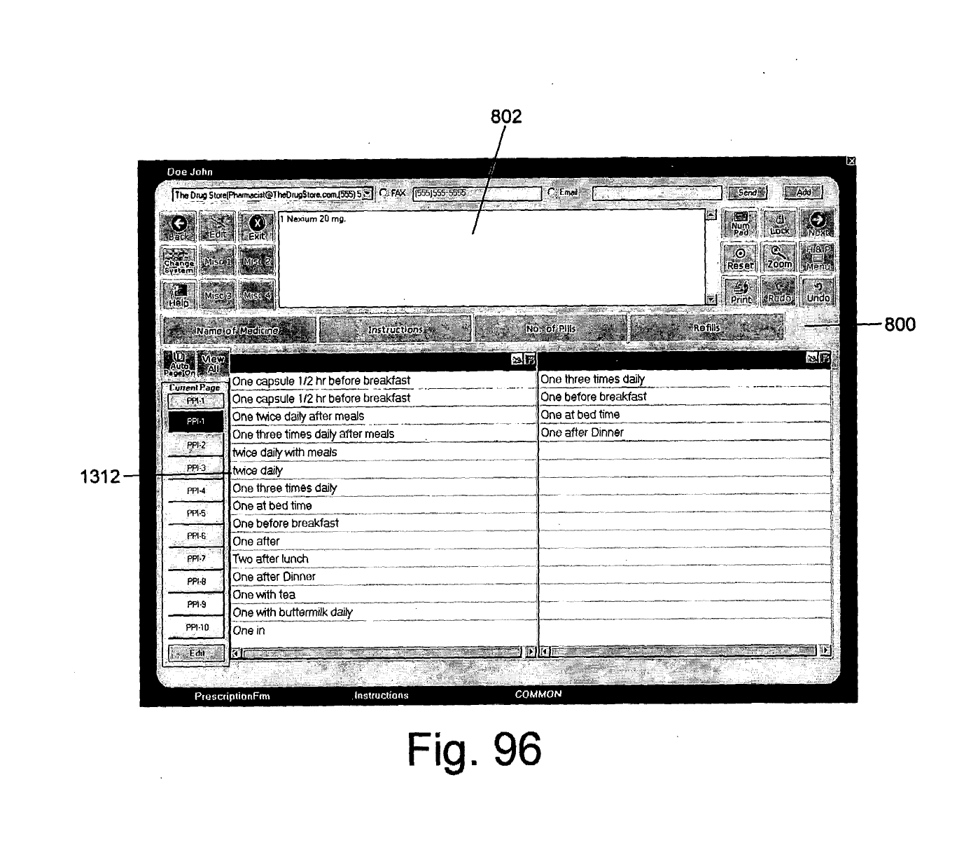

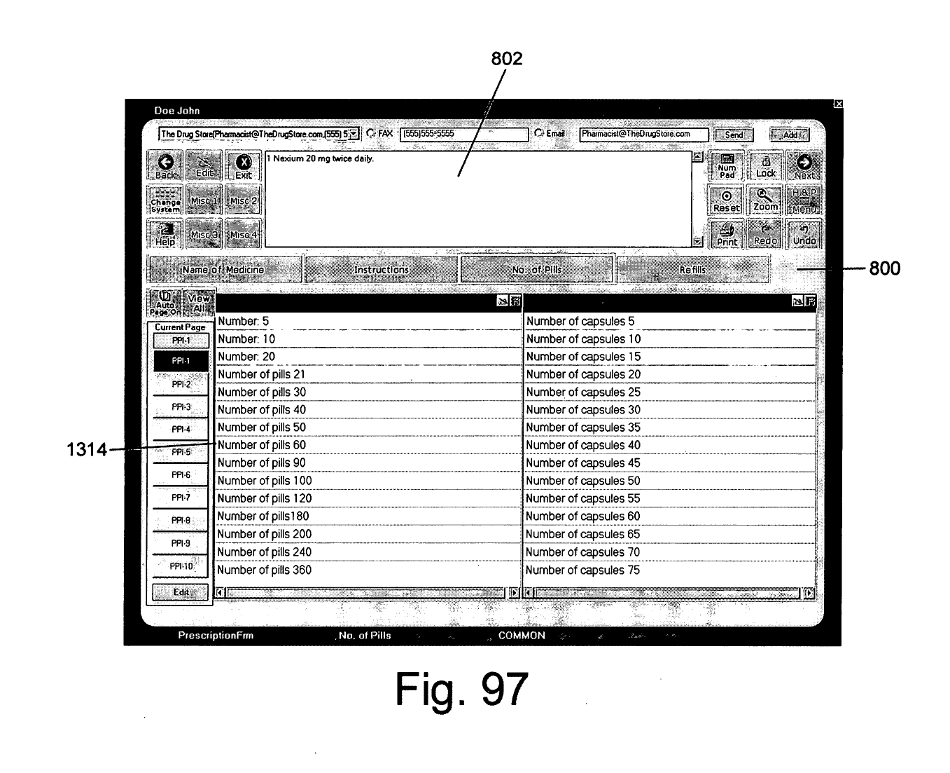

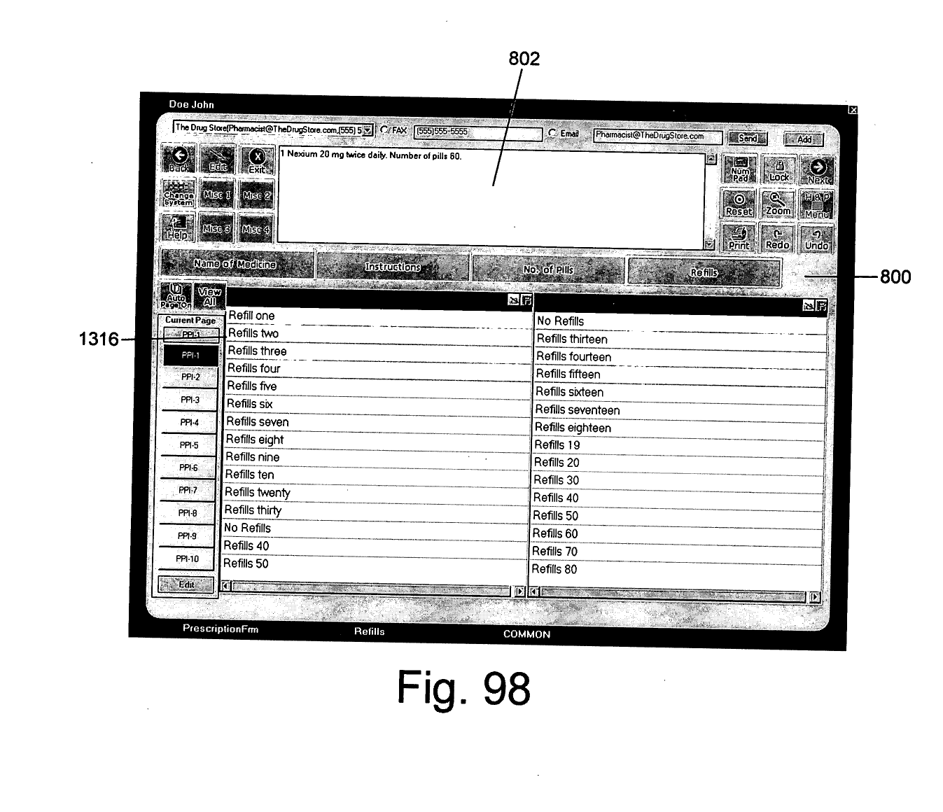

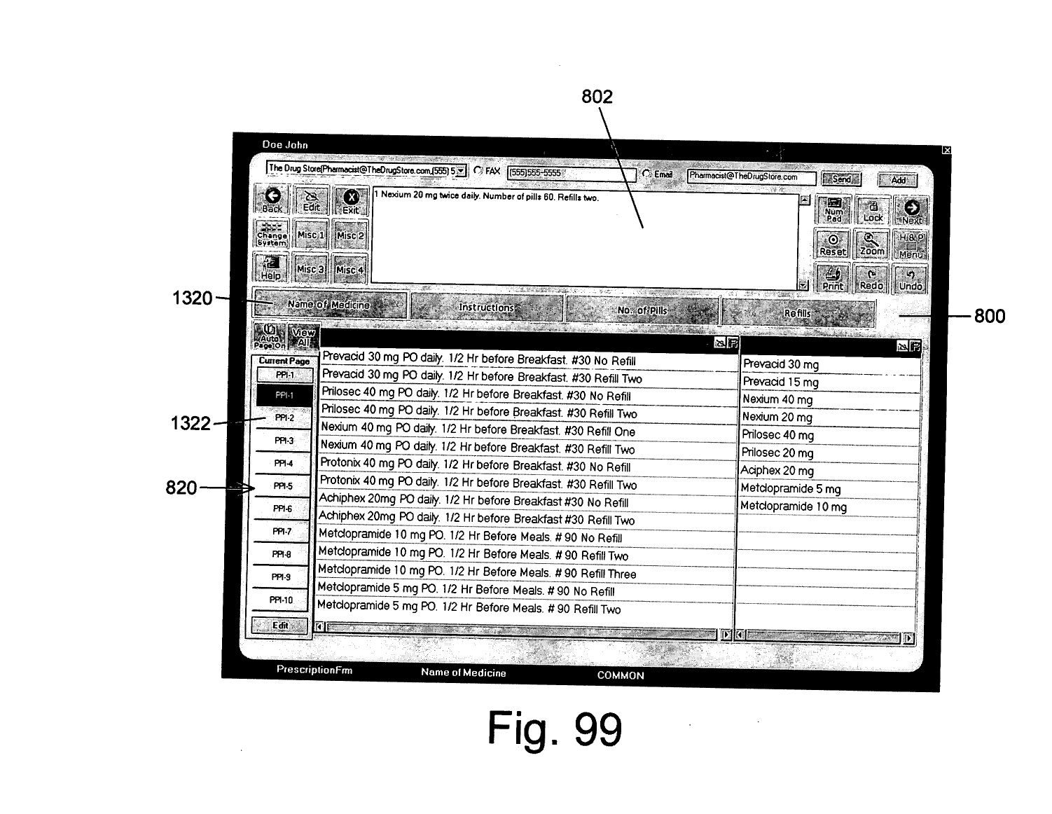

As an example, the user in FIG. 95 selects for the Name of Medicine the text object on line 1310 from the second display work area 804, column 2, which is copied into the first display work area 802 after which the system automatically pages to the next category as seen in FIG. 96. Under the second category, Instructions, the user selects the text object on line 1312 from the second display work area 804, column 1, which is copied into the first display work area 802 after which the system automatically pages to the next category as seen in FIG. 97. Under the third category, No. of Pills, the user selects the text object on line 1314 from the second display work area 804, column 1, which is copied into the first display work area 802 after which the system automatically pages to the next category as seen in FIG. 98. Under the fourth category, Refills, the user the selects the text object on line 1316 from the second display work area 804, column 1.

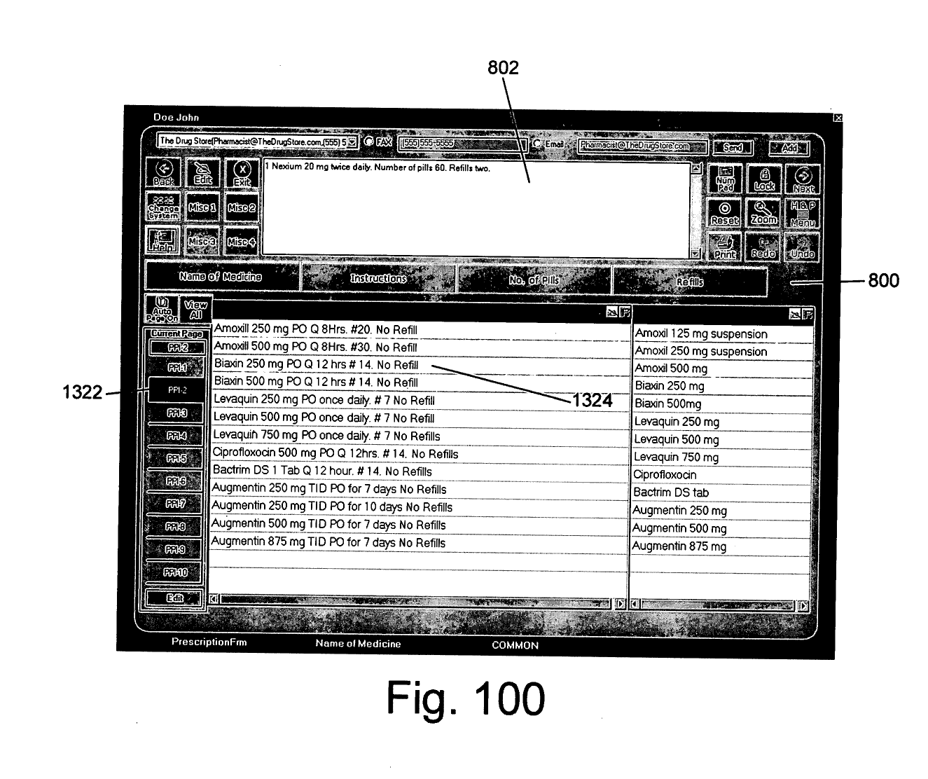

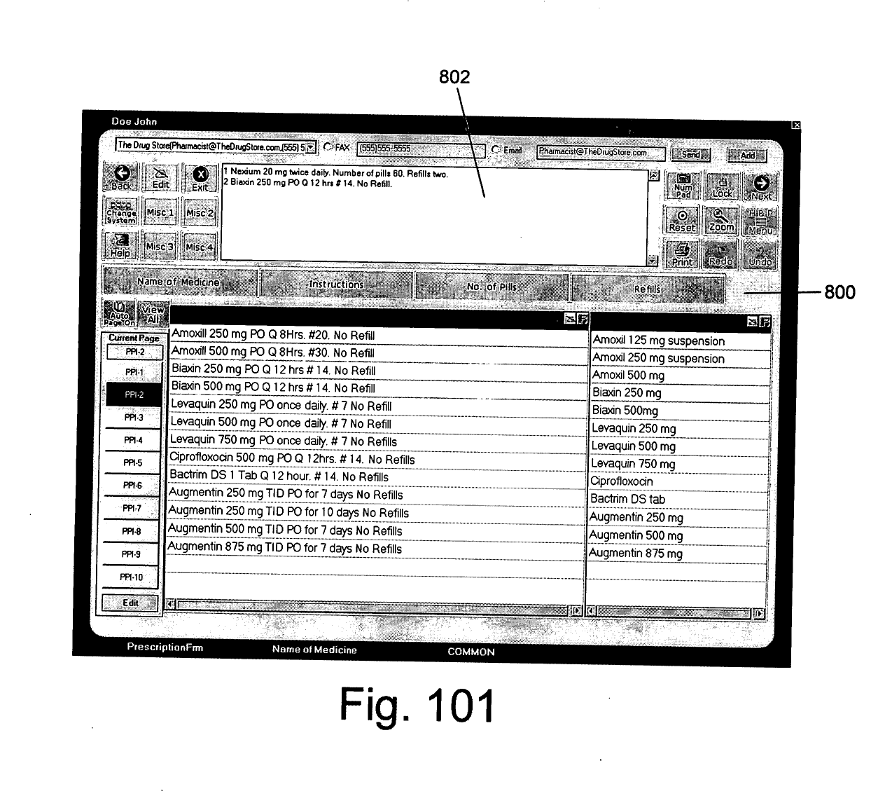

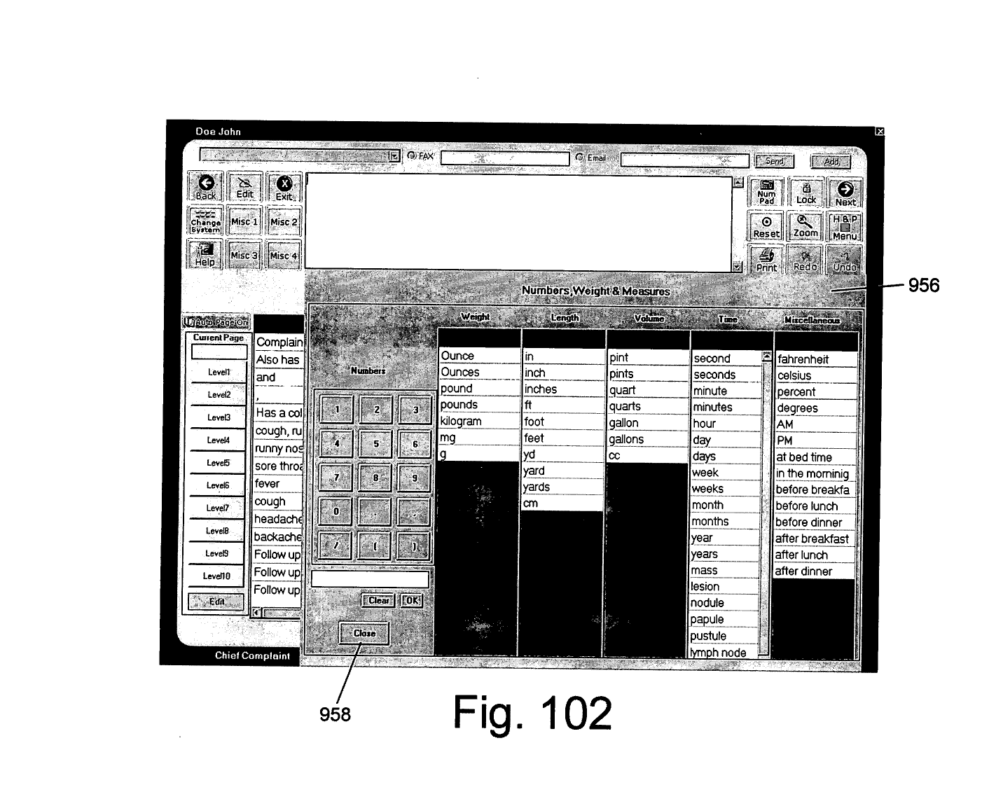

As now seen in FIG. 99, the first line of the prescription is complete and shown in the first display work area 802. Another line of the prescription can then be entered. The user now picks the “Name of Medicine” category tab 1320 and is ready to enter a second line for the prescription. However, the medicine name is on page 2 of the phrase category list, so the user selects the PP1-2 tab 1322 on the Page Level Menu 820 at the left side of the display to change pages. Now by similar operation as set forth with respect to line 1 above, the second prescription line can be entered by selecting line 1324 in FIG. 100. The completed 2-line prescription is shown in the first display work area 802 of FIG. 101.

### 12. Viewing and Printing a Chart/Prescription

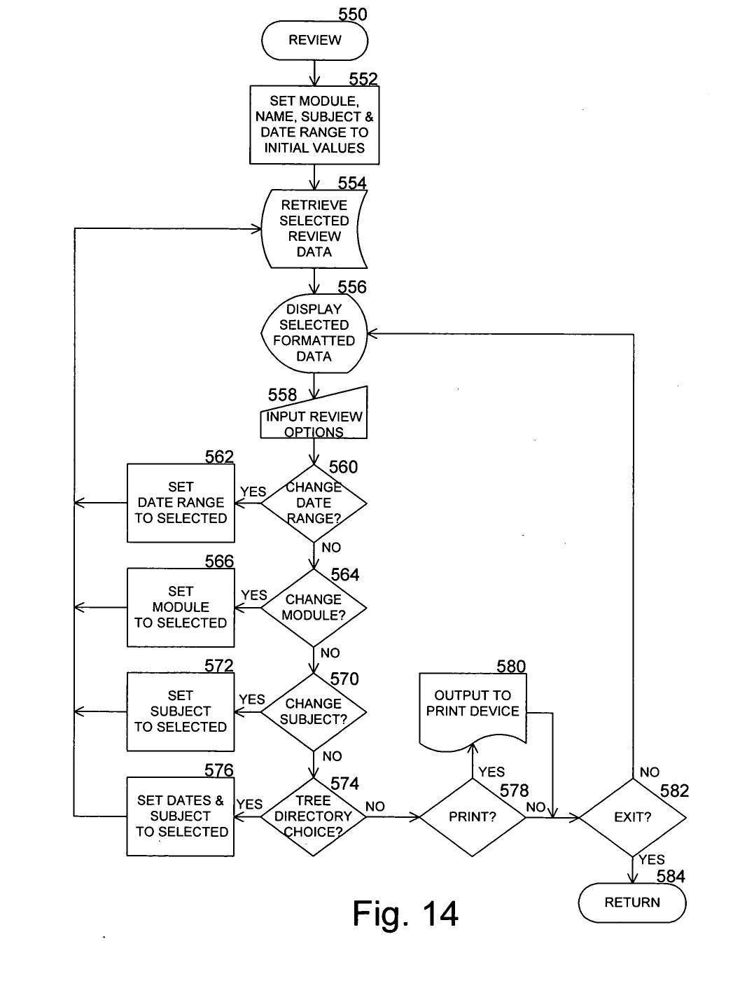

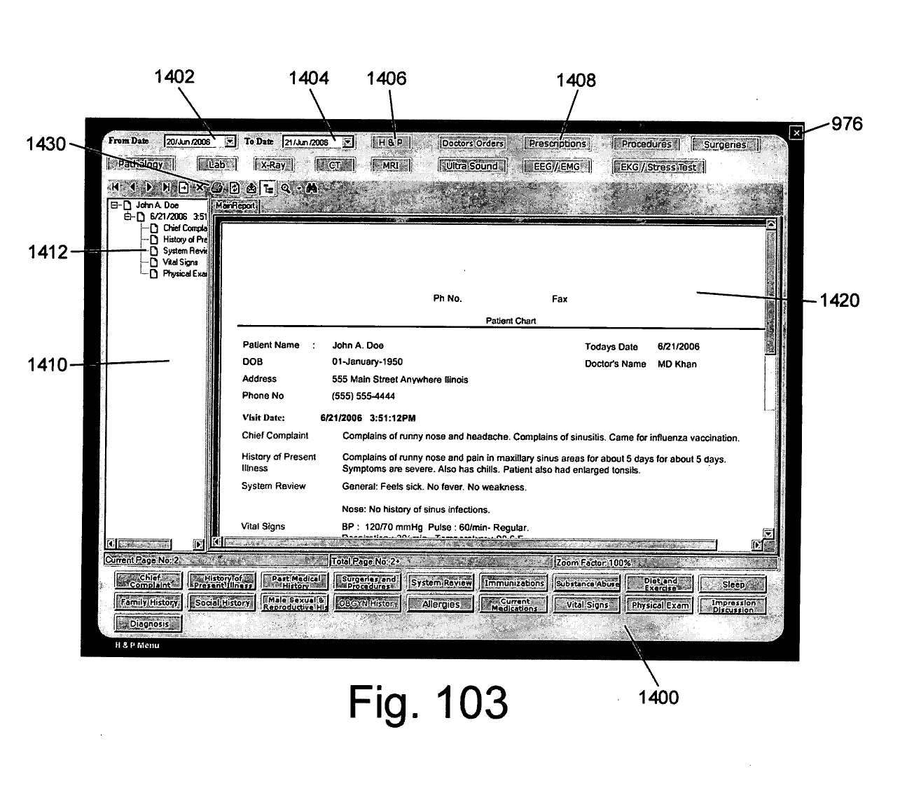

FIGS. 103 through 106 show examples of a chart generated and formatted from the data collected using the documentation system of the present invention. After selecting the REVIEW CHART option 896 on the SESSION MENU SCREEN 890 shown in FIG. 35, execution of the Review Routine (FIG. 14) begins at subroutine 550. After setting the module, patient name, subject and date ranges to initial values at step 552, any relevant data is retrieved from storage at step 554. Thereafter, formatted data is displayed at step 556 for the given parameters in the screen template 1400 shown in FIG. 103. At step 558, the user can input options for limiting the information displayed. At steps 560 and 562, the date range displayed is changed if a date range is entered into input boxes 1402 and 1404. At steps 564 and 566, the module displayed is changed if the user picks a module tab, such as tab 1406 or 1408. At steps 570 and 572, the subject displayed is changed if the user picks a subject icon at the bottom of the display 1400. At steps 574 and 576, the data displayed is changed in accordance with the user's choice in the hierarchial directory tree 1412. If it is determined at step 578 that the user has selected the print icon 1430, formatted data is send to a print device for output as hardcopy at step 580. If the user picks the Exit icon 976, processing branches at step 582 from the subroutine and returns by step 584. Otherwise, processing branches back from step 582 and the review display 1400 is redisplayed at step 556 and input from the user awaited at step 558.

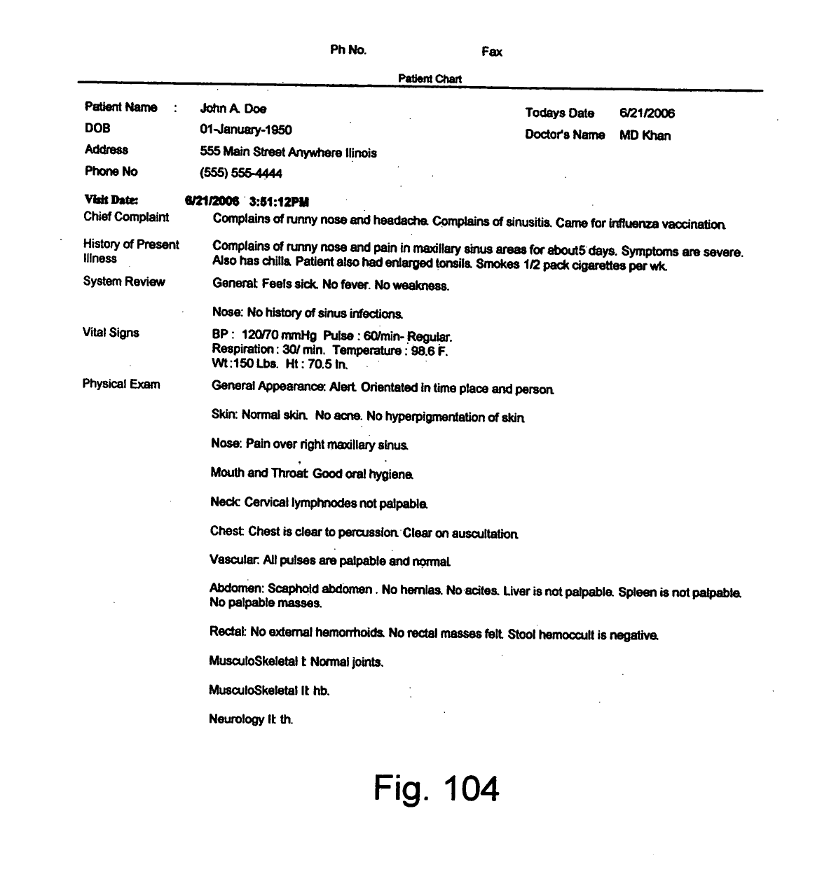

In a detailed example illustrated by the screenshots shown in FIGS. 103 through 106, the user has entered a range of dates in the text boxes 1402 and 1404 and picks the H&P tab 1406 at the top of the screen, the display is updated to that shown in FIG. 103. In the window area 1410 at the left center of the display, the system provides in a hierarchial directory 1412 a list of the information collected about the patient within that date range. In the window area 1420 at center of the display, the patient's record is shown in narrative form in a predefined formatted. It is noted that the user may optionally select portions of the chart to be displayed by selectively picking from the entries shown in the expandable directory 1412. When the user sends the information to a printer by picking the printer icon 1430, a hardcopy chart is provided as illustrated in FIG. 104.

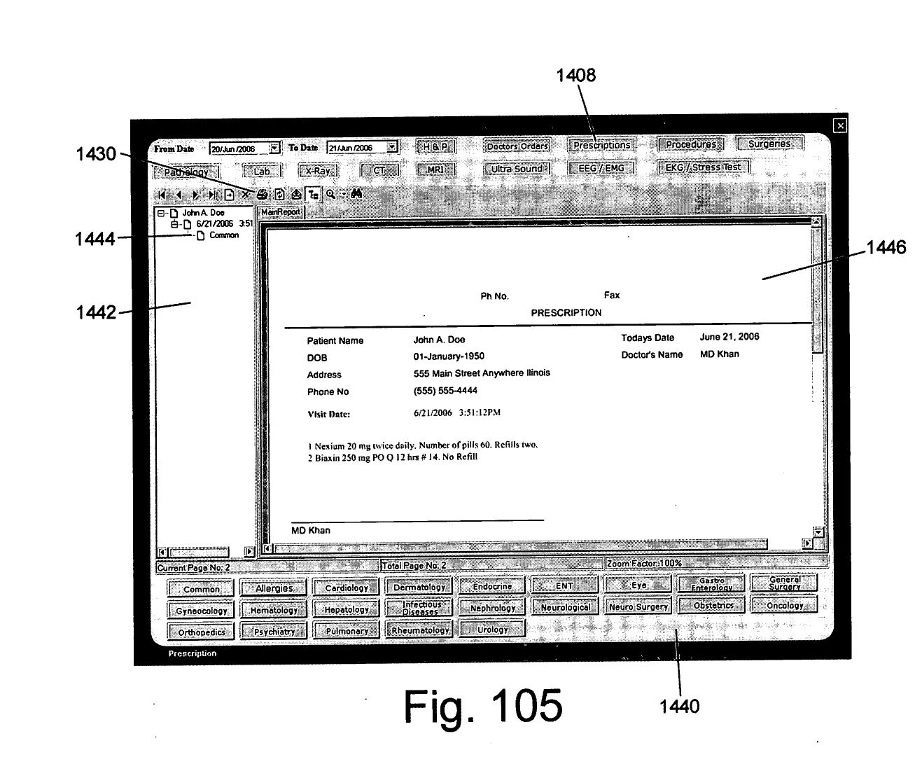

If the user enters a range of dates and selects the Prescription tab 1408 at the top of the screen display as shown in FIG. 105, prescription information that has been recorded in narrative form is shown. Herein, the display template 1440 includes a directory window 1442 with an expandable tree directory 1444 and a document window 1446 depicting a prescription set out in a predefined formatted. When the user sends the information to a printer by picking the printer icon 1430, a hardcopy prescription is provided as illustrated in FIG. 106.

### 13. Other Reports

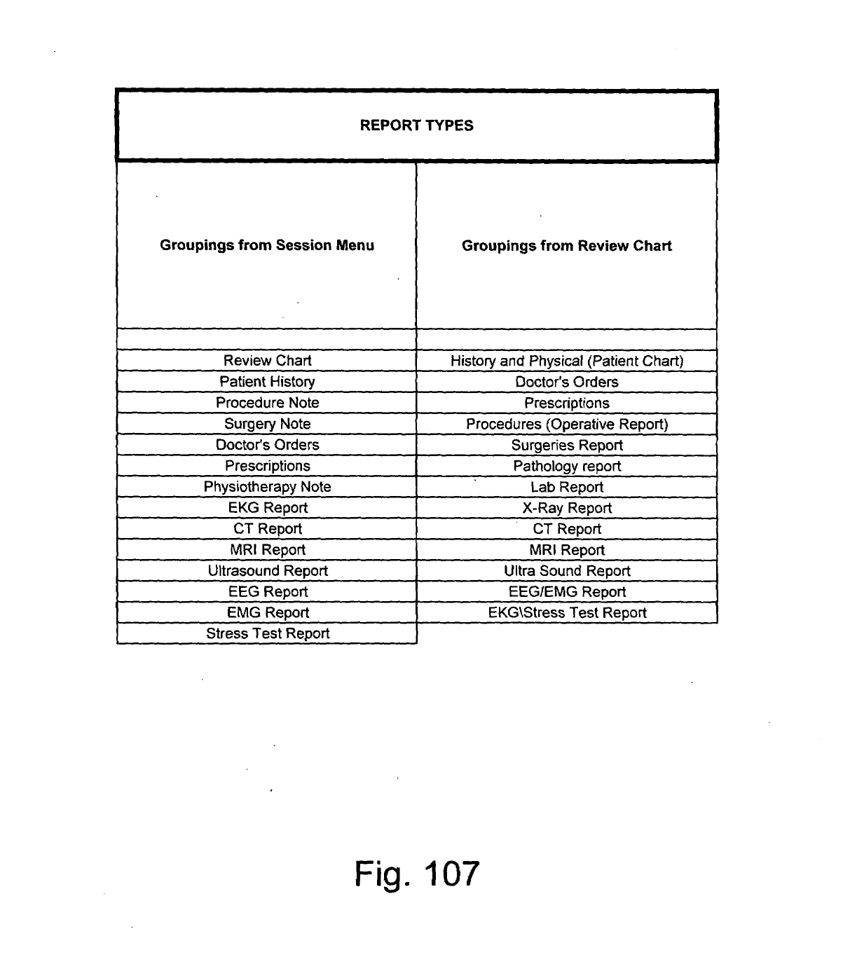

The table shown in FIG. 107 lists the various report types that a user might generate from the information copied into and stored from the first display work area 802.

### INDUSTRIAL APPLICABILITY

It should be apparent the documentation system and method described herein is simple, yet is effective and easy to use.

Other aspects, objects and advantages of this invention can be obtained from a study of the drawings, the disclosure and the appended claims.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

What is claimed is:

1. An automated system for generating documentation from text compiled by a user, said system including a computer having a processor responsive to instructions for manipulating data, an interface communicating with the processor for receiving instructions and data from a user and sending data to a user, and storage means for saving and retrieving processor instructions and data including a database of text objects for a plurality of selectable subjects, a template for organizing data presented to the user and at least one defined output format, said system comprising:
means for retrieving from the storage means any text previously saved by the user for a selected subject and the template associated therewith and copying said text to a first work area;
means for retrieving from the stored database text objects for the selected subject and copying to a second work area;
means responsive to user input for selecting a text object in said second work area and copying said selected text object to said first work area and joining said selected text object with any text therein to thereby modify text in said first work area;
means responsive to user input for saving to the storage means text in said first work area; and, means responsive to user input for sending text in said first work area to the interface in one of the defined output formats.

2. The automated documentation system of claim 1 further including editing means responsive to user input for modifying text in said first work area.

3. The automated documentation system of claim 1 further including means for selectively enabling and disabling editing of text objects in said second work area, means for editing text objects in said second work area when editing is enabled, and means for saving text objects in said second work area to the database.

4. The automated documentation system of claim 1 further including means for retrieving from the database text objects associated with text objects in said second work area and copying to a third work area, and means responsive to user input for selectively copying text objects in said third work area to said second work area.

5. The automated documentation system of claim 4 further including means for selectively enabling and disabling editing of text objects in said third work area, means for editing text objects in said third work area when editing is enabled, and means for saving text objects in said third work area to the database.

6. The automated documentation system of claim 5 further including indicator means for marking a subset of text objects in said second work area.

7. The automated documentation system of claim 6 further including means responsive to user input for selecting text objects for inclusion in said subset and marking with said indicator means, and means for copying said subset of marked text objects to said first work area.

8. The automated documentation system of claim 4 further including indicator means for marking a plurality of subsets of text objects in said second work area.

9. The automated documentation system of claim 8 further including means responsive to user input for selecting text objects for inclusion in said subsets and marking with said indicator means, and means for copying a selected one of said subsets of marked text objects to said first work area.

10. The automated documentation system of claim 9 further including means responsive to user input for selecting a text object in said second work area, means for retrieving from the database text objects associated with said selected text object in said second work area to replace text objects in said third work area, and editing means responsive to user input for modifying text objects in said third work area.

11. The automated documentation system of claim 1 wherein the text objects in said first and second works areas are presented on the interface simultaneously, and further including means for automatically updating the text objects in said second work area in accordance with text objects previously selected, and means for updating the text objects in said second work area in response to a user request therefor.

12. The automated documentation system of claim 1 wherein text objects in the database are categorized by subject matter and further including means responsive to user input for selecting the subject matter, and means for retrieving text objects from the database and the template in accordance with the subject matter selected.

13. The automated documentation system of claim 1 wherein the database includes medical terms and further including means for designating text in said first work area to be associated with an individual patient.

14. The automated documentation system of claim 13 wherein text objects in the database are categorized by subjects and topics with the subjects generally comprising steps associated with interviewing and examining the patient and the topics generally comprising fields of medical specialty.

15. An automated system for generating documentation from text compiled by a user, said system including a computer having a processor responsive to instructions for manipulating data, an interface communicating with the processor for receiving instructions and data from a user and sending data to a user, and storage means for saving and retrieving processor instructions and data including a database of text objects for a plurality of selectable subjects, a template for organizing data presented to the user and at least one defined output format, said system comprising:
means for retrieving from the storage means any text previously saved by the user for a selected subject and presented in the template associated therewith and copying said text to a first work area;
means for retrieving from the stored database text objects for the selected subject and copying to a second work area;
means for retrieving from the database text objects associated with text objects in said second work area and copying to a third work area;
means responsive to user input for selecting a text object in said second work area;
means for retrieving from the database text objects associated with said selected text object in said second work area to replace text objects in said third work area;
means responsive to user input for modifying text objects in said third work area and for saving to the database;
indicator means for marking a plurality of subsets of text objects in said second work area;
means responsive to user input for selecting text objects in said second work area for inclusion in one of said subsets and marking by said indicator means;
means for selectively copying a subset of marked text objects to said first work area;
means responsive to user input for saving to the storage means text in said first work area; and,
means responsive to user input for sending text in said first work area to the interface in one of the defined output formats.

16. A method for generating documentation using a computer system including a processor responsive to instructions for manipulating data, an interface communicating with the processor for receiving instructions and data from a user and sending data to a user, and storage means for saving and retrieving processor instructions and data including a database of text objects for a plurality of selectable subjects, a template for organizing data presented to the user and at least one defined output format, the steps comprising:
retrieving from the storage means any text previously saved by the user for a selected subject and the template associated therewith;
copying said retrieved text to a first work area;
retrieving from the stored database text objects for the selected subject;
copying retrieved text objects to a second work area;
selecting one or more text objects in said second work area;
copying said selected text objects to said first work area and joining said selected text object with any text therein to thereby modify text in said first work area;
saving to the storage means text in said first work area; and,
sending text in said first work area to the interface in one of the defined output formats. defined output formats.

17. The method of claim 16 wherein text in said first work area may be edited by the user and text objects in said second work area is protected from editing until editing is affirmatively enabled.

18. A method for generating documentation using a computer system including a processor responsive to instructions for manipulating data, an interface communicating with the processor for receiving instructions and data from a user and sending data to a user, and storage means for saving and retrieving processor instructions and data including a database of text objects for a plurality of selectable subjects, a template for organizing data presented to the user and at least one defined output format, the steps comprising:
retrieving from the storage means any text previously saved by the user for a selected subject and the template associated therewith;
copying said retrieved text to a first work area;
retrieving from the stored database a first set of text objects for the selected subject;
copying retrieved first set of text objects to a second work area;
retrieving from the stored database a second set of text objects associated with a selected text object in said second work area;
copying retrieved second set of text objects to a third work area;
replacing one or more text objects in said second work area by selecting text objects from said third work area;
selecting a subset of text objects in said second work area;
copying said selected subset of text objects to said first work area and joining said selected text object with any text therein to thereby modify text in said first work area;
saving to the storage means text in said first work area; and,
sending text in said first work area to the interface in one of the defined output formats.

19. The method of claim 18 wherein replacing a text object in said second work area by selecting text objects from said third work area selects the replaced text object as a member of the subset of selected objects in said second work area.

20. The method of claim 18 wherein text in said first work area is editable after text has been copied thereto and editing has been enabled, text objects in said second are not editable, and text objects in said third work area are protected from editing until editing is affirmatively enabled.
